(19) United States
(12) Patent Application Publication
(10) Pub. No.: US 2022/0314045 A1
(43) Pub. Date: Oct. 6, 2022

(54) NON-PENETRATING ROOF SAFETY SYSTEMS AND METHODS OF INSTALLATION AND USE FOR SLOPED ROOFTOPS

(71) Applicant: Ballantyne Gear Inc., McKinney, TX (US)

(72) Inventors: Flent Ballantyne, McKinney, TX (US); Steven Ballantyne, McKinney, TX (US)

(21) Appl. No.: 17/841,271

(22) Filed: Jun. 15, 2022

Related U.S. Application Data
(63) Continuation-in-part of application No. 16/876,674, filed on May 18, 2020.
Application No. 16/876,674 is a continuation-in-part of application No. 15/906,113, filed on Feb. 27, 2018, now abandoned.

(51) Int. Cl. A62B 35/00

(52) U.S. Cl. CPC A62B 35/0068; A62B 35/0075

(57) ABSTRACT

An improved roof safety system allows temporary installation without damaging the roof or building by using non-penetrating C-shaped anchors to hook onto eaves on opposing sides of the roof with the anchors connected by a single, continuous anchor line under tension. Installation of primary components do not require a user to access the roof, as they may be installed from the ground or a ladder position. Slidable anchors connectable to an anchor line and lifeline allow free movement along the line in a first direction and block movement in a second opposite direction, allowing a user to anchor to the line at a selected position and then securely move about the roof's surface in an area generally disposed in the second direction while being protected from a fall. An optional wedge-stopper can aid in single-user installation.

### CROSS-REFERENCE TO RELATED APPLICATIONS

This patent application is a continuation-in-part of U.S. patent application Ser. No. 16/876,674 filed on May 18, 2020, which is a continuation-in-part of U.S. patent application Ser. No. 15/906,113 filed on Feb. 27, 2018, the disclosures of which are incorporated by reference herein.

### RELATED ART

Different types and configurations of roof safety systems that provide an anchorage point or an anchorage line to provide fall restraint, fall arrest, and rope access for use in construction, repair, inspection, or other tasks on a roof's surface are well known in the prior art. Such systems are configured to prevent injury or death by restraining a user from falling and/or arresting a fall from the roof.

Many prior art roof safety systems require some penetration of the roof's surface for installation, such as through a screw or bolt inserted into the roof's surface or substructure, which creates a failure point for water intrusion into the roof or requires repair of the hole when the safety system is removed. Many prior art roof safety systems also either have a fixed anchorage point on the roof, a tether line across the roof (such as a horizontal lifeline) that does not allow a user to anchor to a particular position on the tether line, and/or involve the use of a fixed length lifeline (or lanyard) connecting the user to the fixed anchorage point or horizontal lifeline. These systems limit a user's ability to access all areas of the roof's surface and do not provide adequate protection against falls, particularly swing falls, as further discussed below.

An improved roof safety system is disclosed in U.S. Pat. No. 8,292,030 (owned by applicant). The '030 patent teaches a roof safety system comprising an anchoring device that may be structured as a wheeled “hook member,” adapted to be mounted to an eave or similar roof structure. Multiple hook members may be used, each mounted to a different eave and each having its own separate tether. An embodiment of the roof safety system of the '030 patent is shown in a video produced by Applicant and publicly available at https://www.youtube.com/watch?v=OiNgzEXR7w8 and further depicted in FIGS. 31A-D herein. A first tether is connected directly to an arched body of a first hook member by tying a first end of the first tether to the arched body. A second tether line is similarly connected directly to an arched body of a second hook member. To install the hook members, a user must be positioned on the roof, on the opposite side of the ridge to where the hook member will attach, preferably near the ridge. From this position, (1) a user slowly releases the first tether allowing the first hook member to roll down a first sloped surface of the roof until the rear wheels (wheels that are opposite of the attachment of the hook member to the tether line) fall off the roof's edge; (2) then the user pulls up on the first tether line to hook the rear wheels of the first hook member onto the eave; (3) then the user ties the end of the first tether line disposed on the opposite side of the ridge from where the first hook member is hooked on the eave to a weight also placed on the other side of the ridge from the first hook member to maintain tension on the first tether line and keep the first hook member in place; and (4) then the user connects a first device or devices to the first tether line at a position between the weight and the first hook member that will allow a second tether line to attach to first tether line in a manner that the two separate tether lines can be tensioned where they are connected. For example, a first progress capture pulley slidably attached to first tether line on one side of the progress capture pulley and fixedly connected on the other side of the first progress capture pulley to a connector, such as a ring or a multi-holed connector (shown in FIGS. 31A-31C) such that a second progress capture pulley can also be slideably attached to the second tether line and then the second progress capture pulley can be fixedly connected to the ring or multi-holed connector that will then be between the two progress capture pulleys, resulting in the two tether lines being connected, through the progress capture pulleys and the ring or multi-holed connector; or simply a carabiner can be attached to a loop knotted in first tether line to which the second tether line could be inserted and used to tension the lines. Now from a position on the opposite side of the ridge relative to the first hook member (preferably near the ridge), (5) a user slowly releases the second tether allowing the second hook member to roll down a second sloped surface of the roof (opposite the first sloped surface) until the rear wheels fall off the roof's edge; (6) then the user pulls up on the second tether line to hook the rear wheels of the second hook member onto the eave; (7) then the user connects the second tether line in a manner that the two tether lines can be connected, and at the connection, the two lines can be tensioned. For example, if the first tether line had a progress capture pulley fixedly attached to it, the second tether line may be inserted into the progress capture pulley and tensioned. In another example, the first tether line could have a single carabiner attached to it. The second tether line could run through this carabiner and then be pulled in a reverse direction to tension the two tether lines before knotting the second tether line to maintain the tension. In this way, the first and second separate tether lines are connected under tension.

A great shortcoming of the '030 system is that a user installing the system is required to carry the hook members and the weight onto the roof for installation, with no protection from falls during the installation process. It is dangerous to walk on a roof without fall protection, but when a user is carrying his/her gear, including the large sized hook members, a weight or weights, the tether lines, and other gear, it becomes much more dangerous. If any protection is desired during installation of the '030 safety system, it must be from a separate safety system, making it more complex, more expensive, and installing the separate system will likely add risks of injury to the user. Another shortcoming of the '030 safety system is that it would be easy to accidentally drop gear from the roof during installation. For example, the user, standing precariously on a steep roof with no fall protection, rolling the anchoring device down the roof, might allow the tether line to slip from his/her fingers so that the hook member rolls off the roof, potentially injuring another worker or other person or property that is below, and likely damaging the hook member (which is an expensive piece of gear) so that it is now unusable. Additionally, the user may experience a loss of balance after losing his/her grip on the tether line, further increasing the risk of a fall. Additionally, once installed, the '030 system only allows attachment of a lifeline at the connection of the two tether lines from the opposing hook members, resulting in a swing fall hazard at almost all positions at the roof edge and many areas that are not at the roof edge, resulting in limited access to the roof where the user is properly protected from falls.

There remains a need for further improvements in a roof safety system that protects the installer from falls during installation, provides multiple anchorage points to which a user can safely and easily move from one anchor point to another, allows greater access to areas of the roof's surface with fall protection, does not require penetration of the roof's surface for installation, reduces or eliminates the chance of an anchor becoming unintentionally dislodged, and allows a user to anchor to a selected position on an anchor line.

### SUMMARY OF THE INVENTION

Preferred embodiments of a roof safety system allow a user to access multiple areas of a roof to perform given tasks, such as a roof repair, roofing installation, chimney repair, plumbing vent installation or repair, installation of holiday decorations or lights, and similar tasks. A roof safety system is easily and temporarily installed as needed without requiring any components to be permanently affixed to the roof or building structure. These systems according to the invention do not cause damage to the roof or building and do not require components to be fastened to the roof or building in a manner that penetrates the roof or building surfaces (such as through the use of screws or bolts). These systems may also be installed by a single user if additional users or personnel are not available to assist. Depending on how the components are configured, preferred systems can also allow multiple users to access the roof simultaneously (using multiple anchor lines and lifelines) and even allow multiple users to simultaneously use the same anchor line while being protected from falls.

According to one preferred embodiment, a roof safety system comprises at least two roof anchors or hooks, at least one anchor line disposed between the two roof anchors or hooks, at least one lifeline connectable from the anchor line to a user, and at least one repositionable sliding anchor that connects the lifeline to the anchor line. Most preferably, the above mentioned anchor line is a single, continuous tether line or rope connecting the two roof anchors and does not comprise multiple tether lines or ropes that are connected together. Most preferably, the repositionable sliding anchor connects to a line (such as anchor line or lifeline) in a manner that allows free sliding movement along the line in a first direction but blocks movement along the line in a second direction substantially opposite the first. The sliding anchor effectively allows any connected element to be selectively anchored to the line at a desired position by preventing movement of the element in the second direction.

According to one preferred embodiment, the sliding repositionable anchor comprises a line sliding anchor to allow the lifeline to slide along or be anchored to the primary anchor line. According to another preferred embodiment, there are at least two repositionable sliding anchors comprising the line sliding anchor and a user sliding anchor, with the user sliding anchor connecting the user (or a user's lanyard) to the lifeline to allow the user to slide along or be anchored to the lifeline. When a user sliding anchor is used on a lifeline, it becomes an adjustable lifeline as a length of the lifeline between the user and the primary anchor line is adjustable depending on where the user sliding anchor is positioned on the lifeline.

According to another preferred embodiment, a first roof anchor is hooked onto a bottom surface or eave of a roof edge and a second roof anchor is hooked onto a bottom surface or eave of a roof edge substantially opposite of the first roof anchor. As further described below, a user need not access the roof to position or secure the roof anchors or to connect the primary anchor line, so the risk of falls during installation is minimized. As used herein, references to accessing a roof refer to climbing onto or being located on a roof's surface. Additionally, by hooking onto the eaves, roof safety systems according to preferred embodiment do not require any penetration of the roof surface to be anchored to the building, do not damage the roof's surface, the eave, or the building structure, and do not require any nearby structures (such as a tree) to provide an anchor point.

According to another preferred embodiment, a roof anchor comprises an arcuate or arched body, a front axle connected to a front end of the body, a rear axle connected to a rear end of the body, front wheels disposed on the front axle, and rear wheels disposed on the rear axle. According to another preferred embodiment, a roof anchor further comprises a pivotal connector disposed at or near a front end of the arcuate body, preferably pivotally connected to the front axle. A pivotal connector preferably comprises one or more aperture to allow an end of an anchor line to be selectively connected to allow the end of the anchor line to securely connect the roof anchor to the anchor line while also allowing for pivotal movement of the anchor line relative to the roof anchor, particularly during installation; and additionally allow the connection of a lifeline or lifelines to the pivotal connector. In one preferred embodiment, the arcuate body comprises an asymmetrical C-shape with the curvature of the body at one end being different from that at the other end.

According to yet another preferred embodiment, a roof anchor comprises an arcuate or arched body, front lateral arm, and a rear lateral arm. The lateral arms are configured similarly to axles and wheels, but may be non-rolling, fixed arms that preferably allow a roof anchor to slide along a roof's surface as needed during installation, rather than rolling in the embodiment with wheels.

According to one preferred embodiment, when roof anchors are properly installed for use of a roof safety system according to the invention, only the wheels (or lateral arms) of the roof anchor contact portions of the roof and corresponding building structure. Front wheels (or a front lateral arm) are in contact with a sloped roof surface and rear wheels (or rear lateral arm) are in contact with a surface of an eave or soffit under an edge of the roof, and optionally but preferably also in contact with a side surface of the structure near the eave. Most preferably, no portion of the arched body directly contacts the roof or building structure once installed.

In other preferred embodiments, a roof safety system further comprises a line thrower system to aid in positioning the primary anchor line. A line thrower system preferably comprises a line thrower, a throw line, and a projectile comprising a throw bag or weight that is launchable from the line thrower and connectable to the throw line. Throw line is preferably a lightweight line that is connected to an end of an anchor line while on a first side of a structure before the throw line is launched to the second side of the structure, substantially opposite the first side. This allows a user to pull the anchor line across the roof from a position on the ground or on a ladder, without having to access the roof's surface.

In another preferred embodiment, safety system further comprises a stopper to aid in installation of a first roof anchor when only a single user is available for installation. A stopper preferably comprises a wedge-shaped body that is positioned near an edge of the roof to block movement of the rear wheels (or rear lateral arm) of a roof anchor until a user takes action to remove the stopper or allow the stopper to fall off of the roof.

According to still other preferred embodiments, a roof safety system further comprises one or more of the following additional components: one or more secondary anchor lines, one or more secondary roof anchors, a progress capture/tensioning device (preferably one that provides a mechanical advantage) to apply tension to a primary anchor line (as used herein, “primary” anchor line refers to the first or only anchor line installed) or a secondary anchor line, a harness, at least one lanyard (comprising a short length of rope, strap, chain, or tether line), and a plurality of connectors (such as a carabiner, snap hook, trigger snap, bolt snap, traditional buckle, or side-release buckle that allows selective, easy, and secure connection or disconnection of two components).

According to other preferred embodiments, a roof safety system and its components when installed will comply with U.S. OSHA and/or ANSI Z359 standard applicable as of the filing date of this application and/or as they may be modified subsequent to the filing date.

According to one preferred method of installing a roof safety system, a user or users do not have to access a roof's surface prior to installation of the first and second roof anchors and their connecting primary anchor line. All installation steps for those components may be performed from the ground level and/or on a ladder leaning against the roof or its building structure. This way the user is not at risk of falling from the roof during installation. Additionally, once the first roof anchor is installed, a user may connect to the primary anchor line during installation of the second roof anchor to be protected from a fall off the ladder during that installation step.

One preferred installation method comprises the following steps:

(i) preparation of throw line and first roof anchor—including connecting a first end of a throw line to a projectile and a second end of the throw line to a second end of primary anchor line, with the first end of the anchor line attached to the first roof anchor;

(ii) launching throw line from a first side of a structure across a roof on the structure to a second side of the structure substantially opposite the first side—including loading a projectile into a line thrower 180 (see FIG. 12) and firing the line thrower to launch the projectile from a first side of a structure having a roof which needs to be accessed by a user to complete a task to a second side of the structure substantially opposite the first side;

(iii) positioning a first roof anchor on a roof edge on the first side of the structure in an installed position—including pulling on the throw line until the second end of the primary anchor line is on the second side of the structure, pulling on the anchor line and/or lifting the first anchor into a position near the roof on the first side of the structure, placing the first roof anchor in position with its forward wheels (or front lateral arm) in contact with a sloped surface of the roof and rear wheels (or rear lateral arm) in contact with an eave on the first side of the structure under the edge of the roof (optionally with assistance from a stopper, if needed), and maintaining tension on the primary anchor line from the second side of the structure;

(iv) positioning a second roof anchor on a roof edge on the second side of the structure in an installed position and in a location substantially opposite first roof anchor—including connecting the primary anchor line to a second roof anchor, lifting the second roof anchor into a position near the roof on the second side of the structure, placing the second roof anchor in position with its forward wheels (or front lateral arm) in contact with a sloped surface of the roof and rear wheels (or rear lateral arm) in contact with the adjacent eave under the edge of the roof on the second side of the structure, still maintaining tension on the primary anchor line from the second side of the structure during these steps so that the first roof anchor is maintained in its installed position; and

(v) securing the primary anchor line, which is optional in certain preferred embodiments—including pulling on a free end portion of the primary anchor line to place the primary anchor line under additional tension to hold the first and second roof anchors more securely in installed positions, increasing the tension on the anchor line such that more users can use the system and/or so the system can protect a user or users on a greater area of the roof, and tying free end portion around the primary anchor line with a knot to secure the primary anchor line.

According to another preferred method of installing a roof safety system when a secondary anchor line(s) and second roof anchor(s) are used, the method further comprises the following steps:

(vi) connecting a line sliding anchor to a first end of a secondary anchor line and to primary anchor line including, from a position on the roof, a user connects a line slidable anchor to a desired position on the primary anchor line and fixedly connects a first end of a secondary anchor line to line slidable anchor;

(vii) connecting and positioning a secondary roof anchor (a third roof anchor, for example) on a roof edge on a third side of the structure—including connecting an end of the secondary anchor line to the third roof anchor and either lifting it from a ground position on the third side of the structure (similarly to installation of the second roof anchor) or allowing the third anchor to roll down the roof from a position near the primary anchor until its rear wheels (or rear lateral arm) falls off the roof to engage with the eave, and maintaining tension on the secondary anchor line which is connected between the primary anchor line and the third roof anchor; and

(viii) securing secondary anchor line 168 (See FIG. 35A), which is an option in certain preferred embodiments—including pulling on a free end portion of the secondary anchor line to place the secondary anchor line under additional tension to hold the third roof anchor in its installed position and to provide support to the primary anchor line and allow a user to access the roof connected to primary or secondary anchor line, and tying free end portion around the secondary anchor line with a knot to secure the secondary anchor line.

Installation and use of a roof safety system according to preferred embodiments do not require the user to access the roof during installation, do not require any components to be installed by penetrating the roof or building structure with connectors such as screws or bolts, do not cause any damage to the roof or building structure, and do not require any permanently installed anchorage points. They also provide greater ease of access to different areas of the roof, greater flexibility in installation configurations to accommodate different roof structures and allow access to more areas of the roof to complete a task, allow a user to slide and anchor to any selective position on an anchor line or adjustable lifeline, and provide greater protection from falls particularly swing falls or falls from a roof corner. The roof safety systems of the preferred embodiments solve the problems associated with prior art systems and provide many advantages as further discussed herein.

### BRIEF DESCRIPTION OF THE DRAWINGS

Roof safety systems and methods of installation and use according to preferred embodiments of the invention are further described and explained in relation to the following figures wherein:

FIGS. 1A and 1B show the hazards of a swing fall related to a single point anchorage according to a prior art safety system;

FIG. 2 is a front elevation view of a horizontal lifeline extending above a ridge of a sloped roof, with a worker attached to a tether line that is slidably attached to the horizontal lifeline according to another prior art safety system;

FIG. 3 is a top plan view of FIG. 2 showing a worker falling off the roof from a roof edge that is perpendicular to the horizontal lifeline and showing the tether sliding to the end of the horizontal lifeline, causing the fall distance to increase;

FIG. 4 is a front elevation view of a building with a sloped roof onto which roof safety system according to one preferred embodiment of the invention is installed and showing a user connected to the anchoring system while on the roof;

FIG. 5 is a top plan view of FIG. 4.

FIG. 6 is a perspective view of a preferred embodiment of a roof anchor according to the invention;

FIG. 7 is a bottom perspective view of the roof anchor embodiment of FIG. 6.

FIG. 8A is an exploded view of the roof anchor embodiment of FIG. 6;

FIG. 8B is an enlarged portion of FIG. 8A;

FIG. 8C is a rotated, non-exploded view of FIG. 8B;

FIG. 9 is a perspective view of a preferred embodiment of a connector according to the invention;

FIG. 10 is a bottom view of another preferred embodiment of a connector, attached to the front of the roof anchor and axle of FIG. 6, according to another preferred embodiment of the invention (for clarity, the wheels of a roof anchor are not shown on the axle in FIG. 10);

FIG. 11 is a perspective view of the connector of FIG. 10.

FIG. 12 is a perspective view of an example of a line-thrower system for use with the roof anchor of FIG. 6;

FIG. 13 is a front elevation view showing a user that is launching a throw line from the ground on one side of the structure to position a projectile (or throw bag or weight) on a substantially opposite side of the structure according to one preferred embodiment of a method for installing a roof safety system according to the invention;

FIG. 14 is a front elevation view showing a user that is launching a throw line from a ladder position according to another preferred embodiment of a method for installing a roof safety system according to the invention;

FIG. 15 is a front elevation view showing a user that is launching a throw line from a manlift according to another preferred embodiment of a method for installing a roof safety system according to the invention;

FIG. 16 is a perspective view of a user on a ladder (similar to FIG. 14) preparing to launch a throw line according to one preferred embodiment of a method for installing a roof safety system according to the invention;

FIG. 17 is a perspective view of a user on a ladder (similar to FIGS. 14 and 16) launching a throw line according to one preferred embodiment of a method for installing a roof safety system according to the invention;

FIG. 18 is a front elevation view showing a primary anchor line extending across a roof and connected at first end to a first roof anchor according to the embodiment in FIG. 6;

FIG. 19 is a front elevation view showing general movement of the primary anchor line and first roof anchor of FIG. 18 according to one preferred embodiment of a method for installing a roof safety system according to the invention, with a first user not shown;

FIG. 20 is a perspective view illustrating a user lifting a first roof anchor according to FIG. 6 into an installed position according to one preferred embodiment of a method for installing a roof safety system according to the invention;

FIG. 21 is a perspective view showing the user of FIG. 20 completing installation of the first roof anchor according to one preferred embodiment of a method for installing a roof safety system according to the invention;

FIG. 22 is a front elevation view showing a second user disposed on a side of a building substantially opposite the installed first roof anchor according to one preferred embodiment of a method for installing a roof safety system according to the invention;

FIG. 23 is a front elevation view showing a user (a first or second user) positioned on a ladder and lifting a second roof anchor according to FIG. 6 into position according to one preferred embodiment of a method for installing a roof safety system according to the invention;

FIGS. 24A-24E are perspective views showing a user (a first or a second user) positioned on a ladder (similar to FIG. 23), lifting a second roof anchor according to FIG. 6 into an installed position and the beginning a transfer to the rooftop (or from the rooftop) according to preferred methods for installing a roof safety system according to the invention;

FIG. 25 is a front elevation view showing a user (a first or a second user) tensioning a primary anchor line to complete installation of the second roof anchor according to one preferred embodiment of a method for installing a roof safety system according to the invention;

FIG. 26 is a top plan view of a user on a roof structure connected to an anchor line and rolling a fourth roof anchor down a sloped surface of the roof for installation of the fourth roof anchor according to another preferred embodiment for installing a roof safety system according to the invention;

FIG. 27A is a front perspective view of a stopper according to one preferred embodiment of the invention;

FIG. 27B is a rear perspective view of the stopper of FIG. 26;

FIGS. 28A-28G show use of a stopper according to FIGS. 26-27 and a first roof anchor according to FIG. 6 in varying positions on a roof according to another preferred embodiment of a method for installing a roof safety system according to the invention;

FIG. 29 is a perspective view of an anchor line tied to a ladder as part of one preferred embodiment for installing a roof safety system according to the invention;

FIG. 30 is a front elevation view showing first and second roof anchors according to FIG. 6 properly installed on a roof according to a preferred embodiment of the invention;

FIGS. 31A-31D show preferred embodiments of a roof safety system according to Applicant's prior U.S. Pat. No. 8,292,030 to illustrate operational deficiencies of that system for comparison to the improvements made with a preferred embodiment of a roof anchoring system according to the invention;

FIG. 32 is a perspective view of a user connected to a primary anchor line via a lanyard and a user slidable anchor according to one preferred embodiment of using a roof safety system according to the invention;

FIG. 33 is a perspective view of user connected to a primary anchor line via a lanyard connected to an adjustable lifeline with a user slidable anchor, with the adjustable lifeline connected to a primary anchor line with a line slidable anchor according to one preferred embodiment of using a roof safety system according to the invention;

FIG. 34A is a perspective view of a user facing in a down-roof direction on a corner, connected to two adjustable lifelines to prevent a fall from either of the two fall hazards that are on each side of the corner, according to another preferred embodiment of using a roof safety system according to the invention;

FIG. 34B is a perspective view of a user facing in an up-roof direction on a corner, connected to two adjustable lifelines to prevent a fall from either of the two fall hazards that are on each side of the corner, according to another preferred embodiment of using a roof safety system according to the invention;

FIGS. 35A-35G are top plan views of various preferred embodiments of a roof safety system according to the invention as used on varying roof configurations;

FIG. 36A is a top plan view showing a rope access system according to one preferred embodiment of the invention as installed on a roof, allowing a rope access user to ascend and descend on one line that is hanging from the side of the roof and use a second line as a safety line, in case the first line fails;

FIG. 36B is a front elevation view showing a user connected to the rope access system of FIG. 36A;

FIG. 37A is side elevation view of a hand ascender 183B slidably connected to a working line of the rope access system of FIGS. 36A-B according to a preferred embodiment of the invention;

FIG. 37B is side elevation view of a chest ascender slidably connected to a working line of the rope access system of FIGS. 36A-B according to a preferred embodiment of the invention;

FIG. 37C is a side elevation view of a user connected to a working line via a chest ascender (of FIG. 37B) and a hand ascender (of FIG. 37A) with a foot loop according to one preferred embodiment of using a rope access system with a roof safety system according to the invention;

FIG. 37D is side elevation view of a descender (partially shown in shadow lines through a user's hand) according to a preferred embodiment of the invention;

FIG. 37E is a perspective view of a user connected to a working line via a descender according to one preferred embodiment of using a rope access system with roof safety system according to the invention;

FIG. 38 is a partial front elevation view of a preferred embodiment of a safety system according to the invention with an anchor line disposed over a significant ridge/primary ridge on an exemplary roof;

FIG. 39 is a top plan view of a preferred embodiment of a safety system according to the invention showing various preferred placement locations of a second roof anchor relative to a first roof anchor on an exemplary roof;

FIG. 40 is a top plan view of a preferred embodiment of a safety system according to the invention showing various preferred placement locations of a sliding anchor connecting a primary anchor line and a secondary anchor line to support a third roof anchor on an exemplary roof;

FIG. 41 is a top plan view of a preferred embodiment of a safety system according to the invention showing preferred placement locations and a non-preferred location of a second roof anchor relative to a first roof anchor on an exemplary roof.

For simplicity of the drawings, certain components or steps of the systems and methods of the invention may not be shown in a particular drawing even though such components or steps may also be included in or used with the other components or steps that are illustrated in that drawing.

### DETAILED DESCRIPTION OF PREFERRED EMBODIMENTS

As used herein, portions of a roof structure are designated by certain letters, such as V for a valley, G for a gable ridge, H for a hip, P for a primary ridge, F for a front/rear edge, S for a side edge, and E for an eave. Any such letter including a prime indicator (e.g., left side edge S′ or rear edge F′) is intended to indicate a roof portion that is substantially opposite a similar roof portion without the prime indicator (e.g., right side edge S or front roof edge F). The description of various preferred embodiments of the invention in relation to such portions of the roof structure are not intended to be limiting. For example, a roof anchor 100-1 is primarily described herein as being installed on a right side edge S, but can also be installed on left side edge S′, front edge F, or rear edge F′. The references to the portions of the roof structure are only for ease of understanding the various preferred embodiments of roof safety systems according to the invention and how components thereof are configured and oriented relative to each other during installation on a roof and use of such safety systems.

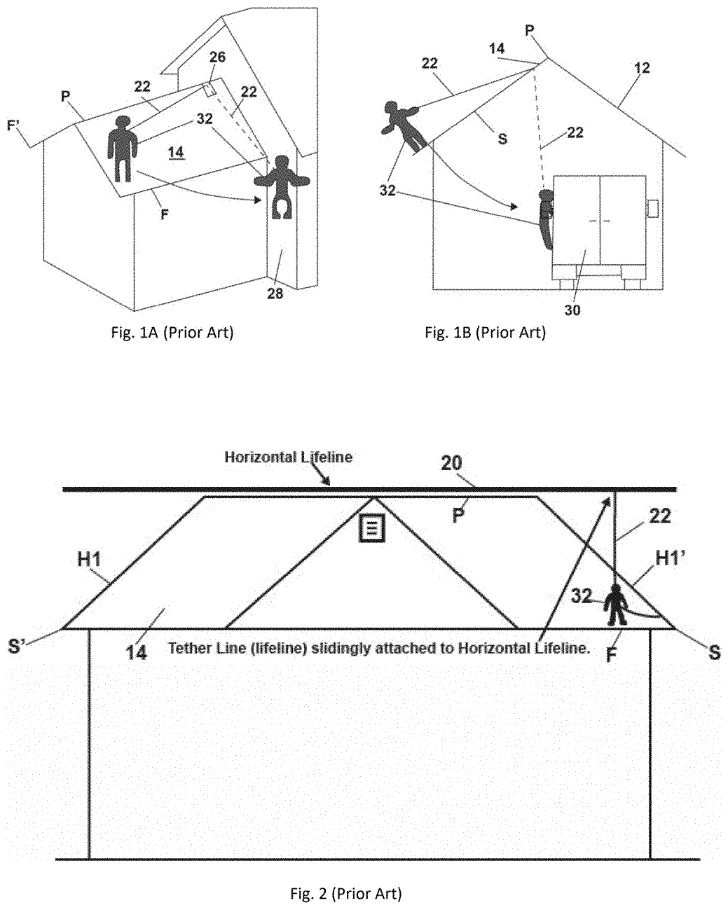

A typical prior art single anchor point roof-anchoring system is depicted in FIGS. 1A-1B. In this prior art safety system, a single anchor point 26 is attached to a roof, such as on a front sloped surface 14 of a roof. A user needing to access the roof to complete a task (such as inspection or repair or installation of a new fixture) wears a harness connected to a first end of a personnel cable 22 or lanyard comprising a rope, strap, or tether line. A second end of the personnel cable 22 is connected to the anchor point 26. This prior art system provides some safety for the user in preventing the user from falling from the roof and hitting the ground. However, there are still several drawbacks to this type of system. First, the anchor point 26 is typically screwed or nailed into the surface 14 (penetrating the roof's surface). This requires repair of the roof if anchor point 26 is removed after the task is complete or requires sealing that is subject to failure if the anchor point 26 is left installed on the roof after the task is complete. Second, it limits the ability of the user to move about and access all parts of the roof. The user is limited by the position of anchor point 26 on the roof and the length of the personnel cable 22. The length of the personnel cable 22 has to be relatively short to prevent the user from hitting the ground if there is a fall. Third, while it aids in preventing the user from hitting the ground in the event of a fall, it does not prevent a “swing fall,” which can cause serious injury or death. For example, if the user is standing on the sloped surface 14 near a front edge of the roof F or a side edge of the roof S and slips off edge F or S, the user will swing as shown by the arrows in FIGS. 1A-1B. Depending on the position of vertical obstacles, such as 28, 30, and the length of personnel cable 22, the user may impact the vertical obstacle 28, 30. Finally, installing anchor point 26 also requires a user to be on and move about the roof, prior to the anchor point 26 being anchored to the roof. Unless a secondary fall prevention system is used, installation of this type of fall protection is hazardous.

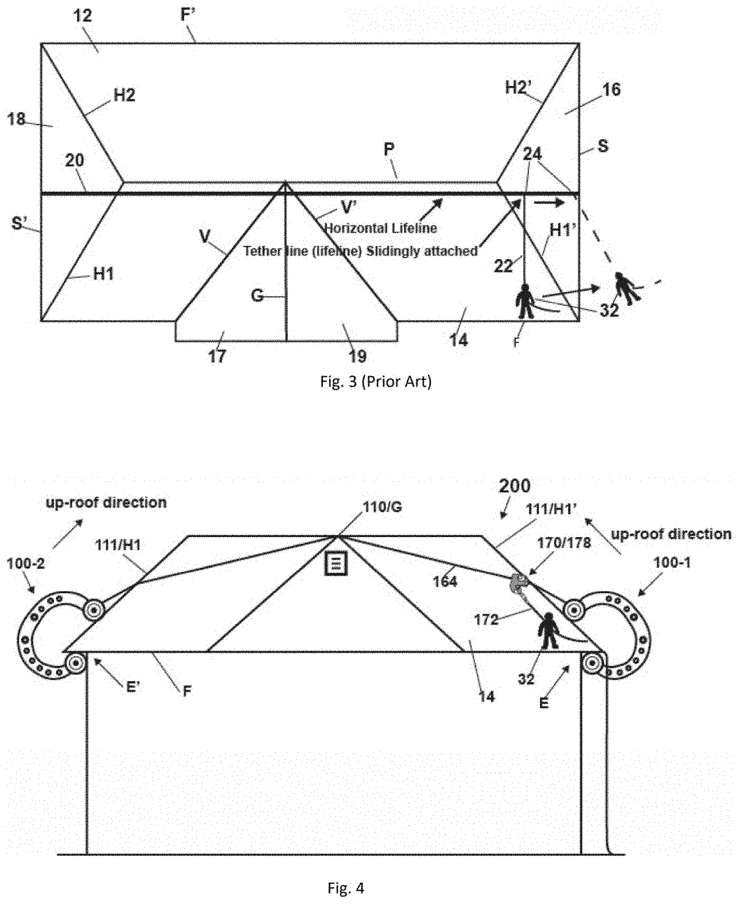

A typical prior art horizontal lifeline safety system is depicted in FIGS. 2-3. In this prior art safety system, a horizontal lifeline 20 (a single line, such as a rope or cable) extends across a roof, such as primary ridge P. A user needing to access the roof to complete a task (such as inspection or repair or installation of a new fixture) wears a harness connected to a first end of a personnel cable 22. A second end of the personnel cable 22 is connected to the horizontal lifeline 20 via a slidable connector 24 (such as a carabiner or snap hook). Connector 24 allows the user to slidably move along the length of horizontal lifeline 20. Although a horizontal lifeline system provides greater range of movement around the roof than using a single anchor point system, it still presents the potential problem of swing falls, particularly from a residential roof. A horizontal lifeline system works well with a flat roof or gable roof with a single primary ridge P, but these types of horizontal lifelines systems are rarely used on most residential rooftops because the rooftops are not just horizontal, they are also sloped in multiple directions (such as front 14, back 12, right side 16, and left side 18) with various gables G, hips H, H′, and valleys V, V′ where the sloped surfaces meet. The hips, or corners, where two slopes meet (such as hip H1 or H2 where a front slope 14 or a rear slope 12 meet a left side slope 18 or hip H1′ or H2′ where front slope 14 or rear slope 12 meet a right side slope 16) can be particularly dangerous when using a horizontal lifeline 20. For example, when the user is standing on or near a corner H1′ (as shown in FIG. 3), the user will be prevented from a fall from one of the roof edges, such as front edge F using a personnel cable 22 connected to a horizontal lifeline 20, but the user is likely not protected from a fall from the adjacent roof side edge S. And, if the user falls from the roof edge S that is subject to the fall hazard, a potentially dangerous swing fall could result. Additionally, during the fall, because the attachment of the personnel cable 22 via connector 24 to the horizontal lifeline 20 is freely slidable, the connector 24 will likely slide to the end of the horizontal lifeline 20 at roof edge S, resulting in increased fall distance and increased risk of injury and death.

A horizontal lifeline system also suffers from installation problems. A horizontal lifeline 20 may be anchored to the roof surface using a penetrating anchor or connection device at two or more locations along the line (not shown, similar to attaching single anchor point 26) or may be anchored to another structure disposed off the roof surface (such as a nearby tree, also not shown) that is sturdy and strong enough to withstand the impact forces of a fall. When anchored directly to the roof, not only is there damage to the roof that needs to be repaired, but a user must be on and move about the roof to attach the anchor points (similar to the single anchor point system). Unless a secondary fall prevention system is used, installation of a horizontal lifeline system is hazardous.

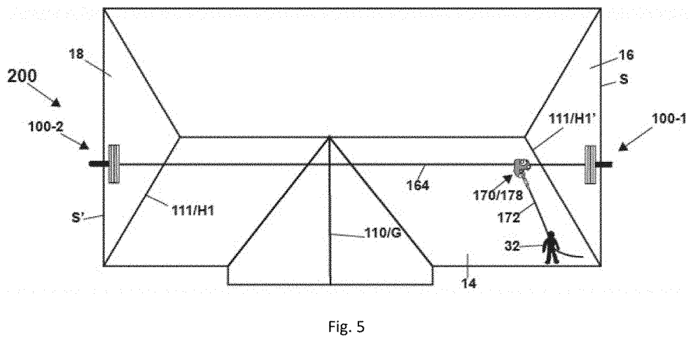

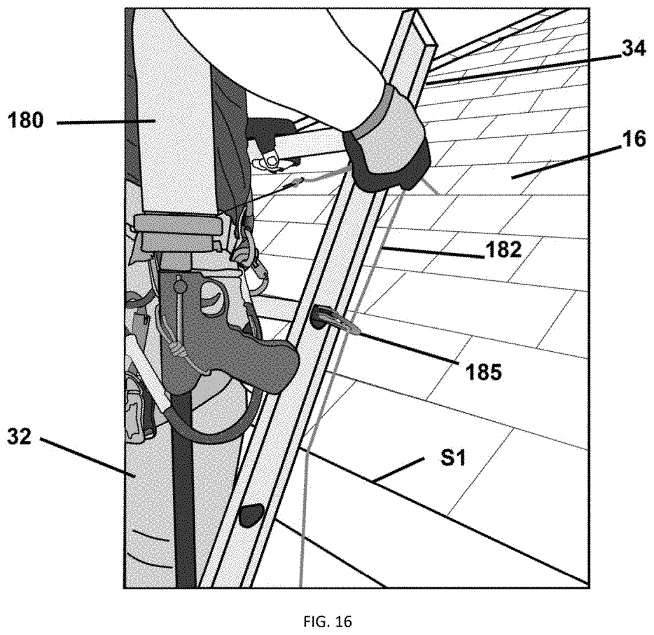

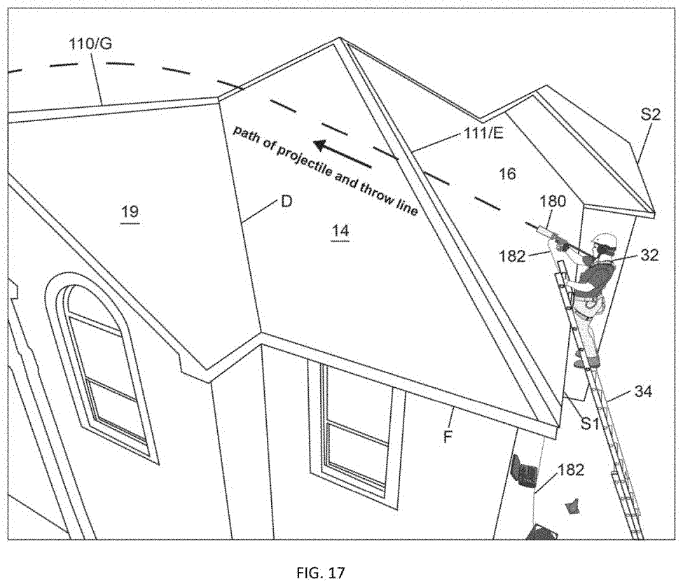

Systems and methods according to preferred embodiments of the invention solve the problems of the prior art safety systems. Roof safety systems according to preferred embodiments of the invention, and methods of installing and using such systems, are depicted in FIGS. 4-30 and 32-41.

Preferred Roof Safety System Components

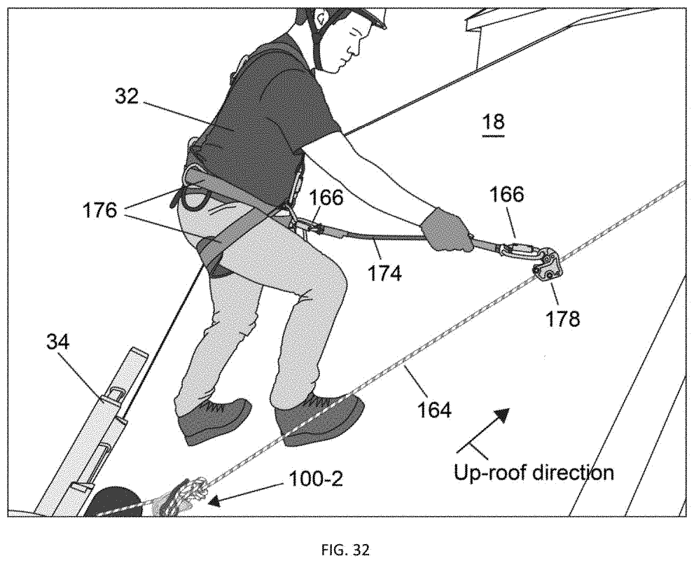

Referring to FIGS. 4-5, a roof safety system 200 according to a preferred embodiment of the invention comprises at least two roof anchors or hooks 100 (e.g. 100-1, 100-2), at least one primary anchor line 164 disposed between the two roof anchors or hooks 100-1, 100-2, at least one lifeline connectable to a user, and at least one repositionable sliding anchor 170 comprising a line sliding anchor 178 (See FIG. 32) to connect the lifeline to the primary anchor line 164. According to another preferred embodiment, there are at least two repositionable sliding anchors 170 comprising the line sliding anchor 178 and a user sliding anchor 177, with the user sliding anchor 177 connected to the lifeline to make it an adjustable lifeline 172. A first roof anchor 100-1 is hooked onto a bottom surface or eave E of a roof edge (such as right side edge S) and a second roof anchor 100-2 is hooked onto a bottom surface or eave E′ of a roof edge (such as left side edge S′) substantially opposite of roof anchor 100-1. As further described below, a user need not climb onto the roof to position or secure roof anchors 100-1, 100-2 or to connect primary anchor line 164, so the risk of falls during installation is minimized. Additionally, by hooking onto the eaves E, E,′ system 200 does not require any penetration of the roof surface to be anchored to the building and does not require any nearby structures (such as a tree) to provide an anchor point.

A primary anchor line 164 is connected at a first end to roof anchor 100-1 and to a second roof anchor 100-2 at a second point distal to the first end under tension so that it is taut. Once anchors 100-1, 100-2 are installed with primary anchor line 164 between them, a portion of primary anchor line 164 (and optional secondary anchor line 168, described below) will make direct contact with at least a portion of the roof surface, preferably at a point on at least one ridge on the roof. Safety system 200 may further comprise one or more mats to place on those points of contact, between the roof's surface and the anchor line 164 (or 168) to protect the roof from an abrasion or rubbing by the anchor line 164 (or 168). The anchor line 164 (or 168) may rub against the roof during slight movement of the anchor line created as a user moves about the roof applying lateral tension or pulling forces on the anchor line 164 (or 168) and when the system is dismantled. Although not typically required, multiple sets of primary roof anchors 100-1, 100-2 each with a primary anchor line 164 may be installed at different locations on the same roof. Preferably, a single set of primary roof anchors 100-1, 100-2 with a single primary anchor line 164 is installed. Most preferably, each primary anchor line 164 is a single, continuous piece of rope or tether line of sufficient strength to withstand the forces of a user falling. Using at least two roof anchors (primary roof anchors) 100-1, 100-2 disposed substantially opposite from each other and connected by primary anchor line 164 under tension, the primary roof anchors 100-1, 100-2 are securely held in position relative to the roof and each other until a user releases them.

Once anchors 100-1, 100-2 and primary anchor line 164 are installed, any forces from a user connected to line 164 created by the user falling will be divided by the two anchors, so that each anchor 100-1, 100-2 received shared portion of the force created by the fall. As additional anchors 100-3, etc. and secondary anchor line 168 are connected, the forces may be further divided between the components as will be understood by those of ordinary skill in the art. Most preferably, combined and properly installed components of safety system 200 are configured to hold at least 5,000 pounds to sufficiently absorb the forces of a fall by a user connected to safety system 200. Preferably, each anchor 100 is configured to hold at least, 5,000 pounds.

One or more lifelines may also be used, each to connect a user to a primary anchor line 164 to allow one or multiple users to access the roof simultaneously with a single primary anchor line 164. A lifeline allows a user to be connected to primary anchor line 164 (or an optional secondary anchor line 168) and move about the roof in any direction relative to primary anchor line 164 (or optional secondary anchor line 168), although movement in certain directions may require use of additional optional features in system 200 as further discussed below. A lifeline may be a fixed length lifeline, like used in the prior art, where a length of the lifeline between the user (or the user's lanyard) and the anchor line to which it is connected (using a line sliding connector 178) is fixed. More preferably, a lifeline is an adjustable lifeline 172, where a length of the lifeline 172 between the user 32 (or the user's lanyard 174) and the primary anchor line 164 is selectively adjustable by the user using a repositionable user sliding anchor 177 connected to the adjustable lifeline 178. As a user 32 moves user sliding anchor 177 on adjustable lifeline 172 towards line sliding anchor 178 on anchor line 164, the length of adjustable lifeline 172 between the user 32 and anchor line 164 becomes shorter, while a free end 172′ of adjustable anchor line becomes longer. As a user 32 moves user sliding anchor 177 on adjustable lifeline 172 away from line sliding anchor 178 on anchor line 164, the length of adjustable lifeline 172 between the user 32 and anchor line 164 becomes longer, while a free end 172′ of adjustable anchor line becomes shorter.

A repositionable sliding anchor 170 (or simply, sliding anchor or slidable anchor) is configured to allow free movement along a rope or tether line (such as primary anchor line 164 or an adjustable lifeline 172) in a first direction and block or resist movement in a second direction substantially opposite the first direction unless the user actuates a trigger allowing free movement in the second direction. Such a sliding anchor 170 includes commonly known devices “goblin” or “camp goblin” or a “rope grab.” The mechanisms of such sliding anchors 170 are well understood by those of ordinary skill in the art. By blocking movement in the second direction (when not actuated), the sliding anchor 170 is configured to repositionably connect and anchor at any point/position on the line to which the repositionable sliding anchor 170 is connected. This allows a user to selectively adjust the positioning of an anchor point on the primary anchor line 164 to allow access to different areas of the roof, in contrast to the use of a fixed anchor point 26 in the prior art. It also allows a user to selectively adjust the length of adjustable lifeline 172 to allow the user to shorten or lengthen it relative to anchor line 164 depending on the relative configuration of the roof, positioning of anchor line 164 on the roof, and location of the task to be performed.

Each sliding anchor 170 is preferably configured to allow a slidable connection to a line and a fixed connection to a second line or other component (such as a harness). As used herein, slidably connected (or slidingly connected or similar wording) refers to connecting slidable anchor 170 to a line so that slidable anchor 170 may freely slide along that line in the first direction when the user moves slidable anchor 170 in the first direction (preferably indirectly by movement of the user in the first direction) and blocks movement in the second direction substantially opposite the first direction unless the user actuates slidable anchor 170 to allow movement in the second direction. As used herein, fixedly connects (or similar wording) means that slidable anchor 170 is connected to an end of a line in a manner which allows the slidable anchor 170 and end of the line to move (relative to a different line) together and not separately. For example, when an end of a lifeline is connected to an aperture on a slidable anchor 170, the slidable anchor 170 cannot slide relative to the lifeline, but the two are fixedly connected and would move together as slidable connector 170 slides along another line, such as primary anchor line 164. Fixedly connected does not mean that there is no movement of the end of the connected line (e.g., a lifeline) and slidable connector 170, as the end of the line may move slightly relative to connector 170 based on movement of a connector (such as a carabiner) connecting the end of the line to the aperture on the sliding anchor 170.

Although it is possible to use different versions of a slidable anchor 170 as a line slidable anchor 178 or a user slidable anchor 177, they are most preferably the same device and interchangeable, with the only difference between a slidable anchor 177 and 178 being the type of line to which it is slidably connected. A line slidable anchor 178 is slidably connected to an anchor line 164 and may be fixedly connected to a lifeline or a secondary anchor line 168. A user slidable anchor 177 is slidably connected to an adjustable lifeline and may be fixedly connected to a lanyard 174.

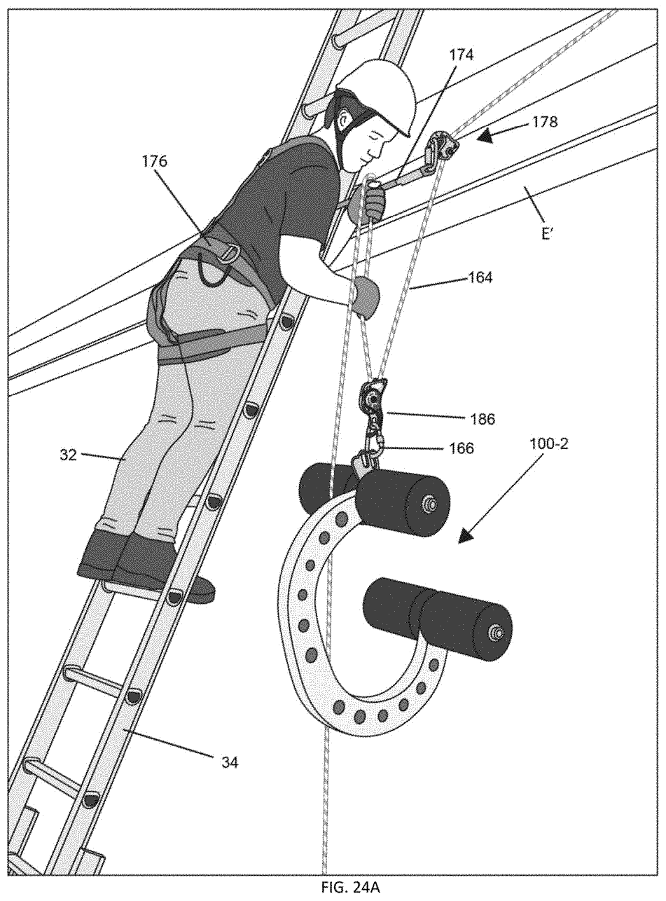

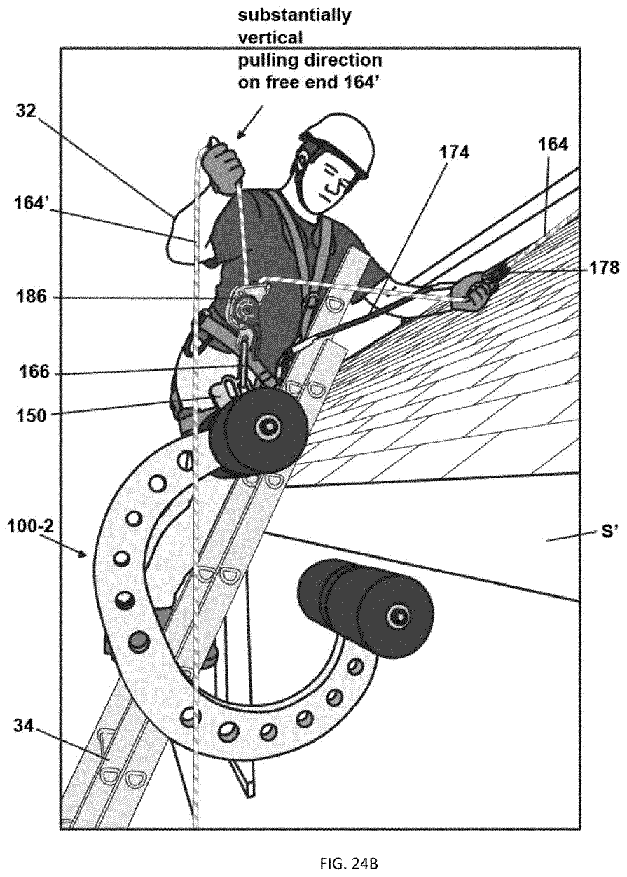

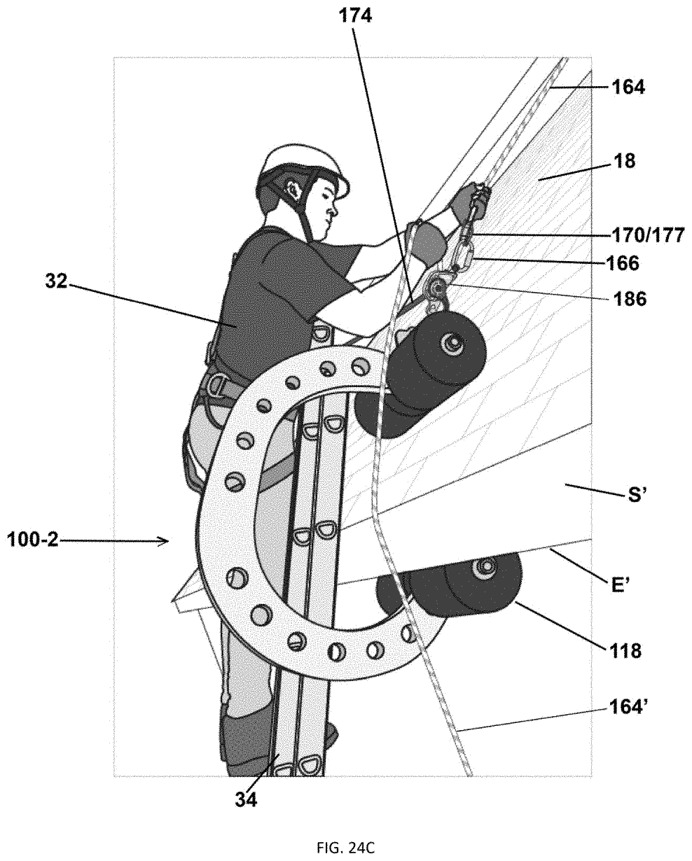

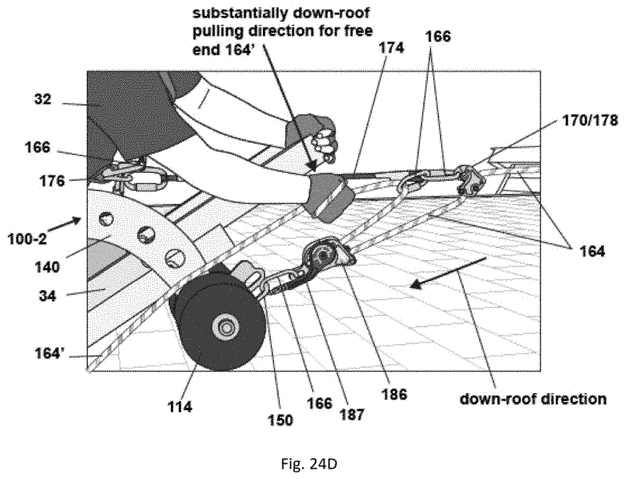

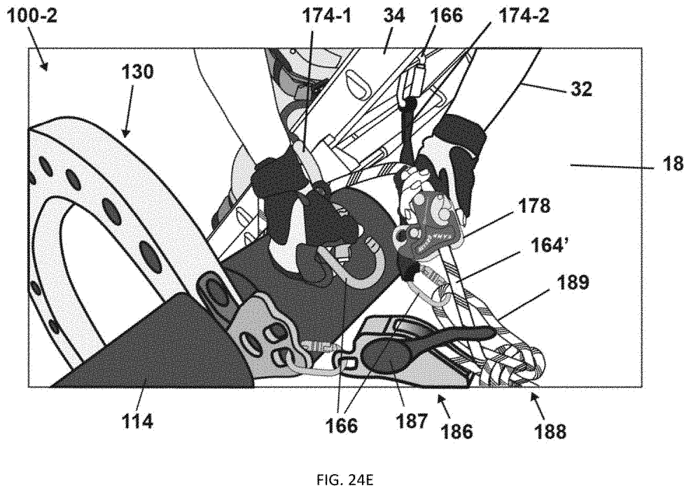

According to another preferred embodiment, roof safety system 200 preferably comprises at least one progress capture/tensioning device 186, preferably one that allows for a mechanical advantage. A progress capture/tensioning device 186, such as a progress capture pulley or a ratchet, is connected to primary anchor line 164 (see FIGS. 23, 24A-D, and 30) between primary roof anchors 100-1, 100-2 and, preferably, near roof anchor 100-2. Progress capture/tensioning device 186 is configured to allow tension to be applied on an anchor line 164, 168 to take up slack on the anchor line between the progress capture/tensioning device and a connection point. For taking up slack on anchor line 164, the connection point is roof anchor 100-1. For taking up slack on a secondary anchor line 168, as further described below, the connection point is primary anchor line 164. Progress capture/tensioning device 186 applies sufficient tension to anchor line 164, 168 that it can support a user if a user falls while connected to (directly or indirectly) anchor line 164, 168 and restrain the user's fall to prevent the user from falling to the ground, and more preferably from falling off the roof's surface. Progress capture/tensioning device 186 is further preferably configured to only allow movement of the anchor line 164, 168 through the device in a first direction (that tightens the line) unless a user actuates progress capture/tensioning device 186, such as by lever 187, to allow movement of the anchor line 164, 168 in a second direction (that loosens the line). The second direction for progress capture/tensioning device 186 is substantially opposite the first direction. For example, progress capture/tensioning device 186 preferably allows a user to pull on a free end (164′ as shown in FIGS. 24C-D and 25) of primary anchor line 164 in the first direction, which moves anchor line 164 through progress capture/tensioning device 186 in a direction from anchor 100-1 towards 100-2, to apply tension to primary anchor line 164 between roof anchors 100-1, 100-2 to make anchor line 164 taut between them. Generally, once the second roof anchor 100-2 is in position with its rear wheels 116, 118 in contact with an eave E, as further described below, one or two pulls on free end 164′ (FIG. 24C) pressing rear wheels of the anchor hooks firmly against the eaves, by an average adult is sufficient to create the required amount of tension on primary anchor line 164 to allow use of safety system 200.

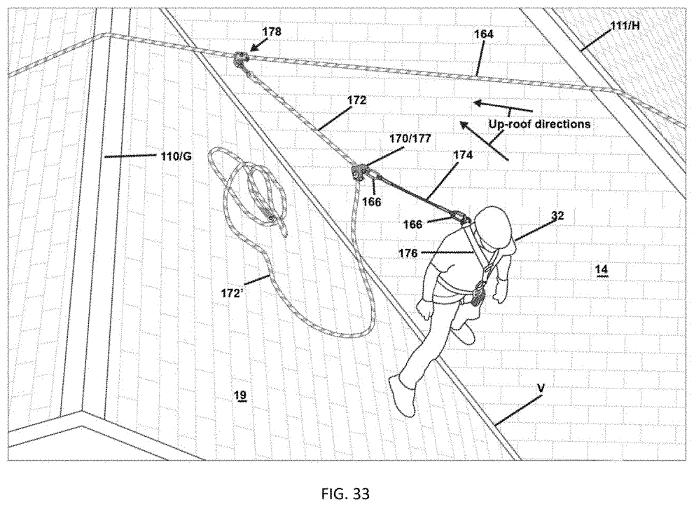

According to another preferred embodiment, roof anchoring system 200 further comprises at least one harness 176, at least one lanyard 174 comprising a short length of rope, strap, chain, or tether line, and a plurality of connectors 166 (such as a carabiner, snap hook, trigger snap, bolt snap, traditional buckle, or side-release buckle that allows selective, easy, and secure connection or disconnection of two components). Alternatively, these components may be separate from roof anchoring system 200. As shown in more detail in FIGS. 32 and 33, a user preferably wears a harness 176 connected to a lanyard 174, which is in turn connectable to an adjustable lifeline 172 or a primary anchor line 164 via a sliding anchor 170. A harness 176 preferably extends over the user's shoulders and around each of the user's legs and has one or more connection points, such as a D-ring.

Harness 176 is a typical harness with adjustable straps that go over a user's shoulders, around the user's waist, and around and through the user's legs, with one or more connection points, such as a D-ring. Connection points are preferably located on a front side of harness 176 in a sternum and a ventral area and on a back side of harness 176 in an area between the user's shoulders.

A user uses connectors 166 to connect (1) a first end of lanyard 174 to a connection point on the harness and (2) a second end of lanyard 174 to an aperture on sliding anchor 170. Connectors 166 allow lanyard 174 to be selectively and easily connected to or disconnected from harness 176 and sliding anchor 170 by a user. Alternatively, one or more lanyards 174 may be more permanently affixed to harness 176 by a fixed D ring connection or by stitching or adhesives, or may be tied onto another component with a knot, without requiring use of a connector 166.

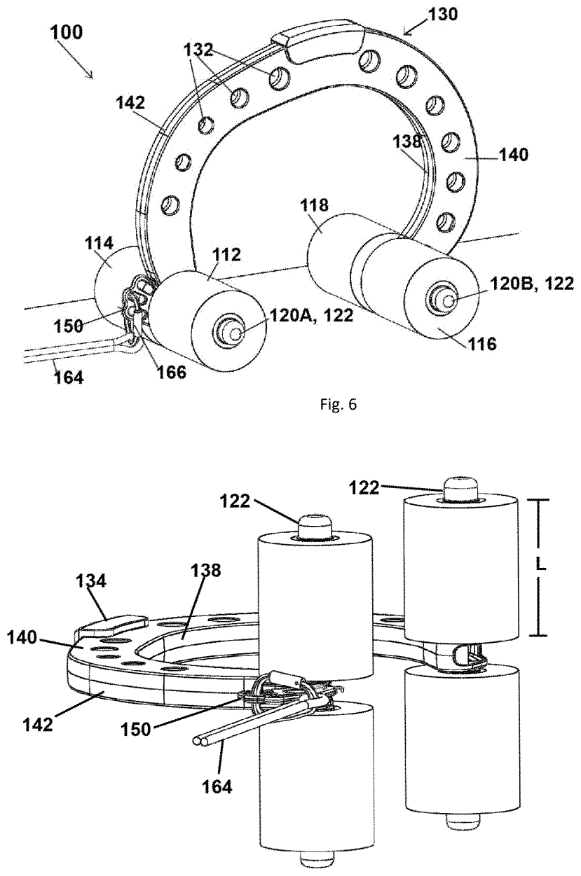

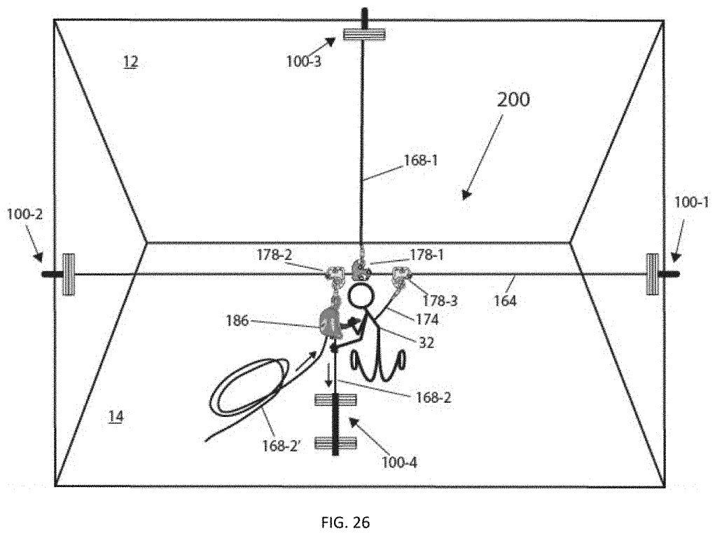

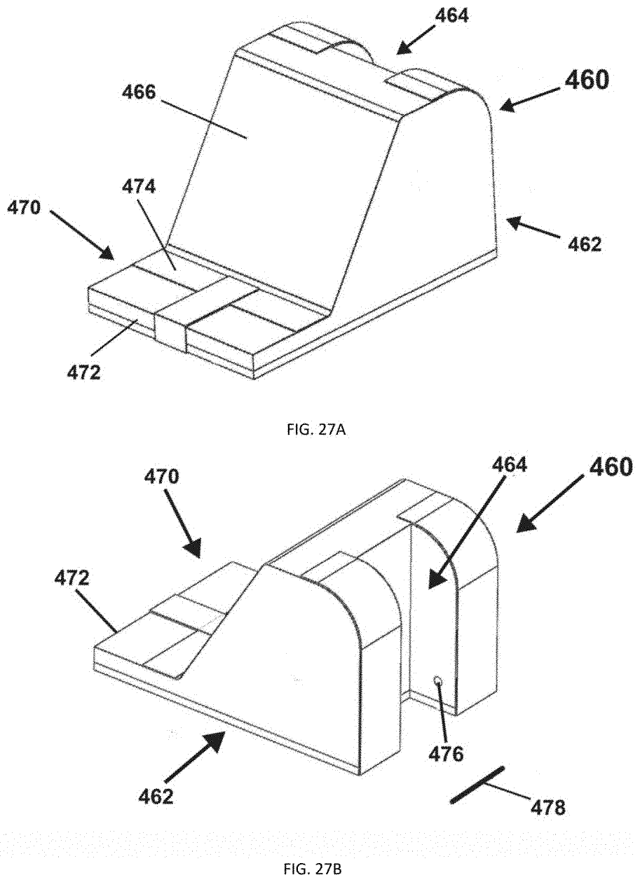

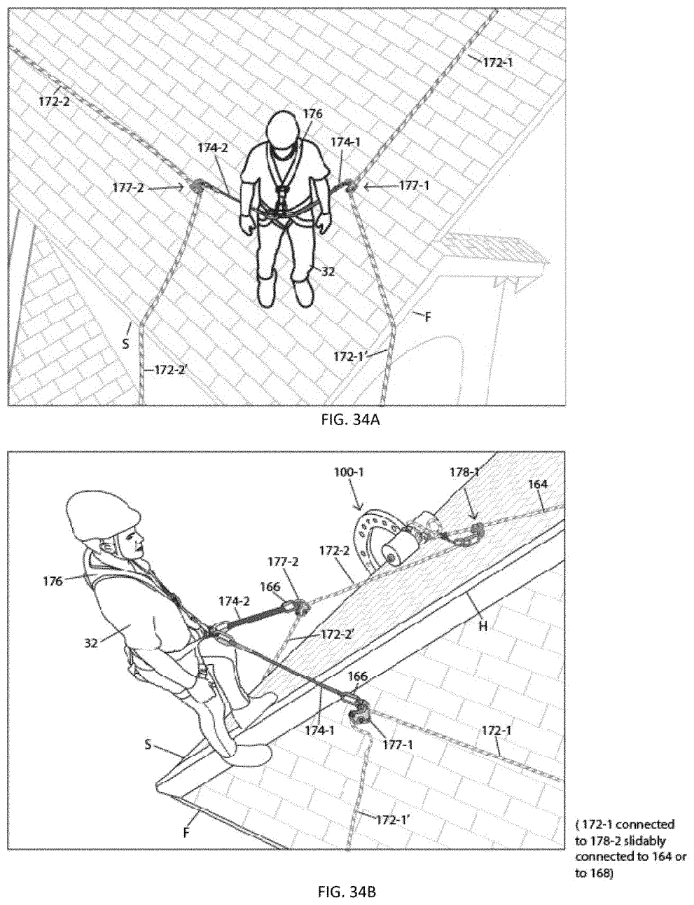

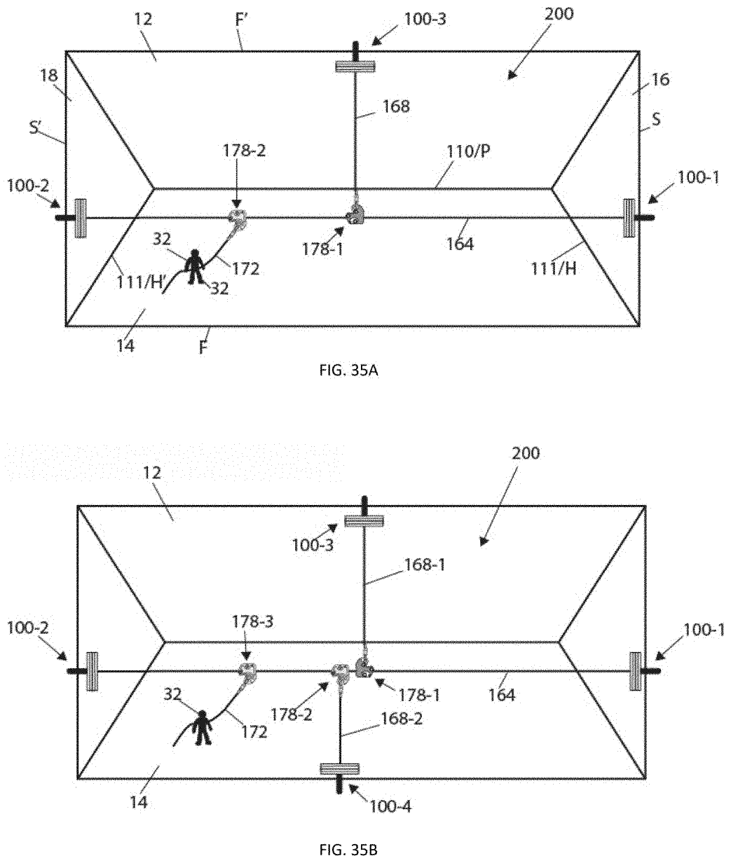

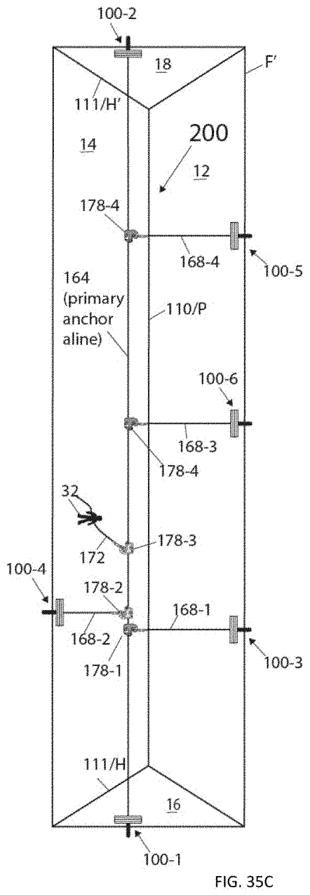

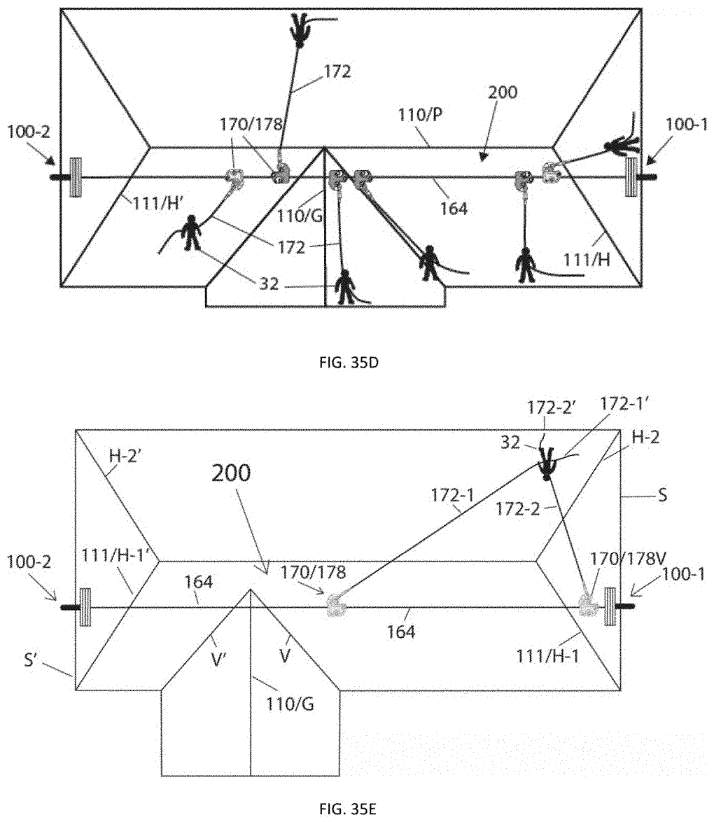

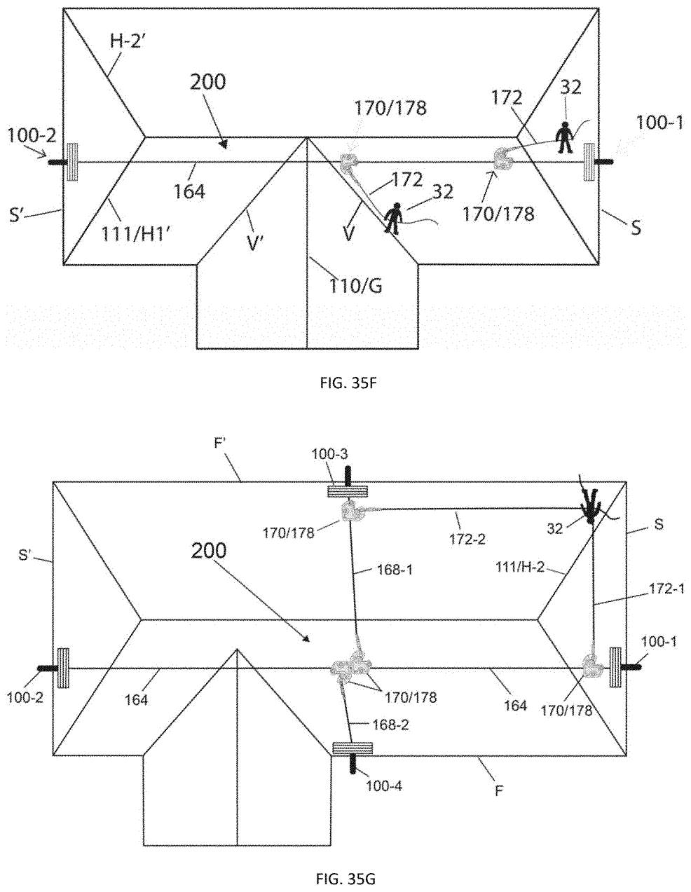

Referring to FIGS. 26, 35A-C, 35G, and 40-41 according to another preferred embodiment, safety system 200 further comprises one or more additional (or secondary) roof anchors (e.g., 100-3, 100-4, 100-5, 100-6, etc.) and one or more secondary anchoring lines 168. Each secondary roof anchor 100-3, 100-4, etc. is preferably structurally identical to each primary roof anchor 100-1, 100-2 as shown with respect to roof anchor 100 in FIGS. 6-11 discussed in more detail below. Each secondary anchor line 168 is also preferably structurally identical to primary anchor line 164, comprising a single, continuous piece of rope or tether line of sufficient strength to withstand the forces of a user falling. The difference between these primary and secondary components is the configuration of connection between them in safety system 200. Each secondary roof anchor 100-3, 100-4, etc. is hooked onto an eave E similar to primary roof anchors 100-1, 100-2 and is connected to one end of a secondary anchoring line 168. Each secondary anchor line 168 is connected at a second point (located distal to the first end) to primary anchor line 164, rather than connected to another secondary roof anchor. Each secondary anchor line 168 is connected to a primary anchor line 164 and a secondary roof anchor 100-3, etc. under tension so that it is taut, preferably using a progress capture/tensioning device 186 and pulling on a free end 168′ of the secondary anchor device as previously described for tightening primary anchor line 164. Most preferably, each secondary anchor line 168 is connected to primary anchor line 164 such that line 168 is substantially perpendicular to line 164. When tensioning a secondary anchor line 168 and there is no secondary anchor line directly on the opposite side that is attached to the same primary anchor line, the secondary anchor line shall be tensioned until the rear wheel of the anchoring device is contacting the bottom of the eave but preferably not so much that the primary anchor line deviates by more than +/−7.5°. If tensioning a secondary anchor line 168-2 that is directly opposite of an installed secondary anchor line 168-1, with both secondary anchor line attachments to the primary anchor line 164 being adjacent or near adjacent to each other, on the same primary anchor line, then the anchor line 168-2 preferably is tensioned, at its anchoring device (e.g. 100-4), in the same manner as the primary anchor line 164 at the second roof anchor 100-2, to include tensioning with a mechanical advantage, shown in FIG. 24D, as was preferably done with the second roof anchor 100-2 on the primary anchor line 164. With most ropes used as anchor lines, when secondary anchor line 168-1 does not have an opposite secondary anchor line 168-2 attached to the primary anchor line 164, then a lifeline 172 attached to this secondary anchor line 168-1 might only allow protection of a user that is working in directions that are perpendicular to the primary anchor line 164 since the tension in the secondary anchor line 168-1 will not be as strong in other directions; however, if there is another secondary anchor line 168-2 with a mechanical advantage that is opposite the secondary anchor line 168-1, then the user is able to be protected in all directions, while attached to the primary anchor 164 line or either secondary anchor lines 168-1, 168-2. Additionally, if the primary anchor line 164 and secondary anchor line 168-1 are tensioned enough, and the potential sag of the anchor lines is small enough, then a user attached to a secondary anchor line 168-1, without an opposing secondary anchor line 168-2, will be able to be protected in all directions. (Throughout the remainder of this document, unless stated otherwise, for the sake of clarity, it will be assumed that all secondary anchor lines can protect a user from falls in all directions.) Secondary anchor lines 168 also serve to support the primary anchor lines 164 to prevent sag.

An adjustable lifeline 172 may be connected to a primary anchor line 164 or a secondary anchor line 168 (after line 168 is connected to primary anchor line 164) to provide greater access to the entirety of the roof surface as needed by the user. Additionally, a user may use multiple adjustable lifelines 172 (such as lines 172-1, 172-2 as shown on FIGS. 34A-B), each connected to a different primary or secondary anchor line 164, 168 or each connected to different points on the same primary or secondary anchor line 164, 168. Most preferably, a user will not use more than two adjustable lifelines 172 at a time. Using two adjustable lifelines 172, either (1) both connected to a primary anchor line 164 at spaced-apart locations as shown in FIG. 35E or (2) one connected to a primary anchor line 164 and the other connected to a secondary anchor line 168 as shown in FIG. 35G, particularly provides protection against falls near corners of the roof, such as outer end points of hip H-2, and reduces the risks of swing falls. Various other configurations of the components of safety system 200 may be used as needed depending on the configuration of the roof, the portions of the roof that a user needs to access, and the number of users to be on the roof at any given time during completion of a task or tasks.

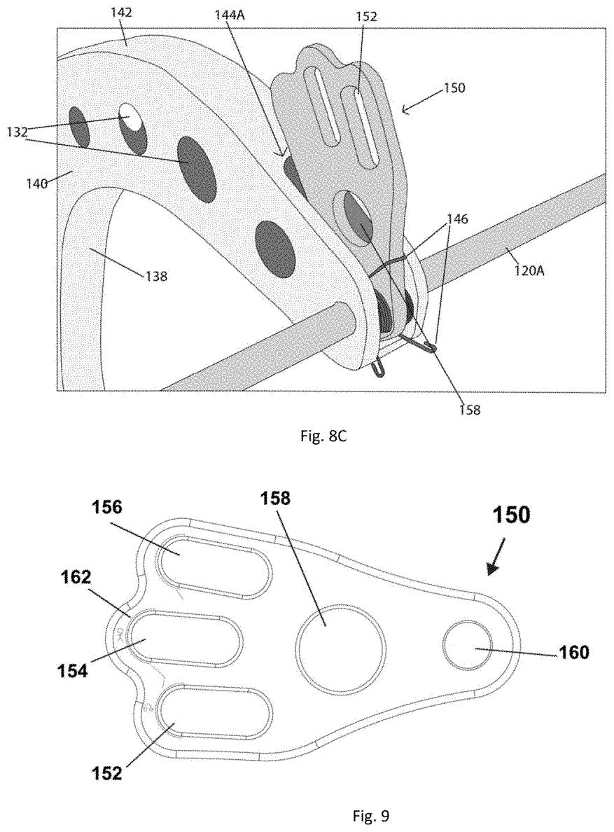

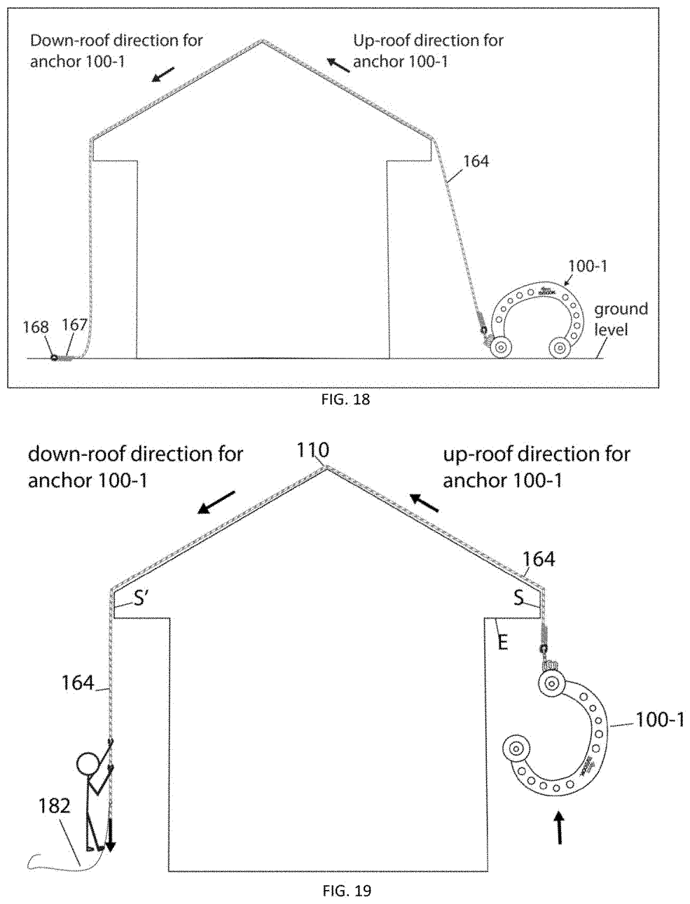

Primary anchor line(s) 164, second anchor line(s) 168, adjustable lifeline(s) 172, and lanyard(s) 174 comprise a rope or tether line of sufficient strength to withstand the forces of a user falling. Adjustable lifeline 172, primary anchor line 164, and secondary anchor line 168 may or may not be made of the same materials. Examples: ropes may be of nylon, polyester, Dyneema, Kevlar, or any other material that can be used for a rope, cord, or cable. Additionally, the ropes may be made of a combination of materials. One example would include a rope with a polyester core and a nylon sleeve. A rope with a Dyneema core and a polyester sleeve makes a great anchor line since the polyester sleeve works well with climbing and safety gear and the Dyneema core will make the anchor line almost three times as strong as a 100% nylon or polyester rope. A lanyard 174 may also be made of the same material or a different material. Within an engineered fall protection system, many professionals in the industry believe that all the gear must be strong enough to withstand a force of not less than 2 times the potential force that it may be subjected to when used as instructed. A first end of one or more of a primary anchor line 164, second anchor line 168, adjustable lifeline 172, optional working line 192-1 and/or optional safety line 192-2 may comprise a pre-formed loop 165 in the fabric or material of the line (as shown in FIGS. 8A and 18 for anchor line 164). Lanyard 174 preferably has a pre-formed loop 165 at each end. Loop 165 is preferably created on the line with a sewn eye termination 167 around a thimble and protected with a sheath to secure an end of the line to itself to create loop 165. A connector, such as a carabiner 166 or a snap hook, preferably made of metal, may be attached to the loop, so the end may easily be connected to other components. A second end of one or more of a primary anchor line 164, second anchor line 168, adjustable lifeline 172, and/or lanyard 174 may also be similarly configured so that the ends of the line are interchangeable. Alternatively, one or both ends of one or more of a primary anchor line 164, second anchor line 168, adjustable lifeline 172, and/or lanyard 174 do not include a pre-formed loop or ring, rather one or both ends are connected to another component, such as a connector 166, by manually looping the end through the other component and then tying the end back to its respective anchor line 164, 168, adjustable lifeline 172, and/or lanyard 174 using a knot to secure the other component to line. Any combination of end types may be used with safety system 200.

A user of a roof safety system 200 according to a preferred embodiment gains an additional advantage of having a point of attachment of a connecting element or elements from his/her harness 176 to a line sliding anchor 178 to allow the user to access the full length of anchor line 164 while protected from a fall (subject to any reorientation of line sliding anchor 178 or transitioning to another line sliding anchor in a different orientation when there is a direction change from movement along anchor line 164 in an up-roof direction to a down-roof direction, as further described below). Such connecting element or elements may include, for example, attachment of at least one a lifeline (fixed length or an adjustable lifeline 172) or lanyard or rope 174 or a combination thereof between a user's harness 176 and the single, continuous anchor line 164, 168 via a line sliding element 178 to permit selective anchoring and sliding on anchor line 164, 168. Anchoring includes anchoring of the line sliding element 178 on the anchor line 164, 168 at any desired point so that the user's movement in the second direction for the line sliding element 178 is restrained or blocked. When line sliding anchor 178 is anchored on anchor line 164, 168, any connected elements such as a lifeline or lanyard 174 are also effectively anchored as movement in the second direction is only permitted as far as the length of the lifeline and/or lanyard 174 will reach from the anchored position of the line sliding anchor 178. Sliding includes sliding of the respective line sliding anchor 178 over and along the primary anchor line 164 from every first point on the common single, continuous anchor line 164 to every and any selective second point on the common single, continuous primary anchor line 164, both the first point and the second point defined between the connectors of the first and second roof anchors 100-1, 100-2. The same anchoring and sliding applies to a user sliding anchor 177 connected to an adjustable lifeline 172.

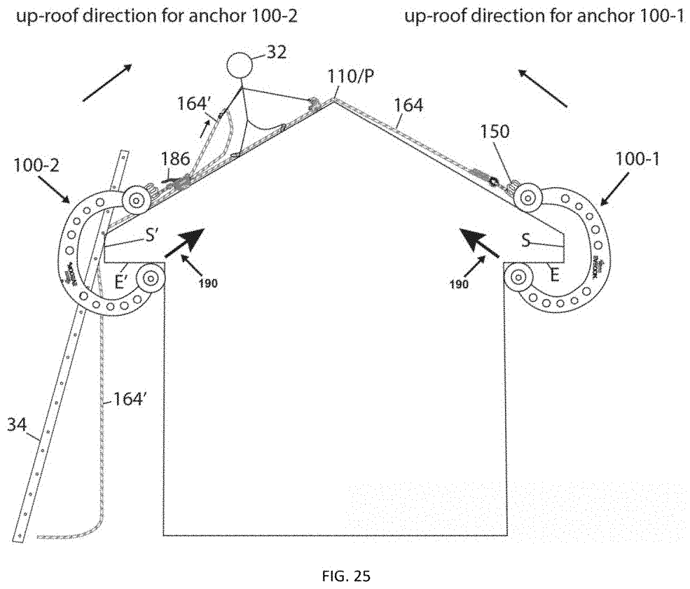

Referring to FIGS. 6-11, preferred embodiments of a roof anchor or hook 100 are shown. Most preferably roof anchor 100 comprises an arcuate body 130, a front axle 120A connected to a front end of body 130, a rear axle 120B connected to a rear end of body 130, a pivotal connector 150 disposed at or near a front end of body 130, front wheels 114, 112 disposed on front axle 120A, rear wheels 116, 118 disposed on rear axle 120B. As used herein, references to front or forward or the like generally refer to a direction that is substantially in an “up-roof” direction relative to the roof anchor as installed for use. For example, with reference to FIG. 25, an up-roof direction for anchor 100-1 is shown by an arrow on the right side of the page as being toward a ridge 110/P and away from a side S where anchor 100-1 is installed. An up-roof direction for anchor 100-2 is similarly shown on the left side of the page.

Arcuate body 130 preferably comprises a lower or inner surface 138, a top or outer surface 142, and right and left side surfaces 140. Preferably comprises a plurality of spaced-apart apertures 132 are disposed between side surfaces 140, which aid in reducing the weight of body 130. Body 130 also may comprise an optional anti-slip grip surface 134 to help prevent the anchoring device from sliding if laid on its side on the roof. Additional apertures 136A, 136B are disposed through body 130 and each configured to receive an axle 120A, 120B. Upper surface 142 preferably comprises openings 144A, 144B disposed at a front and rear ends of body 130. Opening 144A is configured to receive a pivotal connector 150 and allow it to move freely relative to body 130 without substantial interference from upper surface 142. Openings 144A and 144B are also configured to allow a visual to assist in the installation of the front and rear axles 120A, 120B (preferably with springs 146 and washers 148), respectively. A cap 122 is preferably disposed over each outward end of axles 120A, 102B. Arcuate body 130 is preferably substantially C-shaped when viewed from a side elevation and most preferably an asymmetrical C-shape that is designed to go around most roof edges and not contact the building when roof anchor 100 is in its installed position at the roof edge. Body 130 is preferably constructed of high grade aerospace aluminum to achieve the strength of steel, with half the weight.

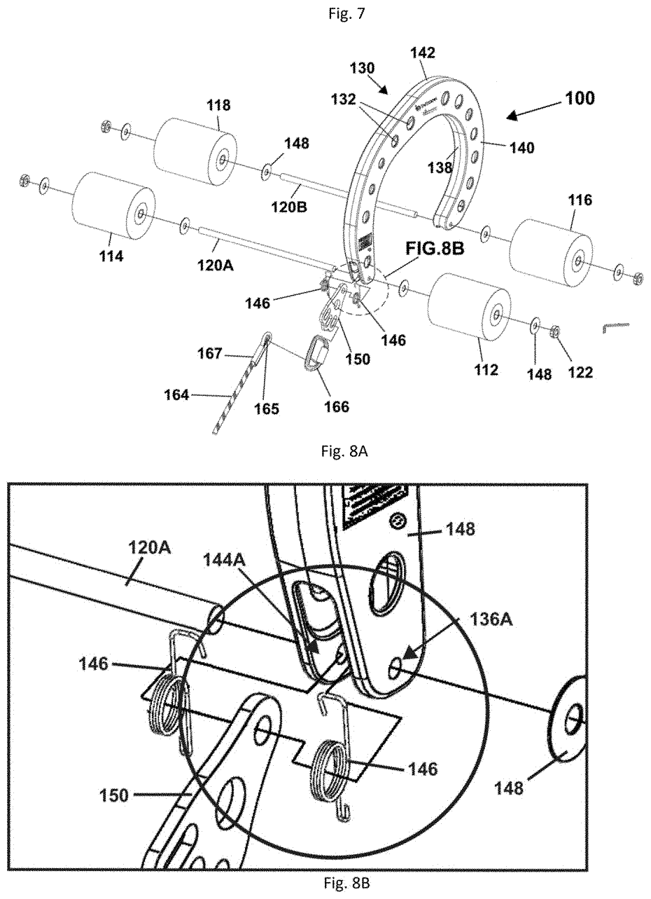

Roof anchor 100 preferably comprises four wheels, a front pair with one wheel 112 disposed on one side of body 130 and a second wheel 114 disposed on the other side of body 130, and a rear pair with one wheel 116 disposed on one side of body 130 and a second wheel 118 disposed on the other side of body 130. Each pair is disposed on its respective axle 120A, 120B. Other configurations or numbers of wheels may also be used. For example, a single front and a single rear wheel may be used with a pair of front and rear arms connecting body 130 to outer ends of axles 120A and 120B, with the single wheel disposed between each pair of arms. Additionally, more than two wheels may be disposed on each axle 120A, 120B. Wheels 112, 114, 116, 118 can generally be made of any desired materials such as rubber or plastic, for example, to allow the wheels to roll/slide easily on a roof surface particularly for a single user installation as described below. Wheels may also have an outer surface configured to be slide-resistant. Wheels 112, 114, 116, 118 are preferably around 5″ to 15″ in diameter, more preferably 7″ to 12″ in diameter and around 8″ to 12″ in length (L as shown in FIG. 7), more preferably 10″ to 11″ in length. Wheels 112, 114, 116, 118 and body 130 are preferably configured to keep body 130 from contacting any roof sloped surface (e.g., 16), any roof edge (e.g., F or S) or any eave E during installation and use of safety system 200, which aids in preventing damage to the roof structure.

As an alternative to axles and wheels, a non-rolling, fixed lateral arm may be disposed at each of the front and rear ends of body 130. Such lateral arm is preferably substantially cylindrical and sized and configured similar to a pair of wheels (e.g., 112, 144) on its axle (e.g., 120A). An exterior surface of such lateral arm is preferably made of rubber, plastic, or foam to avoid damage to surfaces (e.g., sloped surface 16 or an eave E) with which it is in contact during installation and use. A fixed lateral arm embodiment is most preferably used when at least two users are available for installation.

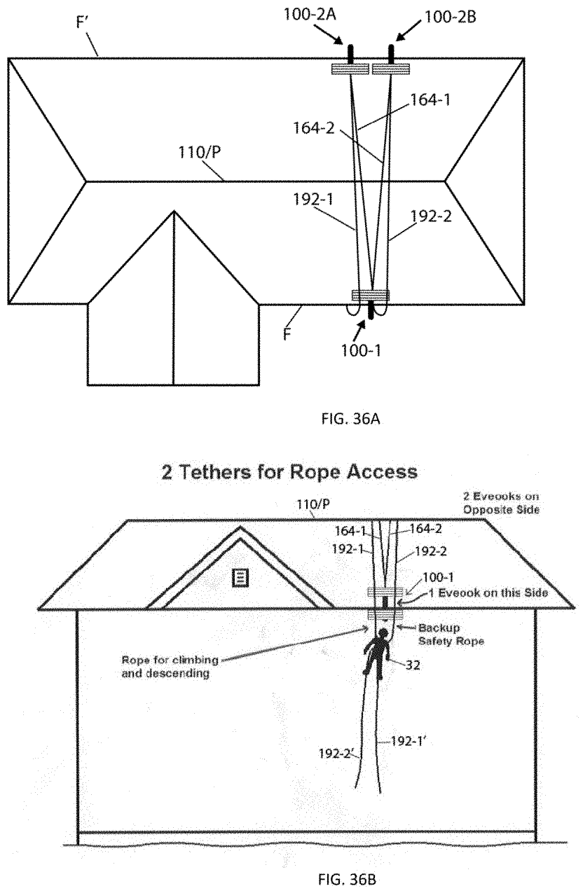

A pivotal connector 150 is pivotally attached to front axle 120A, preferably by insertion of axle 120A through a rear aperture 160, making pivotal connector 150 effectively permanently connected to roof anchor 100. Pivotal connector 150 also preferably comprises one or more other apertures, such as 152, 154, 156, and 158. A connector 166 is preferably used to connect a primary or secondary anchor line 164, 168 to pivotal connector 150 through one of the apertures in pivotal connector 150 (e.g., aperture 152). Additional apertures (e.g., 154, 156) at the front of pivotal connector 150 (generally there are 2 or 3 apertures) are made to attach to additional anchor lines and/or lifelines that are connected directly to the pivotal connector 150, such as used by rope access workers (FIG. 36A). Central aperture 158 is optional, but preferable to reduce weight of pivotal connector 150. Disposed slightly forward of each aperture 152, 154, 156 is preferably a wear indicator marking 162 (e.g., a curved line slightly forward of a forward edge of the aperture). After repeated use in connecting an anchor line 164, 168 to any of the apertures 152, 154, 156, the aperture may increase in size due to wear on a forward edge. If the forward edge of any of these apertures reaches wear indicator marking 162, then pivotal connector 150 should be replaced with a new pivotal connector 150. Alternatively, an end of a primary or secondary anchor line 164, 168 may be fed through one of the apertures on pivotal connector and then tied back to the line 164, 168 using a knot to connect the line to pivotal connector 150 without using a connector 166. As another alternative, a connector 166 that allows pivotal positioning of an anchor line 164, 168 relative to roof anchor 100 may be directly connected to axle and to anchor line 164, 168 without the use of a separate pivotal connector 150. In another alternative, an end of an anchor line 164, 168 may be directly connected or coupled to the axle without the use of connector 166 or pivotal connector 150.

Although other embodiments of connecting roof anchor 100 to an anchor line 164, 168 may be used, it is preferable to use a combination of a pivotal connector 150 directly connected to axle 120A and to the anchor line 164, 168 being used. This preferred configuration aids in preventing roof anchor 100 (or 100-1, 100-2, 100-3, etc.) from dislodging from the roof in the event of a force applied to the anchor line 164, 168 (such as from a fall), particularly if the anchor line is attached to the anchoring device at any location that does not ultimately result in pivotal attachment of the anchor line to the axle, especially if the system is not installed or maintained properly, such that the rear wheels 116, 118 of the anchoring device are not firmly pressed against the soffit,

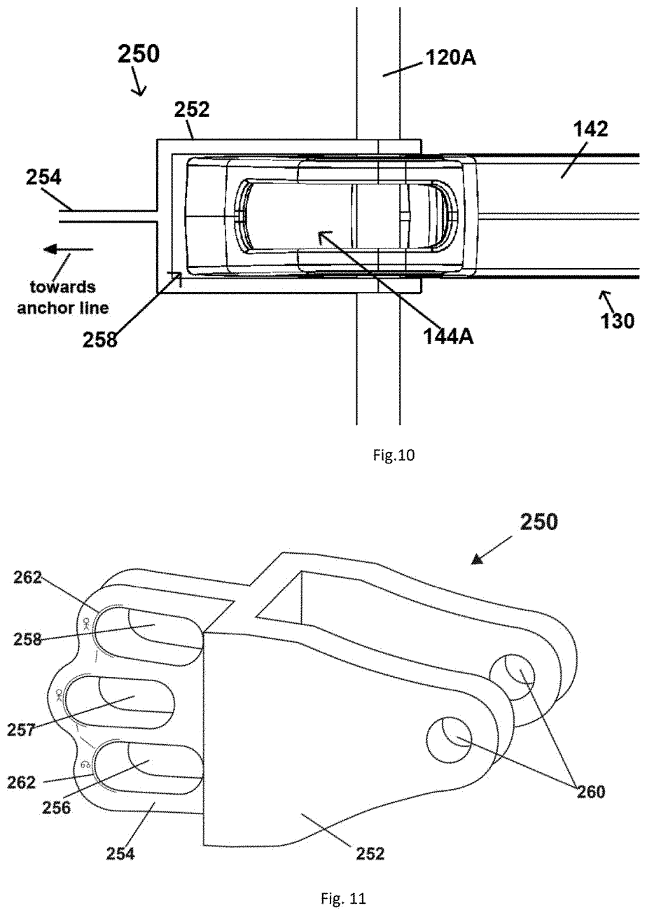

Referring to FIGS. 10-11, according to another alternative, a pivotal connector 250 may be used with roof anchor 100 in place of connector 150. Pivotal connector 250 preferably comprises a substantially U-shaped body 252 and a forwardly extending arm 254. Substantially U-shaped body 252 comprises a forward lateral arm and two rearwardly extending longitudinal arms defining an opening 258 configured to receive a forward end of roof anchor body 130. The longitudinal rear arms of body 252 extend around side surfaces 140 of body 130. An aperture 260 is disposed near a rear end of each longitudinal arm of body 252, which is configured to receive axle 120A and allow pivotal connector 250 to freely rotate around axle 120A, limited only contact of the forward lateral arm of body 252 with body 130. Another aperture 256 is disposed near a forward end of extension arm 254 and is configured to allow connection of pivotal connector 250 to an anchor line 164, 168 in the same manner as pivotal connector 150. Additional apertures 257, 258 may also be disposed near a forward end of extension arm 254 to allow pivotal connection to a lifeline or an a second anchor line A wear indicator marking 262 is preferably disposed forwardly of aperture 256 in the same manner as previously described for marking 162. With this configuration, an opening 144A in upper surface 142 of body 130 is not necessary but is shown for reference. Other configurations for a pivotal connector may also be used as will be understood by those of ordinary skill in the art.

Pivotal connector 150, 250 is preferably made from steel, high grade aluminum or other strong material.

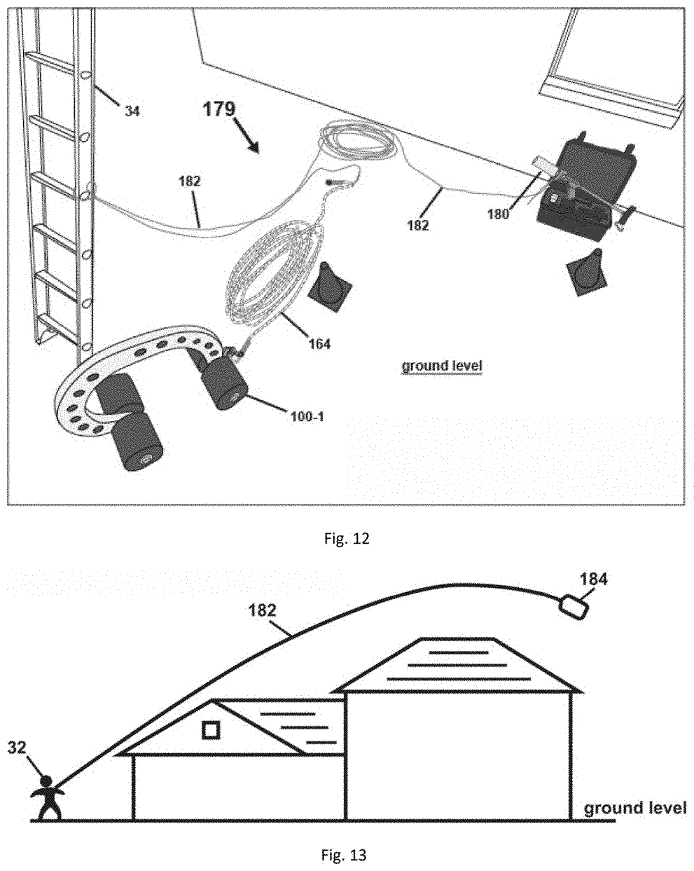

Referring to FIG. 12, according to another preferred embodiment, safety system 200 further comprises a line thrower system 179. Line thrower system 179 preferably comprises a line thrower 180, a throw line 182, and a projectile comprising a throw bag or weight 184 that is launchable from the line thrower 180 and connectable to the throw line 182. Throw line 182 is preferably a lightweight line, it does not need to resist fall forces like anchor lines 164, 168 or adjustable lifeline 172. Such line thrower systems are well-known.

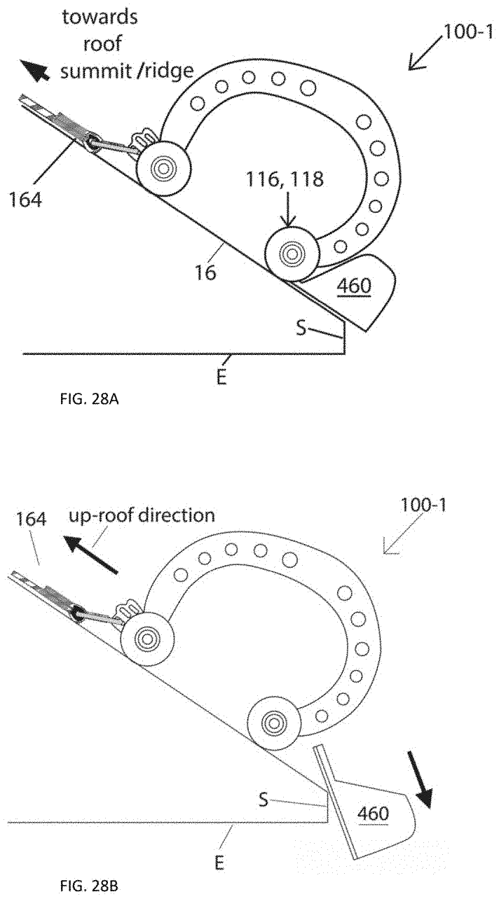

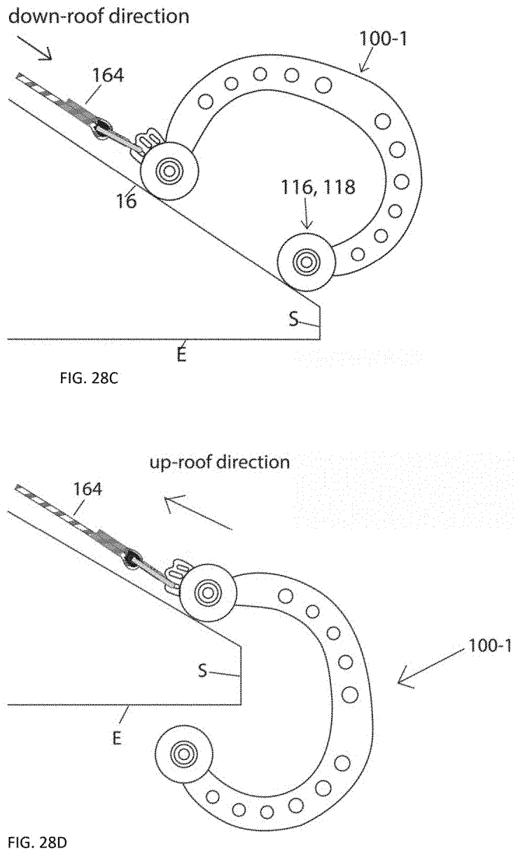

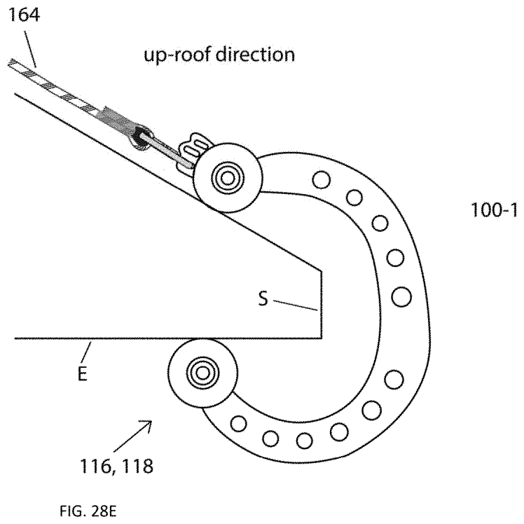

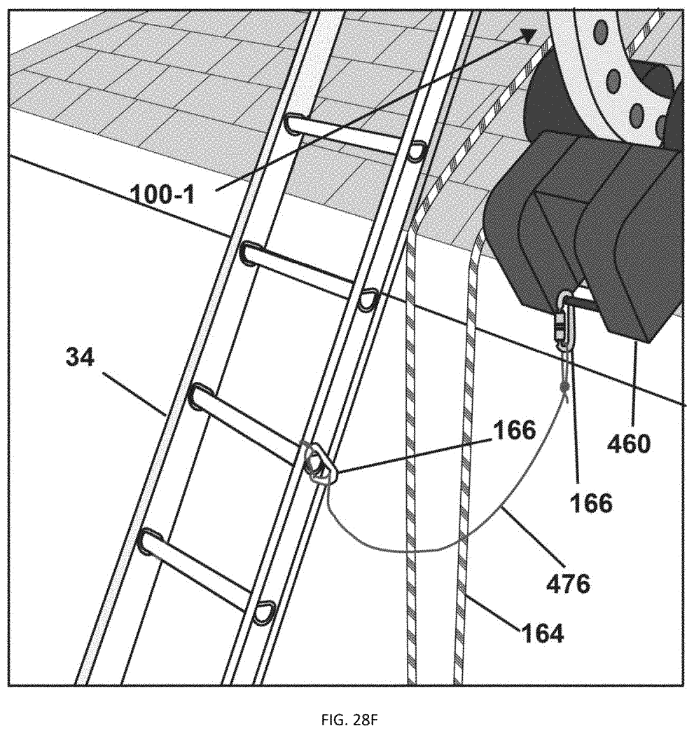

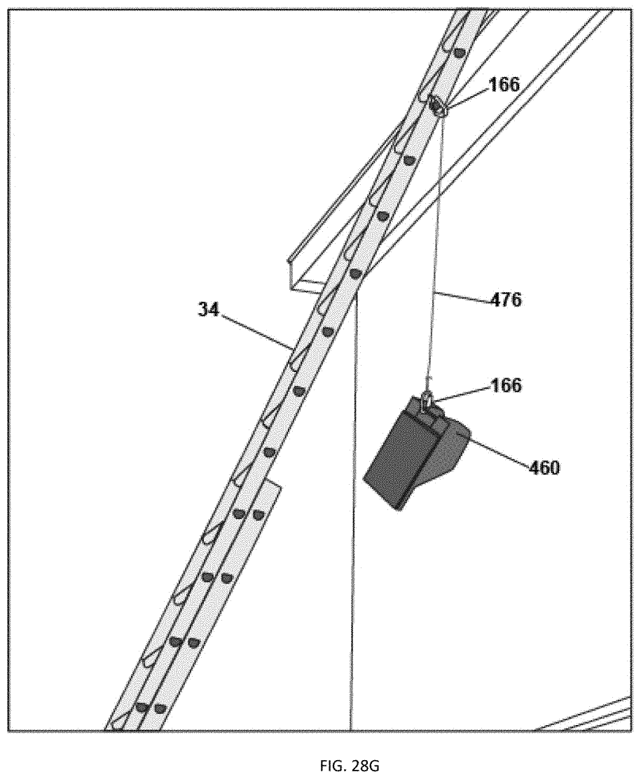

Referring to FIGS. 27A-28GB, according to another preferred embodiment, safety system 200 further comprises a stopper 460 to aid in installation of a first roof anchor 100-1 when only a single user is available for installation. Stopper 460 may also be used, if desired, with a two-user installation method, but it is not necessary. Stopper 460 preferably comprises a substantially trapezoidal or wedge-shaped body 462 and a substantially planar arm 470 extending forwardly from a bottom edge of body 462. Body 462 preferably comprises a sloped forward surface 466 and a notch 464 disposed on a rearward surface. Optionally, but preferably, disposed in an inner surface of notch 464 are oppositely disposed recesses 476, each configured to receive an end of an optional rod 478. Optional rod 478 may be used to connect a catch line 476 to stopper 460, either directly to rod by tying or through use of a connector 166. Optional rod 478 also serves to add weight to the notched end of the stopper, to help remove the stopper 460 from the roof when it is no longer needed (discussed below and shown in FIGS. 28A-B, for example). A fixedly attached line that is attached to the stopper rod may be attached to a ladder rung, next to the stopper such that when the stopper falls, it will swing and hang from the ladder instead of falling to the ground. Arm 470 preferably comprises a forward end 472 and an upper surface 474 extending from forward end 472 to sloped surface 466 of wedge body 462.

Stopper 460 is configured to hold a roof anchor 100 (particularly a first anchor 100-1) in a first temporary position on the roof until a user is able to install the anchor 100 into its second installed position as further described below. Stopper 460 is placed against a rear side of anchor 100, preferably with rear wheels 116, 118 disposed on top surface 474 and a portion of rear wheels 116, 118 and/or a portion of arcuate body 130 in contact with sloped surface 466. Stopper 460 blocks anchor 100 so that anchor 100 is held in a temporary position and does not roll (or slide if wheels are not used) off of the roof edge (e.g., edge S) until the user takes action to dislodge stopper 460 as further described below. Stopper should be positioned such that the notch 464, with the weighted rod 478, is extended beyond the roof edge.

In a preferred embodiment, a bottom surface of stopper 460 is preferably made from slip-resistant materials, such as foam rubber, to increase frictional contact of stopper 460 with a roof surface (e.g. sloped surface 16) to hold the anchor 100 in its temporary position with the weighted and notched end of the stopper hanging over the edge of the roof such that stopper 460 or anchor 100 will not fall off the edge of the roof (e.g. edge S) until a user pulls the anchoring device up the roof and off of the stopper, using the anchor line from the second side of the roof, allowing the stopper to fall from the roof edge. With the catch line 476 fixedly attached to the stopper rod on one end and temporarily affixed to a ladder rung on the other end, the stopper will fall from the roof and hang from the ladder. Adhesive may be used briefly to aid in holding stopper 460 in place on a roof's surface while the anchoring connector is being placed on the stopper. Adhesive will be removed immediately after anchoring device is placed on the stopper. Most preferably, adhesive tape is used to aid in holding stopper 460 in place on a roof's surface.

Preferred Methods of Installation

Preferred embodiments of a roof safety system, such as system 200, are installable on a roof by either two users or by a single user according to preferred embodiments of installation methods as further described herein.

According to one preferred embodiment, a method for installation of a roof anchor 100 on a roof of a building may include a first user attaching an anchor line or tether line 164 to the front of a first roof anchor and running the anchor line across the roof from a first side to a second side, possibly with the assistance of a line thrower and throw line, then lifting the first roof anchor, possibly with a ladder and preferably a second user on the opposite side supporting the first roof anchor by keeping the anchor line taut that is coming from the first anchoring device, and maintaining progression of the anchor while it is being lifted on the first side. First roof anchor is positioned near or at a first edge of the roof such that a first set of wheels with a corresponding first axle are located under and in a first tensioned contact with an eave disposed under an edge of the roof on the first side of the roof while a second set of wheels with a corresponding second axle are in contact with and on the sloped surface of the roof. A first connector pivotally attached to the second axle and attached to the anchor line is under tension due to a first force pulling away from the second axle up the roof, possibly from a second user on the second side of the roof that is pulling the anchor line. The first roof anchor preferably includes a first arched body having first and second ends, the first axle with the first set of wheels juxtaposed with the first arched body at a first end, the second axle with the second set of wheels juxtaposed with the first arched body at a second end and is most preferably a roof anchor 100 according to a preferred embodiment of the invention. The method additionally includes disposing a second roof anchor near a second edge of the roof, generally on the opposite side of the roof from the first edge, such that a third set of wheels with a corresponding third axle are located under and in a second tensioned contact with an eave disposed under a second edge of the roof while a fourth set of wheels with a corresponding fourth axle are in contact with and on the sloped surface of the roof and a second connector pivotally attached to the fourth axle and the anchor line is under tension due to a second force pulling the second connector away from the fourth axle, up the roof. This second force is from the anchor line being tensioned by the use of a progress capture pulley or similar device. This second roof anchor may be installed by suspending the second roof anchor below the second roof edge, slightly above the ground, from the tensioned anchor line that is coming from the first anchor device using a progress capture pulley or similar device and then lifting the second roof anchor with a free end of the anchor line and progress capture pulley or similar device, maintaining tension on the anchor line to the first anchor device on the other side, and then disposing the second roof anchor on the second roof edge and tensioning the anchor line. The second roof anchor includes a second arched body having third and fourth ends, the third axle with the third set of wheels juxtaposed with the second arched body at the third end, the fourth axle with the fourth set of wheels juxtaposed with the second arched body at the fourth end. The first and second pivotal connectors are interconnected under constant tension with a common anchor line to maintain the first and second tensioned contacts while preventing the first and third sets of wheels from losing contact with respective eaves under the first and second edges of the roof. During installation of the second roof anchor on the second side, the installer may attach to the common anchor line with a connecting element to protect the installer from falling and to assist in maintaining tension on the common single anchor line to the first roof anchor. These methods are described in more detail below.

One preferred method for installing a roof safety system 200 with either a single user or two users comprises the following steps: (1) preparation of throw line 182 and first roof anchor 100-1; (2) launching throw line 182 from a first side of a structure across a roof on the structure to a second side of the structure substantially opposite the first side; (3) positioning first roof anchor 100-1 on a roof edge on the first side of the structure in an installed position; (4) positioning a second roof anchor 100-2 on a roof edge on the second side of the structure in an installed position and in a location substantially opposite first roof anchor 100-1; and (5) securing anchor line 164, which is optional in certain preferred embodiments. With the exception of step (3) as further described below, these steps are essentially the same whether two users or a single user are performing the installation. All of these steps are preferably performed with the user(s) on a ground level surrounding the structure or from a position on a ladder (which may be leaning against the structure). Most preferably, a user does not climb onto or need to be on the roof to perform these steps, so that the user is protected from falls during installation. These steps are described in more detail below.

Referring to FIG. 12, a preferred method of preparing throw line 182 and first anchor 100-1 in step (1) comprises the following: A user 32 lays out throw line 182 to ensure there are no tangles. User 32 connects a first end of throw line 182 to projectile 184 (if not permanently attached) and a second end of throw line 182 to a second end of primary anchor line 164. Preferably, the user will measure out enough of the throwline, from the projectile, to cross the roof but not more than needed so the throwline doesn't land where it should not go, such as in a neighbor's tree or pool. At the measured distance on the throwline, installer will attach the line to an anchor, such as the side of a ladder. Second end of throw line 182 is preferably tied to primary anchor line with a knot. Although a carabiner or similar connector 166 could also be used, it is preferred not to use such since it may damage the roof as the throw line 182 and anchor line 164 are being pulled across the roof. User 32 connects a first end of primary anchor line 164 to roof anchor 100-1, preferably using a pivotal connector 150, 250 (this may also be done after the throw line 182 is launched).

Referring to FIGS. 12-17, a preferred method of launching throw line 182 in step (2) comprises the following: A user loads projectile 184 into line thrower 180. From a first side of a structure having a roof which needs to be accessed by a user to complete a task, projectile 184, with throwline 182 attached, is launched from line thrower 180 by a user 32 over the roof to a second side of the structure substantially opposite the first side. As shown in FIGS. 13-15, user 32 may be positioned on a ground level of the structure, may be on a ladder leaning against the structure, or may be raised above the ground in another manner, such as in a lift positioned near the structure when launching projectile 184 from line thrower 180.

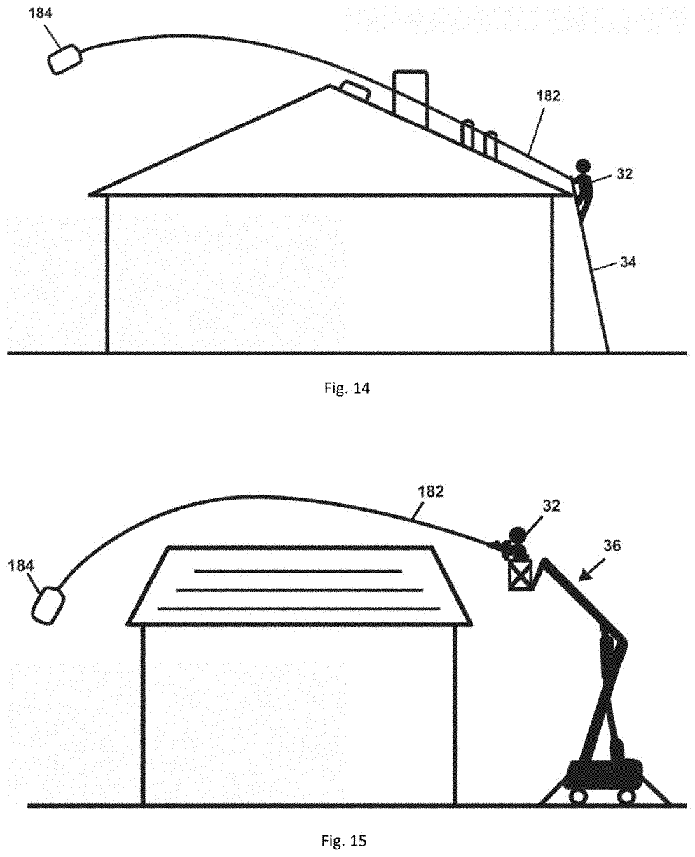

Preferably the throwline will travel directly across the roof between the desired installation locations for the first and second anchoring devices, essentially on the same path as the desired path for anchor line 164. If the throw line is not on the path chosen for the anchor line, changing the placement of the rope, from the placement of the throwline, is very difficult, without getting on the roof. Changing the placement of the throwline, once landed on the roof, is also very difficult to change, without getting on the roof. Use of a ladder to allow user 32 to be at or near roof level when launching projectile 184 from line thrower 180 as shown in FIGS. 14, 16, and 17 is frequently preferred, especially when launching from a side of a building that is more than one story high since launching from the ground often means firing the line nearly vertically such that before the line falls to the ground on the opposite side of the roof and to the rooftop it is subject to drift and does not follow its intended path. A ladder 34 is preferably leaned against the structure in contact with a side of the structure or a side edge S1 of the roof. A line guide 185 is preferably attached to a side of ladder 34 near a top of the ladder. A line guide 185 may comprise a cord, preferably a bungee cord that is run through a hollow ladder rung, second from the top, with connectors 166 (preferably micro-carabiners) attached to both ends of the cord, with the micro-carabiners projecting outwardly from a side of ladder 34 such that the throwline can be inserted into the micro-carabiner through its gate. Line thrower 180 may be connected to the user's harness 176 while the user 32 climbs ladder 34. Throw line 182 is preferably run through line guide 185 which aids in avoiding the user's arm from being snapped by throw line 182 after projectile 184 is launched. In a position near the top of ladder 34 or near roof side edge S1, the user 32 removes line thrower 180 from harness 176 and launches projectile 184 across the roof. The user 32 then descends ladder 34 to a ground level.

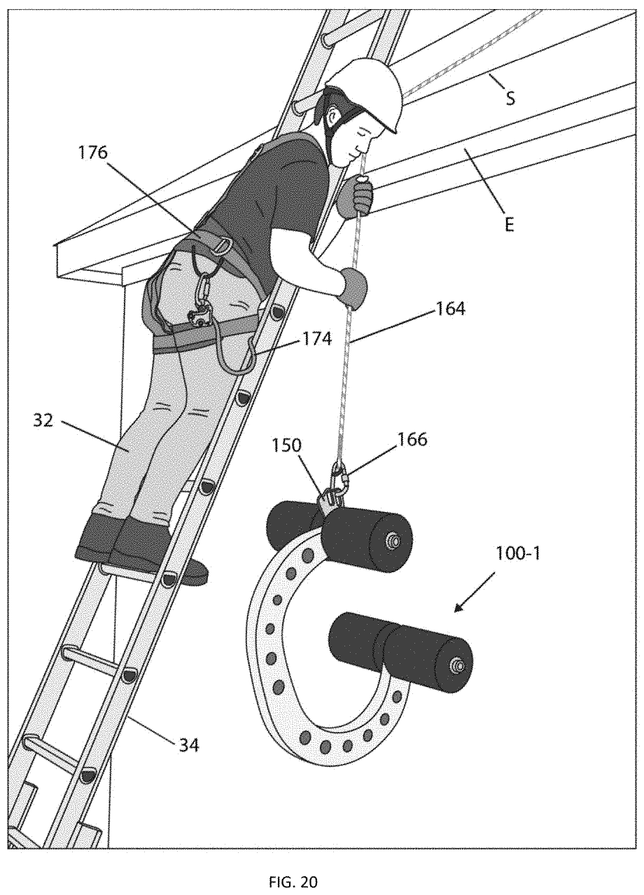

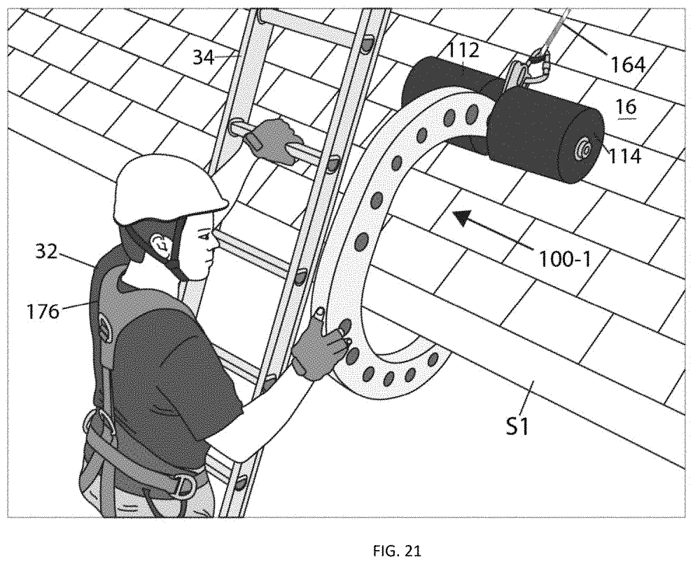

Referring to FIGS. 19-20, a preferred method of positioning a first roof anchor 100-1 in step (3) (with either a single user or two user installation) comprises the following steps: A user 32 (preferably a second user in a two user installation) located on the second side of the structure begins pulling on throw line 182, as projectile 184 and first end of throw line 182 are now on the second side of the structure, until second end of anchor line 164 is on the second side of the structure. The user 32 then pulls on anchor line 164 to remove excess slack in anchor line 164. The user 32 (preferably the first user in a two user installation) lifts the anchoring device 100-1 above his/her head, next to the building, then ascends ladder 34 again on the first side of the structure while a second user 32-2, on the opposite side, maintains the anchoring device suspended at its elevated position. The user 32 may place first roof anchor 100-1 on the user's shoulder prior to ascending ladder 34 to aid in lifting anchor 100-1 into position, but it is not necessary to do so.

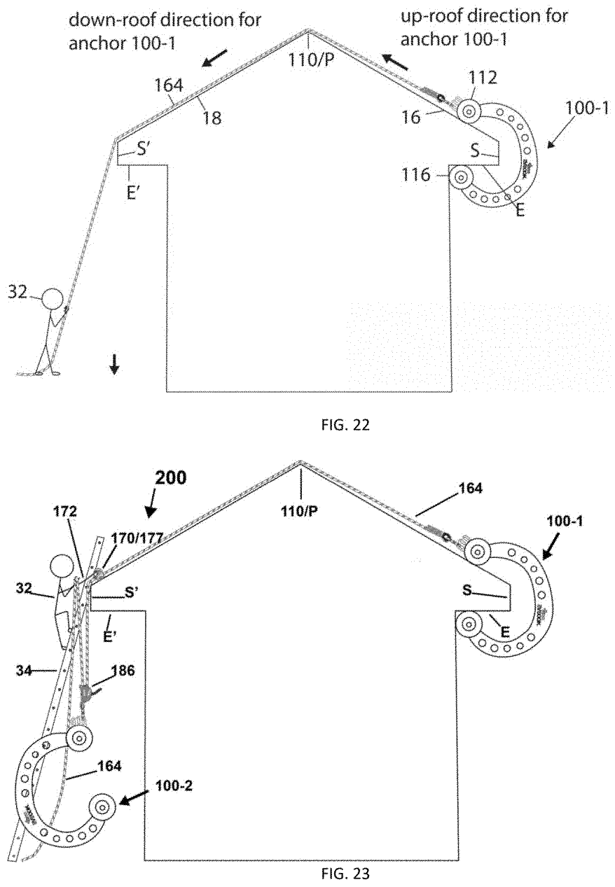

With further reference to FIGS. 20-22, for a two user installation, step (3) preferably further comprises the following steps: Second user 32-2 pulls on anchor line 164 as the first user 32-1, from the ladder, lifts the line to lift anchor 100-1 into position, as shown in FIG. 20-21. As shown in FIGS. 21-22, first roof anchor 100-1 is in proper position with forward wheels 112, 114 in contact with a sloped surface of the roof (e.g., surface 16) and rear wheels 116, 118 in contact with an eave E on the first side of the structure under roof side S or S1. The second user 32-2 continues to hold anchor line 164 taut to maintain anchor 100-1 in proper position while the first user 32-1 again descends the ladder.

With further reference to FIGS. 20 and 28A-G, for a single user installation, step (3) preferably comprises the following steps: On the first side of the structure, the user 32 connects stopper 460 to harness 176 using a connector 166 connected to rod 478. The user 32 then ascends ladder 34 with anchor 100-1, preferably carrying anchor 100-1 on the user's shoulder. The user 32 then removes stopper 460 from harness 176. The user 32 then places stopper 460 and first roof anchor 100-1 on a sloped roof surface 16 near edge S. The user 32 then aligns and positions stopper 460 with the notch 464 and rod 478 hanging over the edge of the roof (as shown in FIG. 28A) such that the stopper is behind anchor 100-1 so that front wheels 112, 114 are on roof surface 16 and rear wheels 116, 118 are on top surface 474 of stopper 460. Rear wheels 116, 118 and/or a portion of body 130 also preferably are positioned in contact with sloped surface 466 of stopper 460. Stopper 460 prevents wheels 116, 118 from moving, which maintains anchor 100-1 in a first temporary position on top of a roof surface 16. When stopper 460 is positioned on the roof, no portion of anchor 100-1 is disposed off of edge S in a down-roof direction when in the first temporary position.

The order of initial placement of stopper 460 and anchor 100-1 on surface 16 is not critical. Anchor 100-1 may be placed on roof surface 16 on its side so that it does not roll while the user places stopper 460 in position. Most preferably, one or more of the wheels 112, 114, 116, 118 are positioned in contact with ladder 34 to further aid in keeping anchor 100-1 from sliding on roof surface 16. Alternatively, user may place anchor 100-1 with its wheels 112, 114, 116, 118 in contact with surface 16 and hold it in a second temporary position with one hand while using the other hand to place stopper 460 in position near roof edge S that is aligned with, and in a down-roof direction from, anchor 100-1. The user can allow anchor 100-1 to easily roll in a down-roof direction from the second temporary position to the first temporary position in contact with stopper 460. The positioning of stopper 460 and of anchor 100-1 in the first temporary position is preferably done while the user 32 is on ladder 34. If a catch line 476 is used with stopper 460 (attached to rod 478), it is preferably attached to a ladder rung of the ladder 34 used by the installer to place the anchor 100-1 on the roof (as shown in FIG. 28F,G). Once anchor 100-1 is in the first temporary position on roof surface 16, the user can then descend from the ladder and move to the second side of the structure.

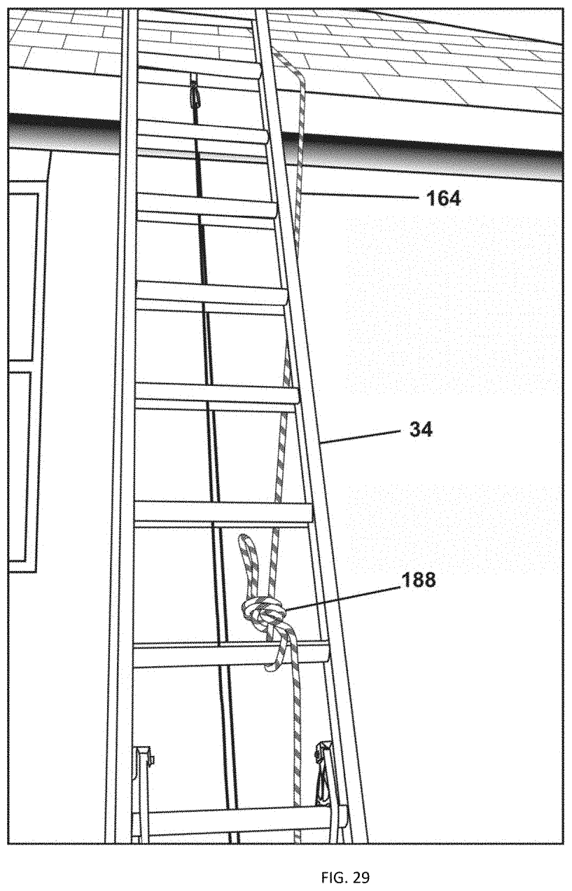

In one preferred embodiment, from the second side of the structure, the user pulls downward (toward the ground) on anchor line 164 a distance of around two feet, which causes anchor 100-1 to roll or move in an up-roof direction on roof surface 16 off of stopper 460. Most preferably, stopper 460 then freely falls to the ground. Preferably a catch line 476 will be connected to rod 478 and to a ladder 34 remaining on the first side of the structure to catch stopper 460 in a suspended position so that it does not hit the ground or any surrounding objects (such as landscaping or air conditioning equipment). The user, on the second side, then slowly releases some of anchor line 164 (allowing it to move up, away from the ground about 3 to 4 feet) which allows first roof anchor 100-1 to roll or move in a down-roof direction, unimpeded by stopper 460, until rear wheels 116, 118 falls off of roof edge S. With front wheels 112, 114 still on roof surface 16, the rear end of arcuate body 130 will swing toward the structure to bring rear wheels closer to eave E. The user will then again pull downward (toward the ground) on anchor line 164 to pull anchor 100-1 into a properly installed position with rear wheels 116, 118 in contact with an eave E on the first side of the structure under roof side edge S (or S1 in some figures). On the second side of the structure, the user may tie or connect anchor line 164 to ladder 34 (as shown in FIG. 29), or another weight or object on the second side of the structure to keep tension on line 164 while the user 32 goes back to the first side of the structure to check the position of the first roof anchor 100-1. If the first anchor 100-1 is in a properly installed position, user 32 may proceed with step (4). If the user released too much of anchor line 164 so that the front wheels 112, 114 inadvertently come off roof surface 16, or the first roof anchor 100-1 otherwise is not in a properly installed position, the user will need to repeat the steps until the first roof anchor 100-1 is in a properly installed position before proceeding with step (4).

Various stages of positioning stopper 460 and roof anchor 100-1 according to embodiments in which a stopper 460 is used are shown in FIGS. 28A-28E. The stopper 460 is used (substantially, as a wedge element) to optionally and temporarily stop the roof anchor 100-1 in a desired location before the lower wheels 116, 118 of the roof anchor 100 reach the roof's edge S. To complete installation of roof anchor 100-1, the stopper 460 has to be released. FIG. 28B illustrates the moment of “release” of the anchor 100 by, for example, pulling the anchor line 164 towards the summit of the roof to separate the wheels 116, 118 from contact with the stopper (and—when the stopper 460 is substantially at the edge S of the roof—let the stopper 460 fall from the roof). Following the release of the stopper 460 from the anchor 100 (FIG. 28C), the anchor 100 can be further lowered along the surface 16 towards the edge S/eave/other structure of the roof until the rear wheels 116, 118 assume the position below the edge or eave E (FIG. 28D), to position the anchoring member 100 firmly pressed to the eave/edge and under the eave/edge, as discussed in more detail below. While the anchor line 164 is shown in FIGS. 28A, 28B to be attached to an upper through-hole of the pivotal connector 150, it may be preferred to be attached to a lower through-hole, as is schematically shown in FIG. 28C so that an upper through-hole is more easily available to be used as an anchor for an additional anchor line or a lifeline.

According to another preferred embodiment, if a suitable anchor point is located on the first side of the structure, such as a tree, safety system 200 may be installed and used without positioning a first primary roof anchor 100-1. An end of primary anchor line 164 may be connected to the anchor point rather than roof anchor 100-1. The previously described steps for launching a throw line to position the other end of anchor line 164 on the second side of the structure may still be followed, as well as the steps discussed below of installing the second roof anchor 100-2 and additional roof anchors 100-3, etc. and secondary anchor lines 168 as needed.

Referring to FIGS. 23-25, preferred methods for positioning a second roof anchor 100-2 in step (4) are shown. Although a progress capture/tensioning device 186 is shown in these figures, the second roof anchor 100-2 may be positioned and installed without the use of progress capture/tensioning device. One preferred method for step (4) without using a progress capture/tensioning device 186 comprises the following steps: From the second side of the structure, user 32 (which could be a first/single user or a second user) connects anchor line 164 to a second roof anchor 100-2 disposed on a second side of the structure, preferably by running a free end 164′ of primary anchor line 164 through a connector 166 connected to pivotal connector 150, 250 or directly through an aperture in pivotal connector 150, 250, so that anchor 100-2 can move along anchor line 164 to increase the length of free end 164′ until anchor 100-2 is in its installed position. Free end portion 164′ is the portion of primary anchor line 164 that is disposed on a side of anchor 100-2 (or its connected connector 166 or pivotal connector 150, 250) away from roof anchor 100-1 or on a side of anchor 100-2 that is a down-roof direction. Tension on anchor line 164 is maintained while connecting it to anchor 100-2 to prevent anchor 100-1 from dislodging from its installed position. Ladder 34 is also preferably positioned on second side of the structure against the structure or against roof side edge S′ or S1′. A user 32 holds free end portion 164′ to keep anchor line 164 taut and maintain first roof anchor 100-1 in position while the user 32 ascends ladder 34 on the second side of the structure. As the user 32 ascends ladder 34, he/she pulls on free end portion 164′ to take up slack in line 164 and keep it taut as second roof anchor 100-2 is lifted into position. User 32 must maintain a grip on anchor line 164′ when no progress capture/tensioning device 186 is used to keep anchor line 164 from sliding back and loosening, which could cause anchor 100-1 to dislodge from its installed position. This process continues until the user 32 reaches the roof edge and then the user lifts second roof anchor 100-2 until it is at the roof level. A user 32 may guide anchor 100-2 into a proper installed position with forward wheels 112, 114 in contact with a sloped surface of the roof (e.g., surface 18) and rear wheels 116, 118 in contact with an eave E′ on the second side of the structure and under roof edge S′.

Referring to FIGS. 23-25, according to an alternate embodiment of step (4) when a progress capture/tensioning device 186 is used, a user connects progress capture/tensioning device 186 to second roof anchor 100-2 disposed on the ground level on the second side of the structure, preferably connected to pivotal connector 150, 250 using a connector 166 inserted through an aperture (e.g. aperture 152) on connector 150, 250 and an aperture on progress capture/tensioning device 186. If anchor line 164 is attached to an anchoring structure (other than a roof anchor), such as the ladder 34 in FIG. 29 (as if second roof anchor 100-2 is being installed after attachment of first roof anchor 100-1 with a one user installation), the user will detach anchor line 164 from the anchoring structure, while maintaining tension on anchor line 164. A portion of primary anchor line 164 is preferably fed through or inserted into progress capture/tensioning device 186 such that the progress capture pulley can move freely up the anchor line 164 towards the roof edge but can only move in the opposite direction if actuated by the user to allow it. User 32 will cause the second anchor 100-2 to move up the rope until the roof anchor 100-2 is hanging above the ground by a few inches and is now keeping the anchor line 164 tensioned to the first roof anchor 100-1. Ladder 34 is also positioned on second side of the structure and against the structure or against roof side edge S′ or S1′. A user 32 may hold free end portion 164′ loosely in his/her hand and climb the ladder to the roof edge, allowing the rope to slide through his/her hand. When progress capture/tensioning device 186 is used, free end portion 164′ is the portion of primary anchor line 164 that is disposed on a side of progress capture/tensioning device 186 away from roof anchor 100-1 or the portion of primary anchor line 164 that would freely hang down relative to a roof edge S′ where the second roof anchor 100-2 is installed, after it has been installed. After the user 32 ascends, he/she pulls on free end portion 164′ which causes progress capture/tensioning device 186 to reduce length of line 164 between first roof anchor 100-1 and second roof anchor 100-2 and keep it taut as second roof anchor 100-2 is lifted into position. The use of a progress capture/tensioning device 186 is instrumental in keeping anchor line 164 from sliding back toward the first side of the structure (in the second direction), which could result in first roof anchor 100-1 dislodging from its installed position. When no progress capture/tensioning device 186 is used, the user 32 must maintain a grip on anchor line 164′ to keep anchor line 164 from sliding back toward the first side of the structure. With a preferred progress capture/tensioning device 186, the user does not need to always maintain a grip on anchor line 164′ during this process as progress capture/tensioning device 186 will maintain a relative position on the anchor line 164. This frees the user's hands to make adjustments on the ladder as needed. This process continues until second roof anchor 100-2 is at the roof level. A user 32 may guide anchor 100-2 into a proper installed position with forward wheels 112, 114 in contact with a sloped surface of the roof (e.g., surface 18) and rear wheels 116, 118 in contact with an eave E′ on the second side of the structure and under roof edge S′. Using progress capture/tensioning device 186, the user may use both hands to position anchor 100-2 into its installed position. Once second roof anchor 100-2 is in a proper installed position, user 32 then pulls on free end portion 164′ of anchor line 164 in a first direction (such that 164′ is pulled in an up-roof direction, to pull anchor line 164 from roof anchor 100-1 toward second roof anchor 100-2) to place anchor line 164 under additional tension, increasing the tension on the anchor line such that more users can use the system and/or so the system can protect a user or users on a greater area of the roof. After the installed anchor device 100-2 has been installed and the anchor line has been tensioned by the installer from the ladder, a user may connect to primary anchor line 164 (as further described below) to access the roof after step (4), which makes step (5) optional, although it is preferred. The installed positions of anchors 100 are such that (1) front wheels 112, 114 are in contact with a sloped roof surface and (2) rear wheels 116, 118 are in tensioned contact with and engagement with a surface of the eave, and preferably in contact with a side surface of the structure disposed under the eave, so that tensioning forces 190 are in an up-roof direction relative to the anchor 100, as shown in FIG. 25. The user is protected at this point because the installed positions of anchor 100-1 and 100-2 with anchor line 164 disposed between them, and progress capture/tensioning device 186 holding anchor line 164 in taut position, will restrain any fall.

According to another preferred embodiment of step (4), with or without use of progress capture/tensioning device 186, a user 32 preferably connects to anchor line 164 using a lanyard 174 and line sliding anchor 178 to provide fall protection while climbing ladder 34 and performing the sub-steps of steps (4) and/or (5), as shown in FIGS. 24A, B, C, and D. Connecting user to anchor line 174 is particularly preferred when a tensioning device is not used as it prevents anchor line 164 from slipping in the up-roof direction during steps (4) and/or (5), which would loosen anchor line 164 and could cause anchor 100-1 to become unintentionally dislodged from its installed position. Optionally, but preferably, while user 32 is still on ground level on the second side of the structure, user 32 connects a line sliding anchor 178 to anchor line 164. Line sliding anchor 178 is oriented on anchor line 164 with its first direction in an up-roof direction relative to anchor 100-2. The user also connects a first end of the user's lanyard 174 to harness 176 (if not already connected) and a second end of the lanyard 174 to line sliding anchor 178. Because anchor 100-1 is installed, if the user were to fall while climbing ladder 34 or during other steps of installing anchor 100-2, the user would be protected as anchor 100-1 and anchor line 164 would arrest the user's fall. As the user 32 ascends ladder 34, the user slides line sliding anchor 178 in the first direction (up-roof).

A preferred method for securing anchor line 164 (when no progress capture/tensioning device 186 is used) in step (5) comprises the following steps: Once second roof anchor 100-2 is in proper installed position, user 32 then pulls on free end portion 164′ of anchor line 164 in the first direction (to pull anchor line 164 from anchor 100-1 toward anchor 100-2) to place anchor line 164 under additional tension, increasing the tension on the anchor line such that more users can use the system and/or so the system can protect a user or users on a greater area of the roof. Generally, a strong pull on free end 164′ from an average adult user, pressing rear wheels of the anchor hooks firmly against the eaves, is sufficient to place anchor line 164 under adequate tension. The user 32 then preferably ties free end portion 164′ around anchor line 164 with a knot to secure anchor line 164. This completes installation of primary roof anchors 100-1, 100-2 and a user may connect to primary anchor line 164 to access the roof. Most preferably, the user 32 does not climb onto or need to be on the roof surface (e.g., surface 18) to perform these steps to install first and second roof anchors 100-1, 100-2, so that the user is protected from falls during installation.

Referring to FIGS. 24C-E and 25, another preferred method for securing anchor line 164 when a tensioning device 186 was used in step (4) and is used in step (5) comprises the following steps: Once second roof anchor 100-2 is in proper installed position and has been tensioned (as shown in step (4)), a user 32 may desire to climb onto the roof, protected by the installed system and further tension the primary anchor line, pulling free end portion 164′ of anchor line 164 in a first direction (to pull anchor line 164 from anchor 100-1 toward anchor 100-2, as shown in FIG. 25). Installer may find this advantageous when installing on a lower sloped roof (such as a 4:12 or 6:12 slope) because, on the ladder, he/she will need to pull the line in a more horizontal direction away from his/her body which may be more challenging for additional tensioning. On a normal to higher sloped roof, climbing on the roof may not be advantageous for adding further tension, because on a normal to steeper sloped roof, the user 32 while positioned on the ladder, will be pulling the rope in a more vertical direction, which is more easily performed on the ladder (FIG. 24C). Tensioning the progress capture/tensioning device 186, operated when a user is on the roof, may be in an up-roof direction (FIG. 25). To further tension the anchor line, the user may also choose to tension with a mechanical advantage. Tensioning with a mechanical advantage, from the ladder (as shown in FIG. 24D) or from the roof, the first direction for pulling on the free end 164′ to tighten primary anchor line 164 may be in a substantially down-roof direction. The first user then preferably ties free end portion 164′ around anchor line 164 with a knot 188 (as shown on FIG. 24E) to further secure anchor line 164. Although progress capture/tensioning device 186 is configured to maintain the tension on anchor line 164 and not allow anchor line 164 to slide in a second direction substantially opposite the first direction, which would loosen anchor line 164, unless a user 32 actuates progress capture/tensioning device 186 to allow movement in the second direction to uninstall or remove safety system 200 from the roof, the use of a knot 188 on anchor line 164 further aids in preventing it from slipping in the second direction in the event of any failure of progress capture/tensioning device 186. The knot in anchor line 164 is disposed between progress capture/tensioning device 186 and anchor 100-1 or on an up-roof side of progress capture/tensioning device 186, preferably in close proximity to progress capture/tensioning device 186. Progress capture/tensioning device 186 preferably remains connected to primary anchor line 164 until removal of anchors 100-1 and 100-2. This completes installation of primary roof anchors 100-1, 100-2. Most preferably, the user 32 does not climb onto or need to be on the roof surface (e.g., surface 18) to perform these steps to install first and second roof anchors 100-1, 100-2, so that the user is protected from falls during installation. When a tensioning device 186 is used, step (5) is optional, but may be preferred, as increasing the tension on the anchor line 164 allows more users to use the safety system to access the roof and/or so the safety system can protect a user or users on a greater area of the roof.

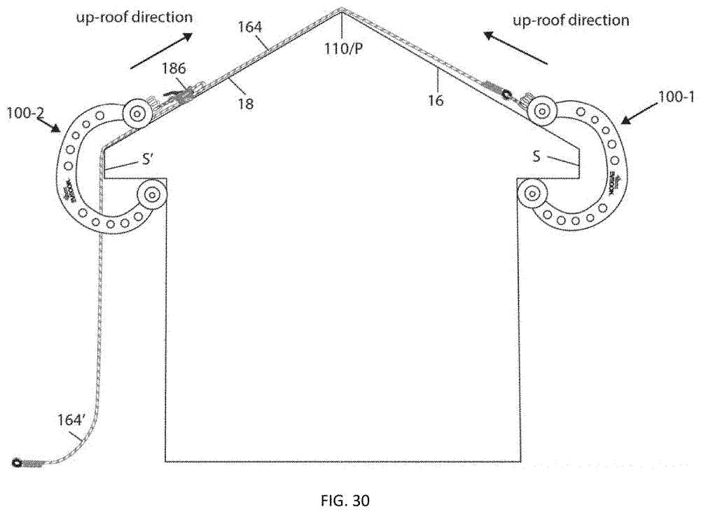

Properly installed first and second roof anchors 100-1, 100-2 are shown in FIG. 30. As can be seen, rear wheels on each anchor 100-1, 100-2 are in contact with an eave surface (and a side surface of the structure) and front wheels on each anchor 100-1, 100-2 are in contact with a sloped surface of the roof, 16, 18. Anchor line 164 is under sufficient tension to maintain the anchors 100-1, 100-2 in these installed positions while a user is using the safety system and connected to anchor line 164. By using a single, continuous anchor line 164 and pivotal connectors 150, 250 to connect anchor line 164 to each anchor 100-1, 100-2 according to a preferred embodiment, dislodgement problems encountered with prior art systems can be avoided.

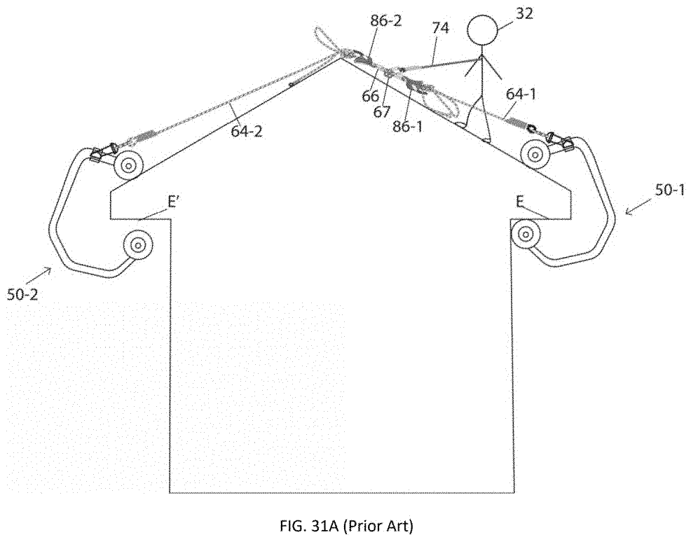

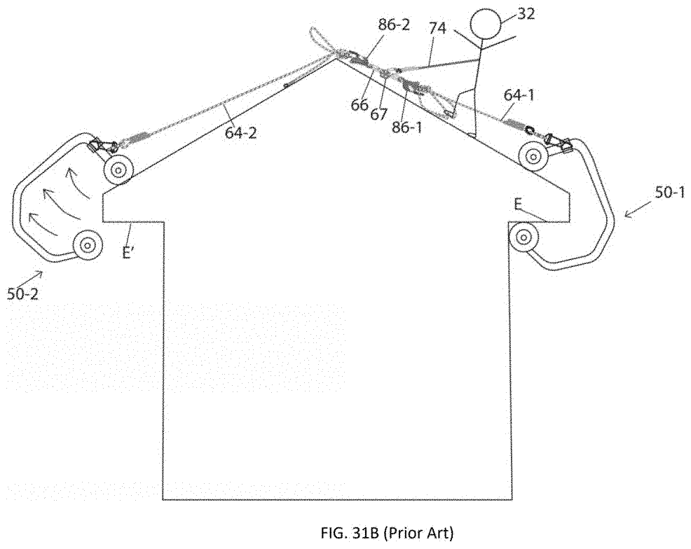

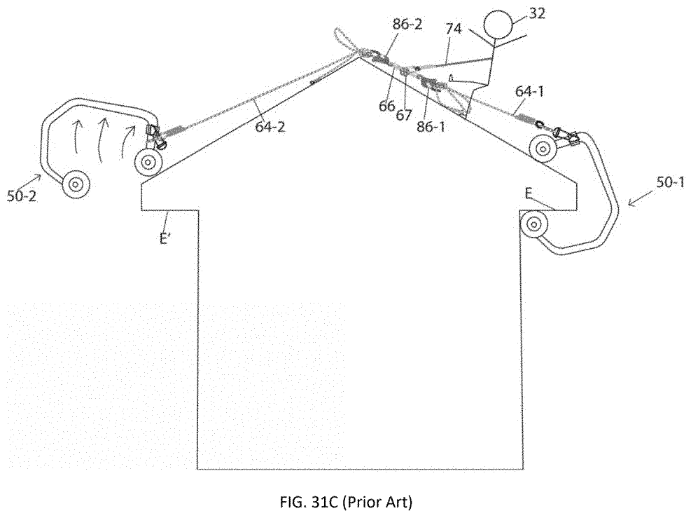

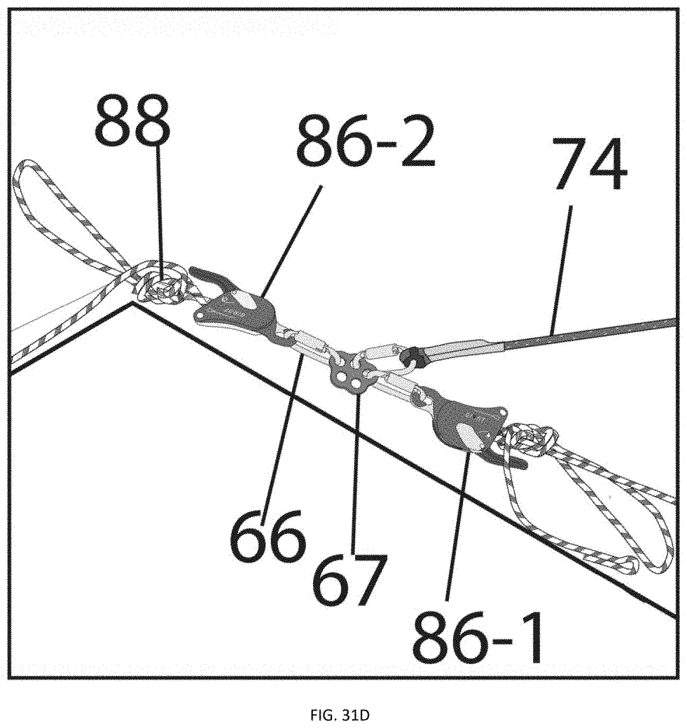

For example, one such prior art system is shown in FIGS. 31A-31D. The system shown in these figures is similar to U.S. Pat. No. 8,292,030 (owned by Applicant), an embodiment of which is shown being installed in a video produced by Applicant and publicly available at https://www.youtube.com/watch?v=OiNqzEXR7w8. This system uses two separate tethers 64-1 and 64-2 to span the roof between hook members 50-1, 50-2, rather than a single continuous anchor line 164 spanning between roof anchors 100-1, 100-2. The two tethers are connected near the ridge using (1) a multi-hole connector 67 and carabiners 66 fixedly connected to two progress capture pulleys, 86-1 and 86-2, progress capture pulley 86-2 attached to tether line 64-2 and progress capture pulley 86-1 attached to tether line 64-1; or (2) it could be a ring attached to two progress capture pulleys 86-1 and 86-2, progress capture pulley 86-2 attached to tether line 64-2 and progress capture pulley 86-1 attached to tether line 64-1; or (3) it could be a ring tied to one of the tethers 64-1 and the other tether 64-2 could be inserted into the ring and the end of the second tether 64-2 could also be pulled to tension the line and then tied/knotted to the ring, etc. User 32 is fixedly attached to the tether lines at the connection of the tether lines 64-1,64-2 using a lifeline 74. Additionally, each tether 64-1, 64-2 was connected directly to an arched body of its respective hook member 50-1, 50-2, as shown in the images of the '030 patent. Several times, testing of a design like that in the '030 patent and depicted in FIGS. 31A-31C, with anchor lines 64-1, 64-2 slightly loosened, simulating a result of long use of the anchor lines, without proper tensioning maintenance, resulted in the rear wheels of one of the hook members (e.g. 50-2 in FIG. 31A) detaching from the roof (disconnecting from the eave E′) when a user, standing on the roof, pulled on the tether line in an up-roof direction at an angle similar to a 14:12 roof slope as shown in a video produced by Applicant and publicly available at https://wwwyoutu.be/LHc2Cj5Sfgl. This pulling force was designed to simulate the forces applied to tether 64-2 if a user attached to tether 64-1 on the opposite side of the roof were to fall. Once hook member 50-2 is unintentionally dislodged from eave E′, the force applied to tether 64-2 will cause hook member 50-2 to rotate upward and unhook from the eave, releasing tension on tethers 64-2, 64-1 so that the user is no longer protected, and the system will not restrain the user's fall. Understandably, eliminating the risk of roof anchor 100 dislodging from the roof/disconnecting from the eave is important for the practical use of safety system 200, as such dislodging significantly increases the risk of a fall. Using a pivotal connector 150 connected to axle 120A and to a single, continuous anchor line 164, 168 according to a preferred embodiment substantially reduces the risks of roof anchor 100 dislodging from the roof. Additionally, users of the '030 system are required to work on a sloped roof, carrying large anchors 50-1, 50-2 and other gear during installation of the system with no protection from falls.

Preferred Methods of Installation with Secondary Roof Anchors

According to another preferred method for installing a roof safety system 200 comprising one or more secondary roof anchors 100-3, 100-4, etc., the method comprises steps (1)-(5) as previously described and further comprises the following steps: (6) connecting a line sliding anchor 178 to a first end of a secondary anchor line 168 and to primary anchor line 164; (7) positioning a second end of secondary anchor line 168 off of the roof; (8) positioning a third roof anchor 100-3 on a roof edge on a third side of the structure, attached to the secondary anchor line; and (9) securing secondary anchor line 168, which is optional in certain preferred embodiments. These steps may be repeated for additional roof anchors 100-4, 100-5, etc. While on the roof performing any of steps 6-9, user 32 is preferably connected to primary anchor line 164 as further described in use of safety system 200 below to ensure the user 32 is protected from falls during installation of one or more secondary roof anchors 100-3, 100-4, etc.

A preferred method of connecting a line sliding anchor 178 in step (6) comprises the following steps: From a position on the roof, a user 32 slidably connects a line slidable anchor 178 to a desired position on primary anchor line 164 and fixedly connects a first end of a secondary anchor line 168 to line slidable anchor 178. Again, as used herein, slidably connected (or similar wording) refers to connecting slidable anchor 170 to a line so that slidable anchor 170 (or 177, 178) may freely slide along that line in a first direction when the user moves slidable anchor 170 in the first direction (preferably indirectly by movement of the user in the first direction) and blocks movement in a second direction substantially opposite the first direction unless the user actuates slidable anchor 170 to allow movement in the second direction. As used herein, fixedly connects (or similar wording) means that slidable anchor 170 is connected to an end of a line in a manner that allows the slidable anchor 170 and end of the line to move (relative to a different line) together and not separately. For example, when an end of secondary anchor line 168 is connected to an aperture in line slidable anchor 178 using a connector 166, both the end of anchor line 168 and line slidable anchor 178 will move together along anchor line 164. Fixedly connected does not mean that there is no movement of the end of the connected line (e.g., secondary anchor line 168) and line slidable connector 178, as the end of the line may move slightly relative to connector 178 based on movement of connector 166 when used. The desired position of line slidable anchor 178 on primary anchor line 164 will depend on where the desired position of third roof anchor 100-3 will be, which will vary based on roof structure and where on the roof the task(s) are to be performed.

A preferred method of positioning a second end of secondary anchor line 168 off of the roof in step (7) comprises the following steps: A user preferably tosses a second end of anchor line 168 off roof edge F or F′ (see FIG. 35A for example positioning). Depending on the distance, the user may be positioned near primary anchor line 164 while tossing or may walk closer to edge F or F′ (still connected to primary anchor line 164 by an adjustable lifeline as described below) to toss the end off the roof. Preferably, there is sufficient length on secondary anchor line 168 that the second end contacts the ground level on the third side of the structure. A line thrower system 179 may also be used to position the second end of secondary anchor line 168 off of the roof, if desired, but it is usually not necessary.

A preferred method of positioning a third roof anchor 100-3 on a roof edge in step (8) (without use of a progress capture/tensioning device 186) comprises the following steps: From the third side of the structure (e.g. F or F′) where anchor 100-3 is to be located, user 32 (which could be a first/single user after he/she descends from the roof and moves to the third side or a second user positioned on the third side of the structure) connects anchor line 168 to a third roof anchor 100-3 disposed on the third side of the structure, preferably by running a free end 168′ of secondary anchor line 168 through a connector 166 connected to pivotal connector 150, 250 or directly through an aperture in pivotal connector 150, 250, so that anchor 100-3 can move along anchor line 168 to increase the length of free end 168′ until anchor 100-3 is in its installed position. Free end portion 168′ is the portion of secondary anchor line 168 that is disposed on a side of anchor 100-3 (or its connected connector 166 or pivotal connector 150, 250) away from roof primary anchor line 164 or on a side of anchor 100-3 that is a down-roof direction. Ladder 34 is also positioned on the third side of the structure against the structure or against roof side edge (such as F′). A user 32 holds free end portion 168′ to keep anchor line 168 taut while the user 32 ascends ladder 34 on the third side of the structure. As the user 32 ascends, he/she pulls on free end portion 168′ to take up slack in line 168 and keep it taut as third roof anchor 100-3 is lifted into position. User 32 must maintain a grip on anchor line 168′ when no progress capture/tensioning device 186 is used to keep anchor 100-3 from sliding off anchor line 168. This process continues until third roof anchor 100-3 is at the roof level. A user 32 may then guide anchor 100-3 into a proper installed position with forward wheels 112, 114 in contact with a sloped surface of the roof (e.g., surface 18) and rear wheels 116, 118 in contact with an eave E′ on the third side of the structure and under roof edge (such as F′).

According to another preferred embodiment, a method of positioning a third roof anchor 100-3 on a roof edge in step (8) when a progress capture/tensioning device 186 is used comprises the following steps: From the third side of the structure (e.g. F or F′) where anchor 100-3 is to be located, user 32 (which could be a first/single user after he/she descends from the roof and moves to the third side or a second user positioned on the third side of the structure) connects a progress capture/tensioning device 186 to third roof anchor 100-3 disposed on the third side of the structure, preferably connected to pivotal connector 150, 250 using a connector 166 inserted through an aperture (e.g. aperture 152) on connector 150, 250 and an aperture on a second progress capture/tensioning device 186. A portion of secondary anchor line 168 is preferably fed through or inserted into second progress capture/tensioning device 186, creating a free end portion 168′ of secondary anchor line 168. Free end portion 168′ is the portion of secondary anchor line 168 that is disposed on a side of second progress capture/tensioning device 186 away from primary anchor line 164 or on a side of second progress capture/tensioning device 186 that is in the first direction for the progress capture/tensioning device (which is in a down-roof direction). Ladder 34 is also positioned on the third side of the structure against the structure or against roof side edge F′, for example. A user 32 holds the free end portion 168′ while the user 32 ascends ladder 34 on the third side of the structure, pulling on free end portion 168′ as he/she ascends, similar to installation of the second primary roof anchor 100-2. Pulling on free end 168′ causes progress capture/tensioning device 186 to take up slack in line 168 and keep it taut as third roof anchor 100-3 is lifted into position. The use of a progress capture/tensioning device 186 keeps third anchor 100-3 securely connected to anchor line 168 without requiring user 32 to maintain a constant grip on anchor line 168. When no progress capture/tensioning device 186 is used, the user 32 must maintain a grip on anchor line 168′ to keep anchor 100-3 from sliding off of anchor line 168. With a preferred progress capture/tensioning device 186, the user does not need to maintain a grip on anchor line 168′ during this process as progress capture/tensioning device 186 will maintain a relative position of anchor line 168 and anchor 100-3. This frees the user's hands to make adjustments on the ladder as needed. This process continues until user is at roof level and then user may continue to lift third roof anchor 100-3 until third roof anchor 100-3 is at the roof level. A user 32 may guide anchor 100-3 into a proper installed position with forward wheels 112, 114 in contact with a sloped surface of the roof (e.g., surface 12) and rear wheels 116, 118 in contact with an eave E′ on the third side of the structure and under roof edge F′ (for example). Again, by using progress capture/tensioning device 186, the user may use both hands to position anchor 100-3 into its installed position. Once third roof anchor 100-3 is in a proper installed position, user 32 then pulls on free end portion 168′ of secondary anchor line 168 in a first direction (such that 168′ may be pulled in an up-roof direction, to pull anchor line 168 from line slidable anchor 178 connected to primary anchor line 164 toward third roof anchor 100-3) to place secondary anchor line 168 under additional tension, increasing the tension on the anchor line such that more users can use the system and/or so the system can protect a user or users on a greater area of the roof. When a progress capture/tensioning device is used, a user may connect to secondary anchor line 168 (as further described below) to access the roof after step (8) and step (9) becomes optional, although it is preferred. The user is protected at this point because the installed positions of anchor 100-3 and secondary anchor line 168 (relative to primary anchor line 164 and anchors 100-1 and 100-2), with progress capture/tensioning device 186 holding anchor line 168 in taut position, will restrain any fall.

A preferred method for securing anchor line 168 (when no progress capture/tensioning device 186 is used) in step (9) comprises the following steps: Once third roof anchor 100-3 is in proper installed position, user 32 then pulls on free end portion 168′ of anchor line 168 in the first direction (such as an up-roof direction, to pull anchor line 168 from line sliding anchor 178 on primary anchor line 164 toward anchor 100-3) to place anchor line 168 under additional tension, increasing the tension on the anchor line such that more users can use the system and/or so the system can protect a user or users on a greater area of the roof. Generally, one or two pulls, pressing rear wheels of the anchor hooks firmly against the eaves on free end 168′ from an average adult user is sufficient. The first user then preferably ties free end portion 168′ around anchor line 168 with a knot to secure anchor line 168. This completes installation of secondary roof anchor 100-3 and a user may connect to secondary anchor line 168 to access the roof or move about other areas of the roof.

A preferred method of securing secondary anchor line 168 using progress capture/tensioning device 186 in step (9) comprises the following steps: Once third roof anchor 100-3 is in a proper installed position, user 32 may then pull on free end portion 168′ of anchor line 168 in a first direction (such that 168 is pulled in an up-roof direction, to pull anchor line 168 from line slidable anchor 178 connected to primary anchor line 164 toward third roof anchor 100-3) to place secondary anchor line 168 under additional tension, increasing the tension on the secondary anchor line such that more users can use the system and/or so the system can protect a user or users on a greater area of the roof. For progress capture/tensioning device 186 operated when a user is on a ladder 34 or otherwise in a down-roof direction relative to progress capture/tensioning device 186, the first direction for pulling on free end 168′ to tighten secondary anchor line 168 may be in a substantially vertical or up-roof direction (see FIG. 24C); or if using a mechanical advantage as shown in FIG. 24D may be in a down-roof direction. For progress capture/tensioning device 186 operated when a user is on the roof in a substantially up-roof direction relative to progress capture/tensioning device 186 (similar to the user position shown in FIG. 25), the first direction for pulling on free end 168′ to further tension secondary anchor line 168 may be in a substantially vertical direction or may be in a substantially up-roof direction, depending on the slope of the roof. Generally, one or two pulls on free end 168′, pressing rear wheels of the anchor hooks firmly against the eaves, from an average adult user is sufficient to add adequate tension to line 168. The user then preferably ties free end portion 168′ around anchor line 168 with a knot to further secure anchor line 168. Although progress capture/tensioning device 186 is configured to maintain the tension on anchor line 168 and not allow anchor line 168 to slide in a second direction substantially opposite the first direction, which would loosen anchor line 168, unless a user 32 actuates progress capture/tensioning device 186 to allow movement in the second direction to uninstall or remove safety system 200 from the roof, the use of a knot on anchor line 168 further aids in preventing it from slipping in the second direction in the event of any failure of progress capture/tensioning device 186. The knot in anchor line 168 is preferably disposed near progress capture/tensioning device 186 between progress capture/tensioning device 186 and primary anchor line 164 or on an up-roof side of progress capture/tensioning device 186. Progress capture/tensioning device 186 preferably remains connected to secondary anchor line 168 until removal of anchor 100-3. This completes the optional securing of secondary roof anchor 100-3 and a user may connect to secondary anchor line 168 to access the roof.

According to another preferred method for installing a roof safety system 200 comprising one or more secondary roof anchors 100-3, 100-4, etc., the method comprises steps (1)-(5) as previously described and further comprises the following steps: (6A) connecting the secondary anchor line 168 to primary anchor line 164 as shown in FIG. 26 at a desired position on primary anchor line 164; (7A) connecting an end of the secondary anchor line 168 to the secondary anchor being installed (e.g., roof anchor 100-3, 100-4, etc.); (8A) from a position on the roof, lowering the secondary roof anchor (e.g., 100-4 as shown in FIG. 26) into an installed position on the third or fourth side of the structure; and (9A) securing secondary anchor line 168, which is an option in certain preferred embodiments. These steps may be repeated for additional roof anchors 100-4, 100-5, etc. While on the roof performing any of steps 6A-9A, user 32 is preferably connected to primary anchor line 164 as further described in use of safety system 200 below to ensure the user 32 is protected from falls during installation of one or more secondary roof anchors 100-3, 100-4, etc.

A preferred method of connecting secondary anchor line 168 to primary anchor line 164 in step (6A) comprises the following steps: A user carries anchor 100-3 onto the roof's surface, while user is connected to anchor line 164 for fall protection. Once at a desired location for secondary anchor line 168, the user slidably connects a line sliding anchor 178 to primary anchor line 164 and fixedly connects line sliding anchor to progress capture/tensioning device 186. The progress capture/tensioning device is then slidably connected to secondary anchor line 168. Steps (7A) and/or (8A) may be performed prior to step (6A). Alternatively, a user may connect secondary anchor line 168 to primary anchor line 164 by feeding it through an aperture on the line sliding anchor 178 connected to primary anchor line 164 and tying it with a knot (if desired, to capture progress) without requiring use of a progress capture/tensioning device 186.

A preferred method of connecting anchor 100-3 in step (7A) comprises the following steps: A user carries anchor 100-3 onto the roof's surface, while connected to anchor line 164 for fall protection, if not already done. Once at a desired location for secondary anchor line 168, the user then connects a first end of anchor line 168 to anchor 100-3, preferably using pivotal connector 150 or 250 and a connector 166 connected to a loop 165 at the end of anchor line 168. This connection may also be made prior to bringing anchor 100-3 to the roof.

A preferred method of lowering anchor 100-3 in step (8A) comprises the following steps: The user then places anchor 100-3 on the roof's surface with all of its wheels 112, 114, 116, 118 in contact with the roof's surface and the rear wheels in a down-roof direction relative to the front wheels. The user then slowly releases anchor line 168 (allowing it to move in a down-roof direction) to allow anchor 100-3 to roll down the roof's surface until the rear wheels fall off of the roof's edge. The user then pulls free end 168′ in the first direction, pulling anchor line 168 up, to fully engage rear wheels 116, 118 with the soffit or eave. In other words, the roof anchor 100-3 is further tensioned (strained) against and in contact with the roof edge/eave as a result of pulling the roof anchor 100-3 towards the roof summit or ridge so as to draw the anchor 100-3 tightly into place, while the front wheels 112, 114 remain on the roof surface.

A preferred method of securing anchor 100-3 in step (9A) comprises substantially the same steps as in step (9) except they are performed at an end of anchor line 168 distal from anchor 100-3 and proximal to anchor line 164. Accordingly, the directions of pulling on free end 168′ may be altered to ensure that line 168 becomes taut and secondary anchor line 168 is placed under additional tension, increasing the tension on the anchor line such that more users can use the system and/or so the system can protect a user or users on a greater area of the roof. These steps may be repeated for additional secondary anchors 100-4, etc.

Added secondary anchor line 168 from secondary roof anchors 100-3, 100-4, etc. may be used to increase the safe area on the roof for the user and reinforce the primary tether line(s) 164. For example, to reinforce a 200 foot tensioned common single, continuous anchor line 164 from sagging, a user may attach a tensioned secondary anchor line 168 to the primary anchor line 164 at a position around halfway between the two primary roof anchors 100-1, 100-2, such that secondary anchor line 168 is attached preferably substantially perpendicular to the primary anchor line 164 and attaches to secondary roof anchor 100-3 installed at the roof edge that is substantially parallel to primary anchor line 164. This supporting anchor line 168 reinforces the primary anchor line 164 for a user that is attached to the primary anchor line 164 and is on the roof on the opposite side of the roof from the secondary roof anchor 100-3. To reinforce the primary anchor line 164 on both sides of the roof, a secondary anchor line 168 may be attached to both sides of the primary anchor line 164 in substantially oppositely supporting positions or in spaced-apart positions.

As shown in FIGS. 35A-35G, multiple roof anchors 100 may be used with multiple secondary anchor lines 168 in various configurations to allow one or more users access to different areas of a roof to complete a task. One preferred configuration utilizes a pair of oppositely supported secondary anchor lines, such as 168-1, 168-2 on FIGS. 35B-C. Oppositely supported secondary anchor lines allow a user connected to one of the pair of secondary anchor lines to move in a substantially lateral direction relative to secondary anchor line to which the user is connected (such as towards sloped surfaces 16, 18). Without use of oppositely supported secondary anchor lines, a user connected to a secondary anchor line (e.g., 168-4) should only move in a direction substantially up-roof (such as towards ridge 111) or down-roof direction (such as towards edge F′) along the secondary anchor line to which the user is connected). A pair of oppositely supported secondary anchor lines requires installation of two secondary roof anchors (e.g., 100-3, 100-4) and two secondary anchor lines (e.g., 168-1, 168-2) as shown in FIGS. 35B-C. The secondary roof anchors 100-3 and 100-4 are preferably disposed substantially opposite each other on the roof, similar to anchors 100-1 and 100-2. The two secondary anchor lines 168-1, 168-2 are aligned in oppositely supporting positions where they are disposed substantially opposite from each other and in close alignment, offset slightly to accommodate their respective line sliding anchors 178-1, 178-2 on primary anchor line 164. Additionally, in this configuration, line sliding anchors 178-1 and 178-2 are oriented in opposite directions, such that the first direction (free movement) of one sliding anchor is in the same direction as the second direction (anchoring) of the other sliding anchor. They are also oriented such that the first direction of either line sliding anchor 178 is toward the adjacent line sliding anchor 178. This allows a user to connect to either line 168-1 or 168-2 and move in a lateral direction (e.g., toward sloped surfaces 16, 18).

In contrast, it is preferred that a user connected to secondary anchor line that is not oppositely supported by another secondary anchor line (e.g., anchor lines 168-3, 168-4) only move in an up-roof direction (toward ridge 111) or a down-roof direction (toward edge F′) along and substantially parallel to the secondary anchor line (168-3 or 168-4, for example). If a user wants to access an area laterally of a secondary anchor line, from a secondary anchor line that is not oppositely supported by another secondary anchor line, then the user may move the secondary anchor line and its corresponding anchor (e.g. line 168-4 and anchor 100-5) so that the desired lateral location becomes a substantially up- or down-roof location (if possible) along the repositioned secondary anchor line or needs to add an oppositely supporting anchor line.

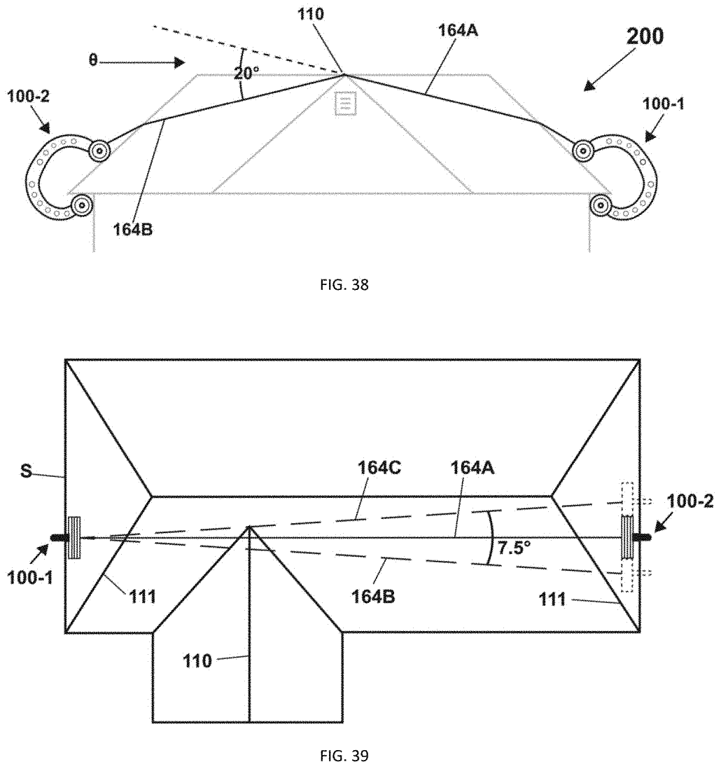

In other preferred configurations, at least one of the primary anchor line 164 or a secondary anchor line 168 (if used) when installed on a roof, or at least one lifeline 172 connected to an anchor line 164, 168, crosses at least one significant ridge 110 on the roof. Most preferably, safety system 200 is installed on a roof such that each significant ridge 110 crossed by an anchor line 164, 168 extends at least 6 feet on either side of the anchor line 164, 168. As shown in FIGS. 38-39, a significant ridge 110 is one that (1) an anchor line (or lifeline) crosses substantially perpendicularly and (2) creates a slope direction change from one side of the ridge to the other, preferably such that a downward change of angle θ of a second portion (e.g. 164b) of an anchor line (or lifeline) along one of the sides of the ridge is at least 20 degrees relative to a trajectory of a first portion (e.g. the dashed line extending from 164a) of the same anchor line (or lifeline) on the other side of the ridge. Additionally, primary ridge is the highest significant ridge and may be the only significant ridge. If there is more than one highest significant ridge, then it is preferred that the one closest to the second anchor 100-2 will be the primary ridge. Anchor line 164 may also cross one or more supporting hips 111, which is any hip on a roof that an anchor line 164 (or anchor line 168) crosses that is not a significant ridge.

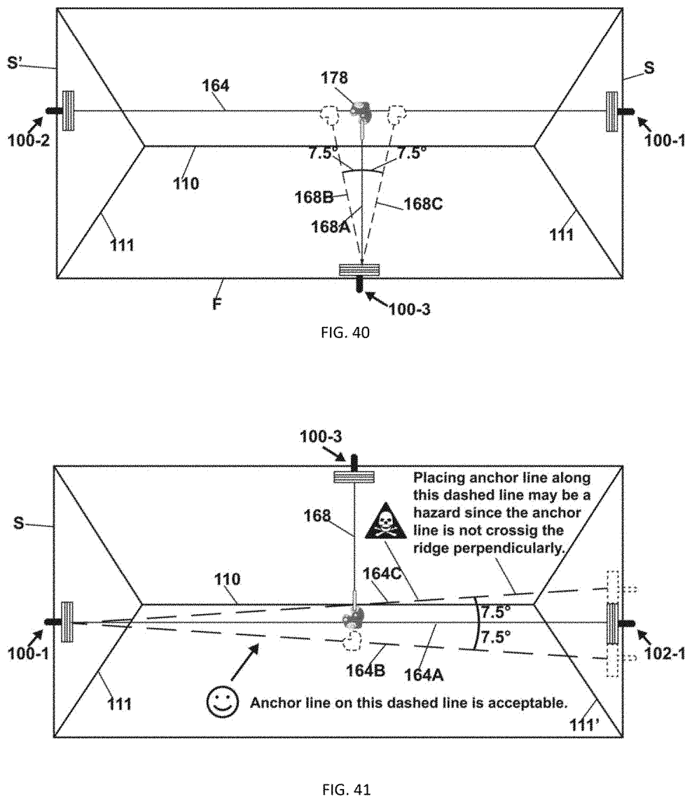

Referring to FIG. 39, preferably, once installation of their respective anchors 100 is complete, each primary anchor line 164 is oriented: (1) substantially perpendicular to the primary ridge 110 that it crosses and (2) substantially perpendicular to the roof edge (e.g., edge(s) S, S′) at which its anchors 100-1, 100-2 are connected. Referring to FIG. 40, preferably, once installation of their respective anchors 100 is complete, each secondary anchor line 168 is oriented: (1) substantially perpendicular to the primary ridge 110 that it crosses; (2) substantially perpendicular to the roof edge (e.g. edge F) at which its anchor (e.g. 100-3) is connected; and (3) substantially perpendicular to the primary anchor line 164 to which it is connected. As used herein, substantially perpendicular preferably means within about +/−7.5 degrees from perpendicular. In FIG. 39, the solid version of anchor line 164 is perpendicular and the dashed lines show +/−7.5 degrees from perpendicular. In FIG. 40, the solid version of secondary anchor line 168 is perpendicular and the dashed lines show +/−7.5 degrees from perpendicular.

For any configuration in which a primary anchor line 164 cannot cross a primary ridge 110 in a substantially perpendicular orientation, then it is preferred to utilize one or more of the following: (1) a secondary anchor line 168 that crosses a primary ridge substantially perpendicularly and disposed on a side of primary anchor line 164 that is opposite from where the user will be located on the roof, with the user connected to the primary anchor line (as shown in FIG. 35A) or (2) a pair of oppositely supported secondary anchor lines (e.g. anchor lines 168-1, 168-2 on FIG. 35B), in which case the user may be located on either side of anchor line 164 and connected to either anchor line 164 or one of the secondary anchor lines 168-1, 168-2 or (3) the user's adjustable lifeline 174 must cross a primary ridge and be connected to primary anchor line 164. As shown in FIG. 41, when a secondary anchor line 168 crosses primary ridge 110, it is most preferred that the primary anchor line 164 to which it is connected does not cross ridge 110, as it would not be oriented substantially perpendicularly to ridge 110. Therefore, depending on where anchor line 164 is placed on the roof relative to ridge 110, its orientation relative to roof edge S may be slightly more limited than substantially perpendicular. For example, anchor lines 164B and 164C on FIG. 41 are within +/−7.5 degrees relative to perpendicular anchor line 164A, but line 164C crosses ridge 110 so that orientation and positioning would preferably not be used. Any other orientation and positioning that shifts anchor line 164C toward 164B such that it does not cross ridge 110 may be used.

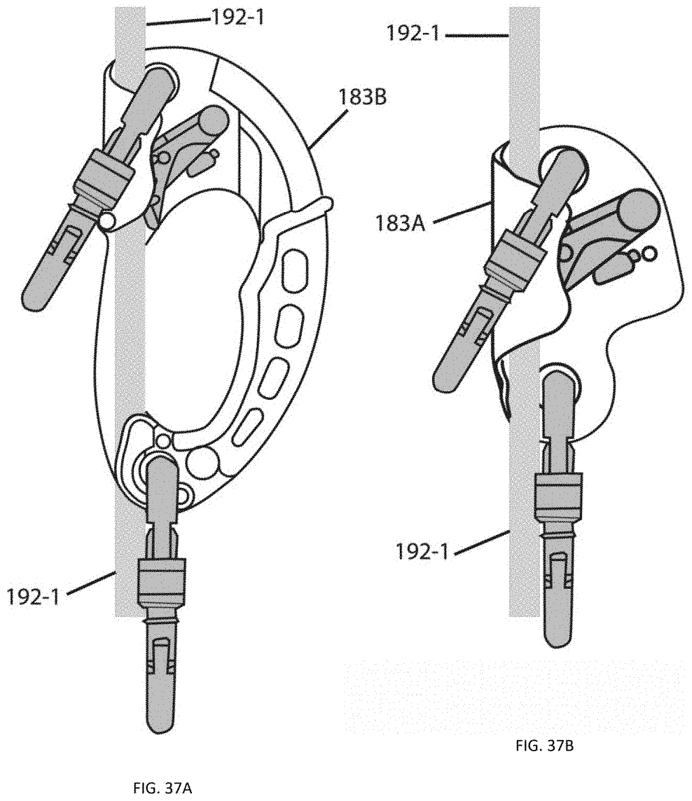

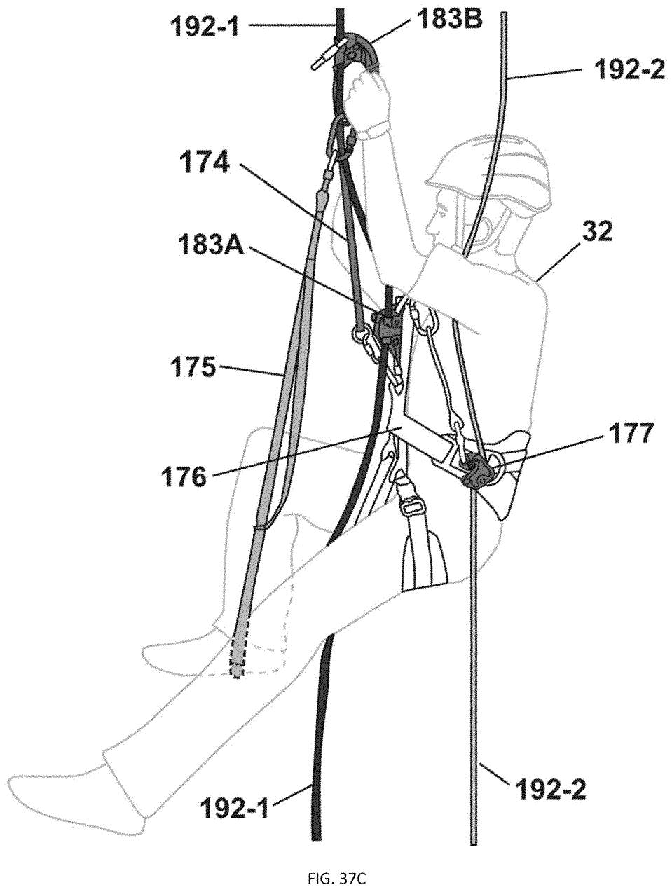

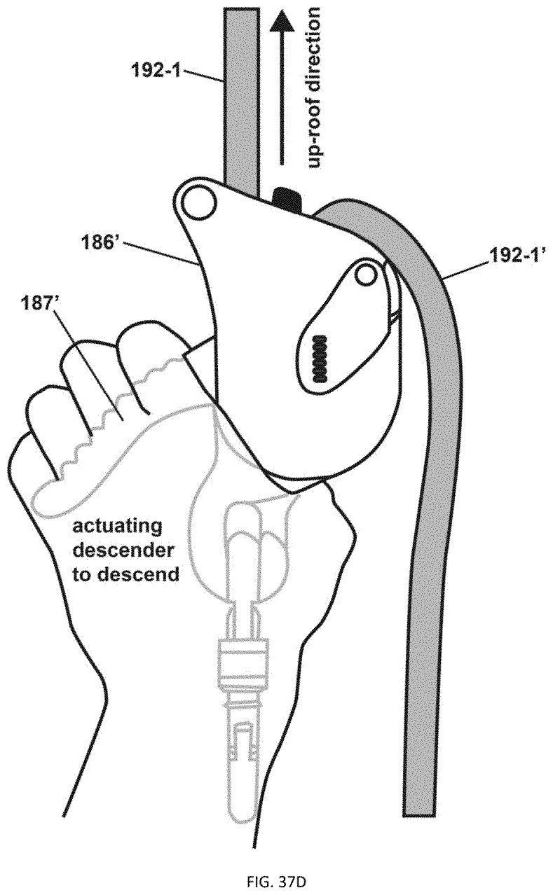

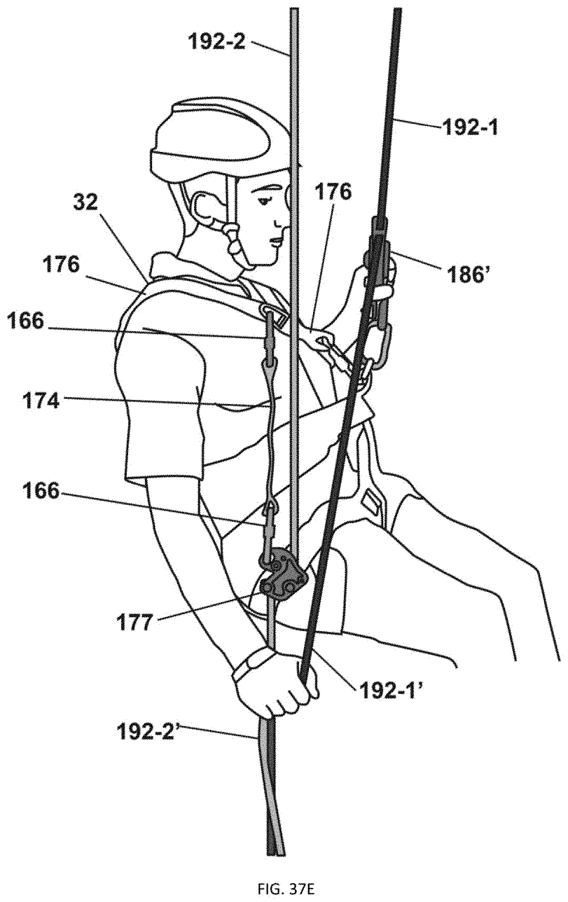

According to another preferred embodiment, roof safety system 200 may further comprise a rope access system that may be installed in a configuration similar to that shown in FIGS. 36A-36B, and 37A-37E. The rope access system will allow a user to ascend and descend on a working line (e.g., one of lines 192-1 or 192-2) hanging from the roof edge, and additionally use a second parallel line (e.g., the other of lines 192-1 or 192-2) as a safety line. In this configuration, three roof anchors 100-1, 100-2A, 100-2B are used, with two of the anchors 100-2A, 100-2B placed near or adjacent to each other on the second side of the structure oppositely of the first roof anchor 100-1. Two anchor lines 164-1, 164-2 are used with this configuration, each is preferably a single, continuous anchor line. Installation of anchor 100-1 is as previously described. Installation of anchors 100-2A and 100-2B are as previously described for anchors 100-2, except that anchors 100-2A and 100-2B are positioned slightly offset from anchor 100-1, rather than being as close to directly opposite anchor 100-1 as possible. A first end of each of anchor lines 164-1, 164-2 is connected to anchor 100-1, preferably each connected to separate, individual apertures on pivotal connector 150 (e.g., line 164-1 connected to aperture 152 and line 164-2 connected to aperture 154) or pivotal connector 250 (e.g., line 164-1 connected to aperture 256 and line 164-2 connected to aperture 257) using two connectors 166. The other end of anchor lines 164-1, 164-2 is connected, respectively, to roof anchors 100-2A, 100-2B as previously described for installation of those anchors (as described for anchor 100-2). Rope access lines 192-1, 192-2, hanging to the ground after crossing the roof are also preferably used in this configuration, with a first line being used as a working line for a user to descend and ascend from the side of the building, and the second line being used as a safety line to which the worker is slidably and anchorably connected. A first end of each line 192-1, 192-2 is connected, respectively, to roof anchors 100-2A, 100-2B, preferably to pivotal connector 150 or 250 using a connector 166. These lines are preferably long enough that the free end of each line 192-1′, 192-2′ is disposed off the roof on the first side of the structure (near anchor 100-1) as shown in FIG. 36B and hang to the ground, to a safe landing, or at least as far as needed for the work that is being performed. The lines 192-1, 192-2 act as a working line and a safety line (lifeline) useable by a user 32 to ascend or descend.

Most preferably, as shown in FIGS. 37A-37E user 32 is connected to lines 192-1, 192-2 using two ascenders 183 and a descender 186′ on the working line (e.g., 192-1) and a user sliding anchor 177 on the safety line (e.g., 192-2). In a preferred embodiment, shown in FIGS. 36A,36B and 37A-37E, the ascenders (e.g., a chest ascender 183A, and a hand ascender 183B with foot loop 175 attached) are shown attached to the working line 192-1. Ascenders 183A, 183B are most preferably progress capture devices configured to allow slidable and anchorable attachment to the working line 192-1 to allow free sliding movement on working line 192-1 in a first direction and to block movement in a second direction to anchor the ascender on the working line 192-1. Unlike a slidable anchor 170, ascenders 183A, 183B most preferably do not include an actuator that can be engaged by the user to allow slidable movement in the second direction. In the preferred embodiment, the chest ascender 183A is fixedly connected to the user 32 on his/her harness 176, either directly or through a separate connector 166. The hand ascender 183B is operated by hand, with the attached foot loop 175 fixedly connected to the hand ascender 183B. The foot loop 175 is configured to allow a user to selectively place his/her foot in the loop, lower or push down on the loop with his/her foot to apply tension, lift his/her foot up to release the tension, and to remove his/her foot from the loop when desired. Ascender 183B is also preferably fixedly connected to a lanyard 174 that is connected to the user's harness 176. Lanyard 174 will prevent the user from dropping the hand ascender 183B and the foot loop if hand ascender is not attached to the rope and user drops the hand ascender 183B. Ascenders 183A, 183B are generally made to allow a user to move the ascenders, with little effort, in a first direction, up the working line 192-1, assisting the user in ascending the working line 192-1. The ascenders should not allow the release of the working line, without a deliberate action of the user, preventing the user from unintentionally descending the working line 192-1 (e.g., sliding in a second direction) or releasing the working line through the ascender 183A, 183B. To ascend, the user will slide the hand ascender up the working line 192-1, while lifting the foot that is in the foot loop 175 (releasing tension), and then the user will step on the foot loop 175 (applying tension) and use the hand ascender 183 as a handle to assist in stepping up to ascend on working line 192-1. Preferably the chest ascender 183A will slide up the working line 192-1 with the user as the user ascends so that the progress of the user ascending the working line 192-1 is not lost once user releases tension on foot loop 175. This process will be repeated until user is at a desired location.

For a user that is attached to the ascenders 183A, 183B to be able to descend the working line 192-1, the ascenders 183A, 183B will need to be removed from the line, as they do not allow slidable movement in the second/descending direction. In a preferred embodiment, the ascender 183A, 183B will also not allow its removal from the working line 192-1 if there is any tension on the ascender 183A, 183B from the working line 192-1.

With descender 186′ fixedly connected to the user 32 on his/her harness 176, either directly or through a separate connector 166, user may slidably and anchorable attach the descender to the working line 192-1. User may then use hand ascender 183B and foot loop 175 to remove tension from chest ascender 183A and then remove chest ascender 183A from working line 192-1, and then lower himself/herself 32 until tension is transferred to the descender 186′ that is fixedly attached to the user 32 and anchorably attached to the working line 192-1. Lifting his/her foot up, within the foot loop 175, releasing tension from hand ascender 183A, the user 32 can remove hand ascender 183B from the working line 192-1. The user may now descend working line 192-1 using descender 186′. Most preferably, a descender 186′ is also a progress capture pulley but, unlike the ascender 183A, 183B, it can be used as a descender or as an ascender even though it is primarily used as a descender for rope access. It will usually require more effort to feed the working line 192-1 through the descender 186′ if used to ascend, which is why is it preferred to use ascender 182A, 183B to ascend and only use a descender 186′ to descend. Preferably, the descender 186′ will allow for a regulated release, fast or slow, of the working line, to allow a user to descend the working line 192-1 at his/her preferred speed. The descender may be similar or even the same as the progress capture/tensioning device 186 that is used to tension the anchor lines 164, 168. In one preferred embodiment, the descender 186′ is slidably and anchorably attached to the working line 192-1 and fixedly attached to the harness 176. The descender can slidingly move up the working line 192-1 and will only move down the working line 192-1 by actuating a lever 187 on descender 186′ to allow movement in the second direction (down-roof, toward the ground). The safety line 192-2 acts as a lifeline or an adjustable lifeline (like line 172). In the event that the working line 192-1 or its corresponding anchor 100-2A fails, the user is still protected by the safety line 192-2 and the roof anchor 100-2B. Safety line 192-2 is preferably connected to the user's harness. Most preferably, a user sliding anchor 177 is slidably attached to safety line 192-2 and fixedly connected to a lanyard 174 using a connector 166, with the lanyard 174 fixedly connected to the user's harness 176 using a connector 166.

Preferred Methods of Using a Safety System

One preferred method of accessing a roof to perform a task using safety system 200 comprises the following steps: (10) bringing an adjustable lifeline 172 to roof level, if not already present at completion of installation; (11) connecting user 32 to anchor line 164 while maintaining continuous protection of user 32 from falls; (12) anchoring line sliding anchor 178 to a desired location on anchor line 164; and (13) having the user move about the roof along adjustable lifeline. The steps for accessing a roof using safety system 200 are numbered consecutively after the installation steps for ease of reference and do not indicate that all of the steps for installation or access need to be performed.

A preferred method of bringing an adjustable lifeline 172 to roof level in step (10) preferably comprises the following steps: After at least anchors 100-1 and 100-2 are in installed position (after at least step (4) and preferably after step (5), and preferably with a user already attached to anchor line 164, near anchor 100-2, with lanyard 174 and sliding anchor 178 as shown in FIG. 24D), a user connects another lanyard (second lanyard 174-2) to loop 189 extending from knot 188 on anchor line 164, preferably using a connector 166, as shown in FIG. 24E. The user then preferably disconnects the original lanyard/first lanyard (174 in FIG. 24D or 174-1 on FIG. 24E)) from line sliding anchor 178 from its up-roof position on anchor line 164 (as shown in FIG. 24D) and moves line sliding anchor 178 to free end 164′ of anchor line 164 (as shown in FIG. 24E), oriented so that the first direction is up-roof relative to anchor 100-2. The user then connects the original lanyard 174-1 as shown on FIG. 24E to sliding anchor 178, preferably using connector 166. Once original lanyard 174-1 is connected to sliding anchor 178, the user may disconnect second lanyard 174-2 from loop 189. In this way, the user is always protected from falls through first and/or second lanyards 174-1, 174-2 and the user is never disconnected from anchor line 164/free end 164′. The user may then descend ladder 34 by actuating sliding anchor 178 to allow movement in the second direction (down-roof, toward the ground). Once at ground level, the user retrieves and preferably connects an end of an adjustable lifeline 172 to harness 176 (adjustable lifeline includes a connector 166 connected to a lifeline and a sliding anchor 170 connected to the lifeline) and ascends ladder 34. Alternatively, the user may simply carry the adjustable lifeline 172 while ascending the ladder 43. While on the ground level, user 32 may also retrieve one or more additional sliding anchors 178, preferably connecting them to harness 176 prior to ascending ladder 34. According to another preferred embodiment, an end of adjustable lifeline 172 may be connected to harness 176 prior to step (4), in which case step (10) may be omitted. To avoid tangling of the lines, it is preferred to utilize step (10).

A preferred method of connecting user 32 to anchor line 164 while maintaining continuous fall protection in step (11) comprises the following steps: Once back at roof level, the user (a) again connects lanyard 174-2 to loop 189; (b) disconnects lanyard 174-1 from sliding anchor 178; (c) disconnects sliding anchor 178 from free end 164′; (d) connects sliding anchor 178 (preferably the same sliding anchor previously connected to free end 164′) to anchor line 164 in an up-roof position from knot 188; (e) connects lanyard 174-1 to sliding anchor; and (f) disconnects lanyard 174-2 from loop 189. This method of connecting user 32 to anchor line 164 does not include using adjustable lifeline 172. Although some variation in order of these sub-steps may be used (e.g., sub-steps (b) and (c) may be reversed), the general order of these sub-steps is important to maintain the user in protected connection to safety system 200 to protect from falls. Alternatively, once back at roof level, the user (a) connects another sliding anchor 178 to anchor line 164 in an up-roof position from knot 188; (b) connects lanyard 174-1 to the sliding anchor 178 on anchor line 164; (c) disconnects lanyard 174-2 from original sliding anchor 178 on free end 164′; (d) disconnects original sliding anchor 178 from free end 164′; and (e) connects the original sliding anchor 178 to harness 176. This method of connecting user 32 to anchor line 164 does not include using adjustable lifeline 172. Although some variation in order of these sub-steps may be used (e.g., sub-steps (c) and (d) may be reversed), the general order of these sub-steps is important to maintain the user in protected connection to safety system 200 to protect from falls. Alternatively again, once back at roof level, the user (a) connects a lanyard (e.g. 174-2) to loop 189; (b) disconnects another lanyard (e.g. 174-1) from sliding anchor 178 on free end 164′; (c) disconnects sliding anchor 178 from free end 164′; (d) connects the sliding anchor 178 to anchor line 164 in an up-roof position from knot 188; (e) user attaches end of adjustable lifeline 172 to slidable anchor 178; and then (f) connects a lanyard (e.g. 174-1 to user sliding anchor 177 that is on the adjustable lifeline 172. Although some variation in order of these sub-steps may be used (e.g., sub-steps (b) and (c) may be reversed), the general order of these sub-steps is important to maintain the user in protected connection to safety system 200 to protect from falls. As shown in FIGS. 31-32, resulting from any of these embodiments, the user 32 is connected to anchor line 164 via lanyard 174 (e.g., either 174-1 or 174-2) and a first sliding connector 178, or the user is connected to anchor line 164 via adjustable lifeline 172 and a first sliding connector 178.

A preferred method of anchoring line sliding anchor 178 to a desired location on anchor line 164 in step (12) comprises the following steps: The user 32 moves the line sliding anchor 178 as shown on FIGS. 32-33 to a desired location along anchor line 164 by walking on the roof surface in the first direction. Most preferably, line slidable anchor 178 is positioned or oriented on primary anchor line 164 so that the first direction is in an up-roof direction. By flipping the slidable anchor 178 around relative to the anchor line, the orientation is reversed. For example, if the slidable anchor 178 is positioned on anchor line 164 with its first end “facing” up-roof, the first direction will be up-roof; but if it is flipped so that the first end is now facing down-roof, the first direction becomes down-roof. Thus, the orientation of the first direction can be selectively changed by how a slidable anchor 170 is oriented or positioned when connected to a line, such as primary anchor line 164. If user 32 moves in the first direction and is connected to anchor line 164 with lanyard 174 and line sliding anchor 178, line sliding anchor 178 moves with the user. If user 32 moves in the first direction and is connected to anchor line 164 with adjustable lifeline 172 and line sliding anchor 178, and adjustable lifeline 172 is taut between the user and the line slidable anchor, line slidable anchor 178 moves with the user. Once the desired anchor location for line sliding anchor 178 on anchor line 164 is reached, the user stops walking and/or moving the sliding anchor 178 up the roof. The desired anchor location for line sliding anchor 178 will depend on where the user needs to access the roof to complete the task, with the task location preferably being a location generally disposed in a second direction relative to the line sliding anchor 178 so that sliding anchor 178 does not move on anchor line 164 while the user is performing the task. If user is connected to primary anchor line 164 via lanyard 174 and sliding anchor 178, to transition to being connected to anchor line 164 via adjustable lifeline and sliding anchor 178, the user then: (a) connects another sliding anchor 178-2 to anchor line 164 near original sliding anchor 178-1; (b) disconnects a first end of adjustable lifeline 172 (with user sliding anchor 177 already slidably connected to adjustable lifeline 172) from harness 176; (c) connects the first end of adjustable lifeline 172 to line sliding anchor 178-2; (d) connects another lanyard 174 (preferably whichever of lanyard 174-1, 174-2 is not already connected to the line sliding anchor 178-1) to the user sliding anchor 177 (fixedly connected); (e) disconnects the original lanyard from the original line sliding anchor 178-1; (f) disconnects original sliding anchor 178-1 from anchor line 164; and (g) connects the original sliding anchor 178-1 to harness 176. Although some variation in order of these sub-steps may be used (e.g., sub-steps (e) and (f) may be reversed), the general order of these sub-steps is important to maintain the user in protected connection to safety system 200 to restrain any fall. As shown in FIG. 33, for example, the user is connected to adjustable lifeline 172 via a user sliding anchor 177 and lanyard 174 and adjustable lifeline 172 is anchored at one end to anchor line 164 via a line sliding anchor 178. Preferably, the user sliding anchor 177 is oriented on adjustable lifeline 172 such that its first direction is in an up roof direction (toward anchor line 164). The task location is preferably in a location generally disposed in a second direction relative to the user sliding anchor 177 so that sliding anchor 177 does not move on adjustable lifeline 172 while the user is performing the task.

A preferred method of having a user move about the roof surface along an adjustable lifeline in step (13) comprises the following steps: The user 32 actuates user sliding anchor 177 to allow movement on the roof in the second direction for sliding anchor 177. The user continues moving along the roof until the desired task location is reached, at which point the actuation of user sliding anchor 177 stops and user sliding anchor 177 becomes anchored against further movement in the second direction at that location. The task location is preferably in a location generally disposed in a second direction relative to the user sliding anchor 177 so that sliding anchor 177 does not move on adjustable lifeline 172 while the user is performing the task. The user may then safely perform the task.

Once the task is completed, the user may reposition to a second location on the roof for a second task, repeating the above steps and/or reversing the above steps as needed. For example, the user may slide user sliding anchor 177 slidably connected to adjustable lifeline 172 in the first direction towards line sliding anchor 178 connected to anchor line 164. The user may then reposition the line sliding anchor 178 on anchor line 164 in either the first or second direction, in the same or similar manner as the line sliding anchor 178 was originally positioned on anchor line 164, to access a different task location on the roof. The user may also move the line sliding anchor 178 to near a secondary anchor line 168 to allow the user to transition his/her adjustable lifeline 172 to the secondary anchor line 168. When a desired task location is closer to anchor 100-1 or 100-3, etc., rather than 100-2, the user may move across primary ridge from the user's initial roof access location by transitioning, at the primary ridge, to a second line sliding anchor 178 on the same anchor line 164, but on the other side of the primary ridge, that is oriented oppositely with respect to the first direction from the first line sliding anchor device used to reach the primary ridge.

Most preferably, during any transition of the user's connection from one sliding anchor 170 to a different sliding anchor 170 (such as for a transition from/to a primary anchor line 164 to/from a secondary anchor line 168 or a transition to the same anchor line 164, 168 on the other side of a primary ridge or for transitioning from a connection to a line sliding anchor 178 with lanyard 174-1 to a connection to a user sliding anchor 177 on adjustable lifeline 172 with lanyard 174-2) the user will connect to the new sliding anchor (already connected to an anchor line 164, 168 or adjustable lifeline 172), prior to disconnecting from the old sliding anchor. In this way, the user is temporarily connected to both the new and old sliding anchors, and their respective anchor lines or adjustable lifeline (that is connected to an anchor line), and is never completely disconnected from an anchor line (through a lanyard or a lifeline) during the transition. This ensures the user is protected during the transition. For example, with reference to FIG. 35C, user 32 may slide line sliding anchor 178-3 (slidingly connected to anchor line 164 and fixedly connected to the user's lanyard or adjustable lifeline) towards a line sliding anchor 178-2 (e.g. 178-2 slidingly connected to primary anchor line 164 and fixedly connected to secondary anchor line 168-2) if the user wants to transition to secondary anchor line 168-2 or 168-1 or transition to a side of anchor line 164 that is closer to roof anchor 100-1. Once the user reaches sliding anchor 178-2, the user may then connect a lanyard to the connector 166 that connects slidable anchor 178-1 to secondary anchor line 168-1 or the connector 166 that connects slidable anchor 178-2 to secondary anchor line 168-2 (which is in close proximity to 178-2 in this example), before disconnecting from sliding anchor 178-3. The user may then connect another sliding anchor (which may be sliding anchor 178-3 after removing it from anchor line 164 or may be a new sliding anchor taken from the user's harness) to the desired secondary anchor line 168-2, 168-1 or to primary anchor line 164 on the other side of sliding anchor 178-1. Once the new sliding anchor is connected to anchor line 168-2, 168-1, or 164, the user then fixedly connects his/her lanyard 174 or adjustable lifeline 172 (with the user connected to a user slidable anchor 177 on adjustable lifeline 172) to the new sliding anchor before disconnecting from connector 166 that is connected to sliding anchor 178-2 or 178-1. The user was protected during the transition and is now free to move along the anchor line to which the new sliding anchor is connected.

Referring to FIGS. 34A-B, 35E, and 35G, a user may also use two simultaneous connections to an anchor line 164, 168. A user may have two lifelines, preferably adjustable lifelines 172-1, 172-2 that are connected to the user's harness 176 through lanyards 174-1, 174-2 and user slidable anchors 177-1, 177-2. An end of each lifeline 172-1, 172-2 is connected to one of the line sliding anchors 178-1, 178-2 (see FIG. 34B) that is in turn connected to an anchor line 164, 168. This provides greater fall protection near a corner of the roof (e.g., where F and S edges meet in FIG. 34A and where F and S edges meet on hip H in FIG. 34B or H-2 in FIG. 35E). This additional arrangement of the combination of primary anchor line 164 with at least one secondary support line 168 (see, e.g., FIG. 35G) facilitates an additional degree of freedom as far as attachment of the user 32 at the rooftop is concerned. Specifically, the user 32, located on the roof somewhere in the corner area limited by the edges S and F′ and anchor lines 164, 168, is now in a position to use a predefined connecting element or elements, such as an adjustable lifeline 172-1, 172-2 to moveably affix the user's harness to both the anchor lines 164, 168—thereby gaining the ability to move anywhere in the identified area and approach the corner of the roof at the intersection of edges S and F′ near hip H-2 without the risk of falling off the roof. Alternatively, or in addition, at least one of the mechanical connections between the user's harness and the anchor lines 164, 168 can be a user sliding anchor 177 (not shown in FIG. 35G) on a lifeline so that the user can control a length of the adjustable lifeline between the user and anchor lines 164, 168 within the defined corner area to provide further protection.

For the simplicity of the drawings, only the line sliding anchors 178 connected to a primary anchor line 164 or secondary anchor line 168 are shown in FIGS. 35A-35G. However, each of the users 32 are also preferably connected to adjustable lifelines 172 using a user sliding connector 177 and a lanyard 174 connected to the user's harness, similar to the configuration shown in FIG. 32-34B. In this way, the user preferably is connected to both a line sliding anchor (e.g., anchor 178-1 in FIG. 34) on an anchor line (e.g., 164) through an adjustable lifeline/lanyard (e.g., 172-2 and 174-2) with an intermediate sliding anchor (e.g. a user sliding anchor 177) disposed between the user and the anchor line (e.g. 164). In other embodiments, a user may be connected to an anchor line 164, 168 using a fixed lifeline, such as a lanyard or other line, that is directly connected to a line sliding anchor 178 on anchor line 164, 168 without an intermediate sliding anchor (user sliding anchor 177) disposed between the user and the anchor line 164, 168.

As used herein, references to an up-roof direction generally refer to a direction from an edge of a roof (such as edge S, S′, F, or F′) upward toward a ridge (such as 110/G from FIG. 4 or 110/P from FIG. 25) on the roof that is connected to the edge by one or more sloped roof surfaces (such as 14, 16, 18). References to a down-roof direction generally refer to a direction from a ridge downward toward an edge on the roof that is connected to the ridge by one or more sloped surfaces. These directions are shown, for example, with reference to FIGS. 4,18, 19, 22, and 25. Sliding anchors 170 are most preferably used in the methods of installation and use of safety system 200 with the sliding anchor's first direction (free movement) being in an up-roof direction. With respect to up- and down-roof directions for movement along an anchor line using a sliding anchor 170, the direction can reverse after the anchor line crosses over the highest ridge in its path across the roof. Accordingly, it is preferred that a user transition from one sliding anchor 170 to a different sliding anchor 170, each oriented in opposite directions when moving across a ridge that results in an up-roof to down-roof direction change.

For example, with reference to FIG. 30, if a user moves in an up-roof direction on sloped surface 16 and continues moving in the same direction after crossing over ridge 110/P, the user would then be moving in a down-roof direction on sloped surface 18. If the user continued using the same sliding anchor 170 oriented in the same manner as it had been on sloped surface 16, the sliding anchor's first direction (allowing free movement) would then be in a down-roof direction. If the user slipped on surface 18, the sliding anchor 170 would not restrain the user's fall and could allow the user to slide all the way to anchor 100-2 and fall off of roof edge S′. Most preferably, the user would transition at ridge 110/P to a new sliding anchor 170 on the surface 18 side of the ridge such that the new sliding anchor is properly oriented with its second direction (anchoring) in the down-roof direction for surface 18. Then if the user slips on surface 18, the sliding anchor would prevent the user from sliding any significant distance. The user would at most slide the pre-determined acceptable length of the lanyard, lifeline, or length of the adjustable lifeline between anchor line 164 and the user.

Variations in ridges result in variations of when a direction changes from being up-roof to down-roof. With reference to FIGS. 4-5, a user on slope 16 moving towards hip 111/H1′ is moving in an up-roof direction and is still moving in an up-roof direction after crossing over hip 111/H1′ because that is not the highest ridge crossed by anchor line 164. Movement along anchor line 164 from surface 16 toward surface 18 does not change to a down-roof direction until after crossing over ridge 110/G, since that is the highest ridge crossed by anchor line 164. Similarly, movement along anchor line 164 from surface 18 toward surface 16 is also in an up-roof direction until ridge 110/G is crossed. With reference to FIG. 35A, for an anchor line 164 that crosses two substantially equal height hips 111/H, 111/H′, a user moving along anchor line 164 from edge S′ toward edge S would be moving in up-roof direction on surface 18 and on surface 14 until crossing over hip 111/H. A user moving along anchor line 164 from edge S toward edge S′ would be moving in up-roof direction on surface 16 and on surface 14 until crossing over hip 111/H′. For a secondary anchor line 168 connected to primary anchor line 164 as shown in FIG. 35A, it may be preferable to transition to a new sliding anchor 170 in a reversed orientation at the point of crossing over line sliding anchor 178-1, since the user would have to make a sliding anchor transition at that point anyway to gain access to anchor line 164 on the other side of sliding anchor 178-1. However, the user could transition to a sliding anchor still oriented in the same orientation and transition again to a reversed orientation sliding anchor at hip 111/H where continued movement in the same direction along anchor line 164 transitions from an up-roof to down-roof direction.

It should be evident that components of the improved roof safety system 200 may be fabricated or formed in a variety of ways and from a variety of materials. The various parts may be machined, molded, or otherwise fabricated from high strength materials such as steel, aluminum alloy, reinforced aluminum, tubular alloy, high-strength plastics, or wood, or be manufactured from a combination of any suitable materials and processes. The choice of materials and construction are clearly within the scope of the appended claims. A skilled artisan will readily appreciate that preferred embodiments of a roof safety system 200 and its method of installation and use provide clear advantages over the prior art.

References made throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of these phrases and terms may, but do not necessarily, refer to the same implementation. It is to be understood that no portion of disclosure, taken on its own and in possible connection with a figure, is intended to provide a complete description of all features of the invention. The term “exemplary” or “for example” or the like when used herein refers to “serving as an example, instance, or illustration.” Accordingly, any embodiment or feature or step referred to as “exemplary” or “for example” or the like is not to be construed as limiting or as necessarily advantageous over other embodiments. Unless specifically excluded, any preferred features and optional components of any roof safety system embodiment or embodiment of any component of such system, and/or method steps described herein may be used with any other embodiment, even if not specifically described herein with that particular embodiment.

All dimensions, sizes, numerical rating, ratio, or percentages indicated herein as a range include each individual amount, numerical value, or ratio within those ranges and any and all subset combinations within ranges, including subsets that overlap from one preferred range to a more preferred range. Unless direct or indirect is specifically referenced, as used herein, general references to contact, engage and similar wording mean any form or direct or indirect contact or engagement between two parts or components or surfaces and preferred embodiments may exclude one or the other of direct or indirect contact or engagement unless such excluded form of contact or engagement is specifically described as required with all embodiments herein.

It is also to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed.

Those of ordinary skill in the art will also appreciate upon reading this specification, including the examples contained herein, that modifications and alterations to the preferred embodiments of a roof safety system and its method of installation and use may be made within the scope of the invention and it is intended that the scope of the invention disclosed herein be limited only by the broadest interpretation of the appended claims to which the inventor is legally entitled.

I claim:

1. A safety system for a roof comprising at least one sloped surface, the safety system comprising:
a plurality of roof anchors, each roof anchor configured to hook onto an eave of the roof;
one or more anchor lines;
one or more lifelines;
one or more slidable anchors comprising at least one a line slidable anchor, each line slidable anchor configured to connect one of the lifelines to one of the anchor lines;
wherein one of the anchor lines is a primary anchor line that is connectable under tension to a first of the roof anchors and to a second of the roof anchors disposed in a location across the roof substantially opposite of the first roof anchor, the primary anchor line configured to hold the first and second roof anchors in contact with its respective eave without requiring penetration of the roof; and
wherein each roof anchor comprises an arched body having a front end and a rear end.

2. The safety system of claim 1 wherein each line slidable anchor is configured to be fixedly connectable to a first end of one of the lifelines and to be slidably connectable to one of the anchor lines to allow selective anchoring of the lifeline at any position along the anchor line by (1) freely allowing slidable movement of the first end along the anchor line in a first direction and (2) anchoring the first end at any position along the anchor line by not allowing slidable movement of the first end in a second direction substantially reversed from the first direction unless a user actuates the line slidable anchor to allow slidable movement in the second direction.

3. The safety system of claim 1 wherein the one or more slidable anchors further comprise at least one user slidable anchor, each user slidable anchor configured to connect a user to one of the lifelines.

4. The safety system of claim 3 wherein each user slidable anchor is configured to be fixedly connectable to a user and to be slidably connectable to one of the lifelines to allow selective anchoring of the user at any position along the lifeline by (1) freely allowing slidable movement of the user slidable anchor along the lifeline in a first direction and (2) anchoring the user slidable anchor at any position along the lifeline by not allowing slidable movement of the user slidable anchor in a second direction substantially reversed from the first direction unless the user actuates the line slidable anchor to allow slidable movement in the second direction.

5. The roof safety system of claim 1 wherein each slidable anchor comprises a rope grab.

6. The safety system of claim 2 wherein the one or more slidable anchors further comprise at least one user slidable anchor, each user slidable anchor configured to connect a user to one of the lifelines; and
wherein each user slidable anchor is configured to be fixedly connectable to a user and to be slidably connectable to one of the lifelines to allow selective anchoring of the user at any position along the lifeline by (1) freely allowing slidable movement of the user slidable anchor along the lifeline in a third direction and (2) anchoring the user slidable anchor at any position along the lifeline by not allowing slidable movement of the user slidable anchor in a fourth direction substantially reversed from the third direction unless the user actuates the line slidable anchor to allow slidable movement in the third direction.

7. The roof safety system of claim 1 further comprising a single tensioning device connected to the primary anchor line at or near the first roof anchor or the second roof anchor and configured to put the primary anchor line under tension.

8. The roof safety system of claim 7 wherein the single tensioning device comprises a progress capture pulley or a ratchet.

9. The roof safety system of claim 1 wherein the user does not need to access the roof to install the system.

10. The roof safety system of claim 1 wherein the system does not include any nails or screws to secure the system to the roof.

11. The roof safety system of claim 1 wherein the system is configured to be secured to the roof only using the tether line under tension.

12. A method of installing a roof safety system on a structure comprising a roof having one or more sloped surfaces and a plurality of eaves, the method comprising:
attaching a first end of an anchor line to a first roof anchor on a first side of the structure;
using a throw line and a line thrower to run the anchor line across the roof to a second side of the structure;
lifting the first roof anchor into a first position to hook the first roof anchor onto one of the eaves at a first location, with a portion of the first roof anchor in contact with a first of the eaves and another portion of the first roof anchor in contact with a sloped roof surface adjacent the first of the eaves;
attaching the anchor line disposed at the second side of the structure to a second roof anchor;
lifting the second roof anchor into a second position to hook the second roof anchor onto one of the eaves at a second location substantially opposite the first location, with a portion of the second roof anchor in contact with a second of the eaves and another portion of the second roof anchor in contact with a sloped roof surface adjacent the second of the eaves;
applying tension on the anchor line from the second side of the structure to hold the first roof anchor in the first position while performing the attaching and lifting the second roof anchor steps; and
wherein each roof anchor comprises an arched body having a front end disposed in contact with one of the sloped roof surfaces and a rear end disposed in contact with one of the eaves when hooked onto on one of the eaves.

13. The method of claim 12 wherein the lifting steps are carried out by one or more users while on a ladder supported by the structure.

14. The method of claim 12 further comprising securing the second roof anchor by tying a free end of the anchor line to a portion of the anchor line disposed between the first and second roof anchors.

15. The method of claim 14 wherein the securing step further comprises applying additional tension to the anchor line from a position near the second eave to place the anchor line under additional tension to hold the first roof anchor more securely in the first position while holding the second roof anchor more securely in the second position.

16. The method of claim 12 wherein the lifting and applying tension steps are carried out by one or more users while the one or more users are positioned on a ground surface or on a ladder supported by the structure or a combination thereof.

17. The method of claim 12 wherein the steps are carried out by one or more users without the one or more users needing to access the roof.

18. The method of claim 12 further comprising:
connecting a user to a lifeline;
connecting a line slidable anchor to a first end of the lifeline and to the anchor line, wherein the line slidable anchor is configured to be fixedly connectable to the first end of the lifeline and to be slidably connectable to the anchor line to allow selective anchoring of the lifeline at any position along the anchor line by (1) freely allowing slidable movement of the line slidable anchor along the anchor line in a first direction and (2) anchoring the line slidable anchor at any position along the anchor line by not allowing slidable movement of the line slidable anchor in a second direction substantially reversed from the first direction unless a user actuates the line slidable anchor to allow slidable movement in the second direction; and
positioning the user in a desired location on the roof to perform a task by moving the lifeline and connected line slidable anchor in the first or second direction to a point on the anchor line wherein the desired location is disposed in a direction in which the line slidable anchor is anchored to the anchor line.

19. The method of claim 18 wherein the lifeline comprises a lanyard.

20. The method of claim 18 wherein the lifeline is connected to a user's harness during the connecting the line slidable anchor step.

21. The method of claim 18 wherein connecting a user to a lifeline comprises:
connecting a harness worn by the user to a user slidable anchor and connecting the user slidable anchor to the lifeline, wherein the user slidable anchor is configured to be fixedly connectable to the harness and to be slidably connectable to the lifeline to allow selective anchoring of the user at any position along the lifeline by (1) freely allowing slidable movement of the user slidable anchor along the lifeline in a first direction and (2) anchoring the user slidable anchor at any position along the lifeline by not allowing slidable movement of the user slidable anchor in a second direction substantially reversed from the first direction unless the user actuates the line slidable anchor to allow slidable movement in the second direction.

22. The method of claim 21 wherein a length of the lifeline disposed between the user and the anchor line is adjustable based on a selective position of the user slidable element on the lifeline.

23. The method of claim 12 wherein the attaching the anchor line to the second roof anchor step comprises passing the anchor line (1) through an aperture on a connector pivotally connected the second roof anchor or (2) around a forward axle on the second roof anchor or (3) through an aperture disposed through a body of the second roof anchor.
